(19) United States
(12) Patent Application Publication
(10) Pub. No.: US 2025/0198099 A1
(43) Pub. Date: Jun. 19, 2025

(54) SUSTAINABLE BARRIERS

(71) Applicant: PRETRED, INC., Aurora, CO (US)

(72) Inventors: Eric Davis, Aurora, CO (US); Rick Welle, Aurora, CO (US); Vincent Powell, Aurora, CO (US); Geoffrey R. Quinter, Aurora, CO (US)

(21) Appl. No.: 18/981,374

(22) Filed: Dec. 13, 2024

Related U.S. Application Data
(60) Provisional application No. 63/610,986, filed on Dec. 15, 2023.
(60) Provisional application No. 63/695,756, filed on Sep. 17, 2024.
(60) Provisional application No. 63/722,894, filed on Nov. 20, 2024.

(51) Int. Cl. E01F 15/08; C08L 17/00

(52) U.S. Cl. CPC E01F 15/086; C08L 17/00; C08L 2207/24; E01F 15/088

(57) ABSTRACT

A sustainable barrier including a waste material and a binder is provided. The binder is mixed with the waste material and configured to bind the waste material into the sustainable barrier. The binder includes a catalyst configured to enable the binder to bind the waste material into the sustainable barrier. The sustainable barrier has a maximum load rating of at least 25,000 pounds.

### CROSS REFERENCE TO RELATED APPLICATION

This application claims priority to and the benefit of U.S. Provisional Patent Application No. 63/610,986, filed Dec. 15, 2023, and entitled SUSTAINABLE BARRIERS, U.S. Provisional Patent Application No. 63/695,756, filed Sep. 17, 2024, and entitled SUSTAINABLE BARRIERS, and U.S. Provisional Patent Application No. 63/722,894, filed Nov. 20, 2024, and entitled SUSTAINABLE BARRIERS AND BARRIER JACKETS, the disclosures of which are incorporated herein by reference in their entirety.

### TECHNICAL FIELD

The present disclosure relates generally to sustainable barriers.

### BACKGROUND OF CERTAIN ASPECTS OF THE DISCLOSURE

Traffic barriers or crash barriers keep vehicles within a roadway and prevent vehicles from colliding with dangerous obstacles such as boulders, buildings, walls and storm drains. Traffic barriers may also be installed within medians of divided highways to prevent vehicles from entering the opposing lane of traffic and help to reduce head-on collisions. Some of these barriers, designed to be struck from either side, are called median barriers. Other traffic barriers may be installed along the side of a road to prevent errant vehicles from leaving the road and travelling down an embankment such as a hillside or to prevent vehicles from entering a river or lake.

Crash or median barriers can also be used to protect vulnerable areas like school yards, pedestrian zones or fuel tanks from being penetrated by vehicles. An early concrete median barrier design was developed by the New Jersey State Highway Department. This led to the term Jersey barrier being used as a generic term for barriers. However, Jersey Barrier refers to a specific shape of concrete barrier—one which has a wide base with an angled surface and a narrower upper portion. Other types of barriers include constant slope barriers, concrete step barriers, and F-shape barriers.

Barriers are typically made of a non-sustainable material such as concrete, plastic, and/or a non-sustainable material filled with water. For example, the typical Jersey style barrier is typically made of concrete and may be reinforced with rebar or some other material. At least some jurisdictions require that contractors for large project consider using sustainable materials in the project and some jurisdictions require that contractors actually use sustainable materials in the project if sustainable materials are available. To date, no sustainable traffic barrier is commercially available that has been certified for use by the United States Department of Transportation.

Additionally, the materials typically used to manufacture existing barriers are monolithic or uniform in density throughout the barrier. Specifically, Jersey Barriers are typically made of concrete and material cannot be changed. As such, the material of typical barriers cannot be tailored specific uses. For example, a contractor cannot order a barrier that has a dense core with a less dense skin such that the barrier gives more on impact but is still structurally able to withstand an impact. Additionally, concrete is a somewhat brittle material that may break if dropped. For example, Jersey barriers are typically moved around at construction sites. If a Jersey Barrier is dropped during a move, it may break or chip easily.

Finally, the shape of typical barriers is predetermined and cannot be changed or customized to suit different situations. For example, companies that manufacture Jersey Barriers only manufacture one shape of barrier. The companies typically do not enable a contractor to tailor the shape of the barrier to a specific use.

Accordingly, there is a need for a barrier that is formed of sustainable materials where the materials can be tailored to specific uses and the shape of the barrier can also be tailored to specific uses.

### BRIEF SUMMARY OF SOME ASPECTS OF THE DISCLOSURE

One aspect of the present disclosure relates to a sustainable barrier including a waste material and a binder. The binder is mixed with the waste material and configured to bind the waste material into the sustainable barrier. The binder includes a catalyst configured to enable the binder to bind the waste material into the sustainable barrier. The sustainable barrier has a maximum load rating of at least 25,000 pounds.

Another aspect of the present disclosure relates to a sustainable barrier including a waste material, a binder, and a connection system. The binder is mixed with the waste material and configured to bind the waste material into the sustainable barrier. The binder includes a catalyst configured to enable the binder to bind the waste material into the sustainable barrier. The connection system is embedded in the sustainable barrier. The connection system including at least one loop and a plate. The at least one loop comprising a primary loop extend through a primary hole in the plate.

Yet another aspect of the present disclosure relates to a sustainable barrier including a waste material, a binder, and a connection system. The binder is mixed with the waste material and configured to bind the waste material into the sustainable barrier. The binder includes a catalyst configured to enable the binder to bind the waste material into the sustainable barrier. The sustainable barrier has a maximum load rating of at least 25,000 pounds. The connection system is embedded in the sustainable barrier. The connection system including at least one loop and a plate. The at least one loop comprising a primary loop extend through a primary hole in the plate.

In some embodiments, the sustainable barrier includes a waste material and a binder mixed with the waste material and configured to bind the waste material into the sustainable barrier, wherein the binder comprises a catalyst configured to enable the binder to bind the waste material into the sustainable barrier. The sustainable barrier is capable of being certified under the MASH TL2 certification test. In some embodiments, the sustainable barrier also includes two broad sides that are substantially vertical relative to grade. In some embodiments, the sustainable barrier also includes two broad sides that are oriented at an angle relative to grade, wherein the angle is from about 80° to about 100°. In some embodiments, the sustainable barrier defines a sustainable barrier height of at least 30 inches. In some embodiments, the sustainable barrier defines a sustainable barrier height of 32 inches. In some embodiments, the sustainable barrier is not attached to a support surface. In some embodiments, the sustainable barrier defines a bottom width of at least 20 inches. In some embodiments, the sustainable barrier defines a bottom width of 22.5 inches.

In some embodiments, the sustainable barrier includes a waste material and a binder mixed with the waste material and configured to bind the waste material into the sustainable barrier. The sustainable barrier comprises 85% by weight of the waste material and 15% by weight of the binder. In some embodiments, the waste material comprises crumb rubber. In some embodiments, the binder is a polyurethane binder. In some embodiments, the sustainable barrier has a mass of approximately 400 kilograms. In some embodiments, the sustainable barrier has a length of approximately 1.83 meters. In some embodiments, the sustainable barrier has a height of approximately 810 millimeters. In some embodiments, the sustainable barrier has a width of approximately 610 millimeters.

In some embodiments, the sustainable barrier includes a waste material and a binder mixed with the waste material and configured to bind the waste material into the sustainable barrier. The binder comprises a catalyst configured to enable the binder to bind the waste material into the sustainable barrier, and wherein the sustainable barrier has a maximum load rating of at least 25,000 pounds. In some embodiments, the catalyst comprises a polyether polyol-based catalyst. In some embodiments, the catalyst comprises approximately 0.002% to approximately 0.01% of the barrier by weight of the waste material. In some embodiments, the catalyst comprises approximately 0.002% of the barrier by weight of the waste material. In some embodiments, the binder further comprises a polyurethane binder. In some embodiments, the polyurethane binder comprises approximately 1.5% to approximately 10% of the barrier by weight of the waste material. In some embodiments, the polyurethane binder comprises approximately 2% to approximately 2.5% of the barrier by weight of the waste material. In some embodiments, the binder further comprises a colorant. In some embodiments, the colorant comprises approximately 2.5% to approximately 5% of the barrier by weight of the waste material. In some embodiments, the binder further comprises water. In some embodiments, the water comprises approximately 0.02% of the barrier by weight of the waste material. In some embodiments, the waste material comprises crumb rubber. In some embodiments, the crumb rubber comprises approximately 85% to approximately 98% by weight of the sustainable barrier. In some embodiments, the crumb rubber comprises 10/20 mesh size granules of crumb rubber. In some embodiments, the crumb rubber comprises 10 mesh size granules of crumb rubber. In some embodiments, the crumb rubber comprises 20 mesh size granules of crumb rubber.

In some embodiments, the sustainable barrier includes a waste material, a binder mixed with the waste material and configured to bind the waste material into the sustainable barrier, and a connection system embedded in the sustainable barrier. The binder comprises a catalyst configured to enable the binder to bind the waste material into the sustainable barrier. The connection system comprising at least one loop and a plate, the at least one loop comprising a primary loop extend through a primary hole in the plate. In some embodiments, the at least one loop further comprises two secondary loops. In some embodiments, the two secondary loops extend through secondary holes in the plate.

In some embodiments, the sustainable barrier includes a waste material, a binder mixed with the waste material and configured to bind the waste material into the sustainable barrier, and a connection system embedded in the sustainable barrier. The binder comprises a catalyst configured to enable the binder to bind the waste material into the sustainable barrier. The sustainable barrier has a maximum load rating of at least 25,000 pounds. The connection system comprising at least one loop and a plate, the at least one loop comprising a primary loop extend through a primary hole in the plate.

In some embodiments, the sustainable barrier includes a waste material, a binder mixed with the waste material and configured to bind the waste material into the sustainable barrier, and a barrier jacket positioned on the sustainable barrier. The binder comprises a catalyst configured to enable the binder to bind the waste material into the sustainable barrier. In some embodiments, the barrier jacket comprises a twin wall plastic sheet formed of polypropylene. In some embodiments, the barrier jacket comprises at least one cutout that enables the barrier jacket to be folded into a plurality of sections. In some embodiments, each of the plurality of sections corresponds to a side of the sustainable barrier such that a shape of the barrier jacket corresponds to a shape of the sustainable barrier. In some embodiments, the barrier jacket comprises a plurality of holes configured to receive a plurality of fasteners configured to attach the barrier jacket to the sustainable barrier.

In some embodiments, the sustainable barrier includes a waste material, a binder mixed with the waste material and configured to bind the waste material into the sustainable barrier, and a sign positioned on the sustainable barrier. The binder comprises a catalyst configured to enable the binder to bind the waste material into the sustainable barrier. In some embodiments, the sign comprises a twin wall plastic sheet formed of polypropylene. In some embodiments, the sign comprises a plurality of holes configured to receive a plurality of fasteners configured to attach the sign to the sustainable barrier. In some embodiments, the sign comprises a sheet material. In some embodiments, the sheet material comprises a flexible vinyl. In some embodiments, the sign is attached to the sustainable barrier by an adhesive.

In some embodiments, the sustainable barrier includes a waste material, a binder mixed with the waste material and configured to bind the waste material into the sustainable barrier, and a design debossed into the sustainable barrier. The binder comprises a catalyst configured to enable the binder to bind the waste material into the sustainable barrier.

In some embodiments, the sustainable barrier includes a waste material, a binder mixed with the waste material and configured to bind the waste material into the sustainable barrier, and at least one protective covering attached to the sustainable barrier. The binder comprises a catalyst configured to enable the binder to bind the waste material into the sustainable barrier. In some embodiments, the at least one protective covering comprises a top corner protective covering attached to a corner of a top of the sustainable barrier. In some embodiments, the at least one protective covering comprises a side corner protective covering attached to a corner of a side of the sustainable barrier. In some embodiments, the at least one protective covering comprises a drainage slot protective covering attached to a drainage slot of the sustainable barrier.

In some embodiments, the sustainable barrier includes a waste material, a binder mixed with the waste material and configured to bind the waste material into the sustainable barrier, and an accessory attachment unit incorporated in the sustainable barrier. The binder comprises a catalyst configured to enable the binder to bind the waste material into the sustainable barrier. In some embodiments, the accessory attachment unit comprises at least one tube overmolded within the sustainable barrier. In some embodiments, the at least one tube is oriented vertically within the sustainable barrier. In some embodiments, the at least one tube is configured to receive a fence post. In some embodiments, the at least one tube is oriented horizontally within the sustainable barrier and extends through a width of the sustainable barrier. In some embodiments, the at least one tube is oriented horizontally within the sustainable barrier and extends through a length of the sustainable barrier.

In some embodiments, the sustainable barrier includes a waste material, a binder mixed with the waste material and configured to bind the waste material into the sustainable barrier, and a reflective material. The binder comprises a catalyst configured to enable the binder to bind the waste material into the sustainable barrier. In some embodiments, the reflective material is mixed throughout the sustainable barrier. In some embodiments, the reflective material is applied to a surface of the sustainable barrier. In some embodiments, the reflective material comprises a natural mica powder. In some embodiments, the reflective material comprises a natural mica flake.

There are other novel aspects and features of this disclosure. They will become apparent as this specification proceeds. Accordingly, this brief summary is provided to introduce a selection of concepts in a simplified form that are further described below in the detailed description. The summary and the background are not intended to identify key concepts or essential aspects of the disclosed subject matter, nor should they be used to constrict or limit the scope of the claims. For example, the scope of the claims should not be limited based on whether the recited subject matter includes any or all aspects noted in the summary and/or addresses any of the issues noted in the background.

### BRIEF DESCRIPTION OF THE DRAWINGS

A further understanding of the nature and advantages of the embodiments may be realized by reference to the following drawings. In the appended figures, similar components or features may have the same reference label.

FIG. 1 illustrates a perspective view of an example sustainable barrier in accordance with aspects of the present disclosure.

FIG. 2 illustrates a front view of the sustainable barrier illustrated in FIG. 1 in accordance with aspects of the present disclosure.

FIG. 3 illustrates a side view of the sustainable barrier illustrated in FIG. 1 in accordance with aspects of the present disclosure.

FIG. 4 illustrates a top view of the sustainable barrier illustrated in FIG. 1 in accordance with aspects of the present disclosure.

FIG. 5 illustrates a bottom view of the sustainable barrier illustrated in FIG. 1 in accordance with aspects of the present disclosure.

FIG. 6 illustrates a first cut-away side view of the sustainable barrier illustrated in FIG. 1 in accordance with aspects of the present disclosure.

FIG. 7 illustrates a second cut-away side view of the sustainable barrier illustrated in FIG. 1 in accordance with aspects of the present disclosure.

FIG. 8 illustrates a perspective view of an example sustainable barrier including a connector system in accordance with aspects of the present disclosure.

FIG. 9 illustrates a front view of the sustainable barrier illustrated in FIG. 8 in accordance with aspects of the present disclosure.

FIG. 10 illustrates a side view of the sustainable barrier illustrated in FIG. 8 in accordance with aspects of the present disclosure.

FIG. 11 illustrates a top view of the sustainable barrier illustrated in FIG. 8 in accordance with aspects of the present disclosure.

FIG. 12 illustrates a bottom view of the sustainable barrier illustrated in FIG. 8 in accordance with aspects of the present disclosure.

FIG. 13 illustrates a partially transparent perspective view of an example sustainable barrier including a connector system in accordance with aspects of the present disclosure.

FIG. 14 illustrates a partially transparent front view of the sustainable barrier illustrated in FIG. 13 in accordance with aspects of the present disclosure.

FIG. 15 illustrates a partially transparent side view of the sustainable barrier illustrated in FIG. 13 in accordance with aspects of the present disclosure.

FIG. 16 illustrates a partially transparent top view of the sustainable barrier illustrated in FIG. 13 in accordance with aspects of the present disclosure.

FIG. 17 illustrates a partially transparent bottom view of the sustainable barrier illustrated in FIG. 13 in accordance with aspects of the present disclosure.

FIG. 18 illustrates a partially transparent perspective view of an example sustainable barrier including a connector system in accordance with aspects of the present disclosure.

FIG. 19 illustrates a partially transparent front view of the sustainable barrier illustrated in FIG. 18 in accordance with aspects of the present disclosure.

FIG. 20 illustrates a partially transparent side view of the sustainable barrier illustrated in FIG. 18 in accordance with aspects of the present disclosure.

FIG. 21 illustrates a partially transparent top view of the sustainable barrier illustrated in FIG. 18 in accordance with aspects of the present disclosure.

FIG. 22 illustrates a partially transparent bottom view of the sustainable barrier illustrated in FIG. 18 in accordance with aspects of the present disclosure.

FIG. 23 illustrates two perspective views of an example sustainable barrier including a connector system in accordance with aspects of the present disclosure.

FIG. 24 illustrates a front view, a side view, a top view, and a bottom view of the sustainable barrier illustrated in FIG. 23 in accordance with aspects of the present disclosure.

FIG. 25 illustrates two perspective views of an example sustainable barrier including a connector system in accordance with aspects of the present disclosure.

FIG. 26 illustrates a front view, a side view, a top view, and a bottom view of the sustainable barrier illustrated in FIG. 25 in accordance with aspects of the present disclosure.

FIG. 27 illustrates two perspective views of an example sustainable barrier including holes and troughs in accordance with aspects of the present disclosure.

FIG. 28 illustrates a front view, a side view, a top view, and a bottom view of the sustainable barrier illustrated in FIG. 27 in accordance with aspects of the present disclosure.

FIG. 29 illustrates a perspective view, a side view, a top view, a front view, and a bottom view of an alternative sustainable barrier in accordance with aspects of the present disclosure.

FIG. 30 illustrates a perspective view, a side view, a top view, a front view, and a bottom view of an alternative sustainable barrier in accordance with aspects of the present disclosure.

FIG. 31 illustrates a perspective view, a side view, a top view, a front view, and a bottom view of an alternative sustainable barrier in accordance with aspects of the present disclosure.

FIG. 32 illustrates a perspective view, a side view, a top view, a front view, and a bottom view of an alternative sustainable barrier in accordance with aspects of the present disclosure.

FIG. 33 illustrates a perspective view, a side view, a top view, a front view, and a bottom view of an alternative sustainable barrier in accordance with aspects of the present disclosure.

FIG. 34 illustrates a perspective view, a side view, a top view, a front view, and a bottom view of an alternative sustainable barrier in accordance with aspects of the present disclosure.

FIG. 35 illustrates a perspective view, a side view, a top view, a front view, and a bottom view of an alternative sustainable barrier in accordance with aspects of the present disclosure.

FIG. 36 illustrates a perspective view, a side view, a top view, a front view, and a bottom view of an alternative sustainable barrier in accordance with aspects of the present disclosure.

FIG. 37 illustrates a perspective view, a side view, a top view, a front view, and a bottom view of an alternative sustainable barrier in accordance with aspects of the present disclosure.

FIG. 38 illustrates a perspective view of an example sustainable barrier in accordance with aspects of the present disclosure.

FIG. 39 illustrates a front view of the sustainable barrier illustrated in FIG. 38 in accordance with aspects of the present disclosure.

FIG. 40 illustrates a side view of the sustainable barrier illustrated in FIG. 38 in accordance with aspects of the present disclosure.

FIG. 41 illustrates a top view of the sustainable barrier illustrated in FIG. 38 in accordance with aspects of the present disclosure.

FIG. 42 illustrates a partially transparent perspective view of the sustainable barrier illustrated in FIG. 38 in accordance with aspects of the present disclosure.

FIG. 43 illustrates a perspective view of the connector system in accordance with aspects of the present disclosure.

FIG. 44 illustrates another perspective view of the connector system illustrated in FIG. 43 in accordance with aspects of the present disclosure.

FIG. 45 illustrates a top view of the connector system illustrated in FIG. 43 in accordance with aspects of the present disclosure.

FIG. 46 illustrates a side view of the connector system illustrated in FIG. 43 in accordance with aspects of the present disclosure.

FIG. 47 illustrates a partially perspective view of the connector system illustrated in FIG. 43 in accordance with aspects of the present disclosure.

FIG. 48 illustrates a perspective view of the connector system in accordance with aspects of the present disclosure.

FIG. 49 illustrates another perspective view of the connector system illustrated in FIG. 48 in accordance with aspects of the present disclosure.

FIG. 50 illustrates a top view of the connector system illustrated in FIG. 48 in accordance with aspects of the present disclosure.

FIG. 51 illustrates a side view of the connector system illustrated in FIG. 48 in accordance with aspects of the present disclosure.

FIG. 52 illustrates a partially perspective view of the connector system illustrated in FIG. 48 in accordance with aspects of the present disclosure.

FIG. 53 illustrates a perspective view of the connector system in accordance with aspects of the present disclosure.

FIG. 54 illustrates another perspective view of the connector system illustrated in FIG. 53 in accordance with aspects of the present disclosure.

FIG. 55 illustrates a top view of the connector system illustrated in FIG. 53 in accordance with aspects of the present disclosure.

FIG. 56 illustrates a side view of the connector system illustrated in FIG. 53 in accordance with aspects of the present disclosure.

FIG. 57 illustrates a partially perspective view of the connector system illustrated in FIG. 53 in accordance with aspects of the present disclosure.

FIG. 58 illustrates a perspective view of the connector system in accordance with aspects of the present disclosure.

FIG. 59 illustrates another perspective view of the connector system illustrated in FIG. 58 in accordance with aspects of the present disclosure.

FIG. 60 illustrates a top view of the connector system illustrated in FIG. 58 in accordance with aspects of the present disclosure.

FIG. 61 illustrates a side view of the connector system illustrated in FIG. 58 in accordance with aspects of the present disclosure.

FIG. 62 illustrates a partially perspective view of the connector system illustrated in FIG. 58 in accordance with aspects of the present disclosure.

FIG. 63 illustrates a perspective view of the connector system in accordance with aspects of the present disclosure.

FIG. 64 illustrates another perspective view of the connector system illustrated in FIG. 63 in accordance with aspects of the present disclosure.

FIG. 65 illustrates a top view of the connector system illustrated in FIG. 63 in accordance with aspects of the present disclosure.

FIG. 66 illustrates a side view of the connector system illustrated in FIG. 63 in accordance with aspects of the present disclosure.

FIG. 67 illustrates a partially perspective view of the connector system illustrated in FIG. 63 in accordance with aspects of the present disclosure.

FIG. 68 illustrates a perspective view of the connector system in accordance with aspects of the present disclosure.

FIG. 69 illustrates another perspective view of the connector system illustrated in FIG. 68 in accordance with aspects of the present disclosure.

FIG. 70 illustrates a top view of the connector system illustrated in FIG. 68 in accordance with aspects of the present disclosure.

FIG. 71 illustrates a side view of the connector system illustrated in FIG. 68 in accordance with aspects of the present disclosure.

FIG. 72 illustrates a perspective view of the barrier including the anchor system in accordance with aspects of the present disclosure.

FIG. 73 illustrates a top view of the barrier including the anchor system illustrated in FIG. 72 in accordance with aspects of the present disclosure.

FIG. 74 illustrates a side view of the barrier including the anchor system illustrated in FIG. 72 in accordance with aspects of the present disclosure.

FIG. 75 illustrates a side sectional view of the barrier including the anchor system illustrated in FIG. 72 in accordance with aspects of the present disclosure.

FIG. 76 illustrates a side sectional view of the barrier including the anchor system illustrated in FIG. 72 in accordance with aspects of the present disclosure.

FIG. 77 illustrates a perspective view of a performance barrier in accordance with aspects of the present disclosure.

FIG. 78 illustrates a perspective view of two of the performance barriers illustrated in FIG. 77 supporting a load in accordance with aspects of the present disclosure.

FIG. 79 illustrates a perspective view of two of the performance barriers illustrated in FIG. 77 supporting a load and securing the load with a strap in accordance with aspects of the present disclosure.

FIG. 80 illustrates an exploded view of the sustainable barriers described herein attached to each other by a connector in accordance with aspects of the present disclosure.

FIG. 81 illustrates a barrier jacket on a barrier in accordance with aspects of the present disclosure.

FIG. 82 illustrates the barrier jacket illustrated in FIG. 81 in an unassembled and an assembled configuration in accordance with aspects of the present disclosure.

FIG. 83 illustrates another barrier jacket on a barrier in accordance with aspects of the present disclosure.

FIG. 84 illustrates an exploded view of a sign attached to a barrier in accordance with aspects of the present disclosure.

FIG. 85 illustrates a front, top, and side view of the sign illustrated in FIG. 84 in accordance with aspects of the present disclosure.

FIG. 86 illustrates a perspective view of another sign attached to a barrier in accordance with aspects of the present disclosure.

FIG. 87 illustrates a front, top, and side view of the sign illustrated in FIG. 86 in accordance with aspects of the present disclosure.

FIG. 88 illustrates a perspective view of a barrier including an embossed design in accordance with aspects of the present disclosure.

FIG. 89 illustrates a front, top, and side view of the barrier with an embossed design illustrated in FIG. 88 in accordance with aspects of the present disclosure.

FIG. 90 illustrates a perspective, exploded view of a barrier including a plurality of protective coverings in accordance with aspects of the present disclosure.

FIG. 91 illustrates a front, top, and side view of the barrier including the plurality of protective coverings illustrated in FIG. 90 in accordance with aspects of the present disclosure.

FIG. 92 illustrates a perspective view of an accessory attachment unit incorporated into a barrier in accordance with aspects of the present disclosure.

FIG. 93 illustrates an exploded view of the accessory attachment unit illustrated in FIG. 92 in accordance with aspects of the present disclosure.

FIG. 94 illustrates a cross-sectional view of the accessory attachment unit illustrated in FIG. 92 in accordance with aspects of the present disclosure.

FIG. 95 illustrates a perspective view and a cross-sectional view of an alternative accessory attachment unit incorporated into a barrier in accordance with aspects of the present disclosure.

FIG. 96 illustrates a perspective view and a cross-sectional view of an alternative accessory attachment unit incorporated into a barrier in accordance with aspects of the present disclosure.

FIG. 97 illustrates a portion of a barrier including reflective material in accordance with aspects of the present disclosure.

FIG. 98 illustrates a perspective view of a barrier in a Jersey style barrier shape in accordance with aspects of the present disclosure.

FIG. 99 illustrates top, bottom, and side views of the barrier illustrated in FIG. 98 in accordance with aspects of the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

The systems and methods disclosed herein relate to, among other things a sustainable barrier that may be used for a variety of purposes including use as a traffic barrier. The sustainable barriers described herein are formed of a waste material and a binder that binds the waste material into a specific shape for a specific use. Additionally, the waste material and the binder may be combined in different ratios with different compositions such that the material that forms the sustainable barrier may be tailored to specific uses. Moreover, the shape of the barriers may be tailored to a specific shape to suit a specific function. Accordingly, the sustainable barriers described herein are formed of a sustainable material with a tailored composition and shape to suit a specific function.

Specifically, in the illustrated embodiments, the waste material used to form the sustainable barriers described herein is used tires. In alternative embodiments, the waste material may be any material including, but not limited to, recycled plastics, recycled wood, and/or any other sustainable or recyclable material. The binder includes a polyurethane binder, an optional colorant, an optional catalyst, and a small amount of water. The used tires are ground to form a crumb rubber and the binder is formulated to bind the crumb rubber into a formed sustainable barrier. Specifically, the binder has been formulated to bind the crumb rubber into the sustainable barrier without using heat. More specifically, the catalyst within the binder quickly forms the sustainable barrier such that heat is not required.

The properties of the waste material and/or the processing conditions may be varied to tune or specify the final properties of the sustainable barrier. Specifically, a specific type of waste material may be selected to achieve a desired physical property within the sustainable barrier. For example, a denser waste material may be selected such that the sustainable barrier is denser and/or harder. The denser/harder sustainable barrier may be useful for specific uses or harsh environments. For example, the denser/harder sustainable barriers may be tailored such that the density is greater than the density of water and may be useful for flood control. Additionally, the denser/harder sustainable barriers may be useful for barriers in high traffic/high speed highways where collisions may cause damage to softer/less dense barriers.

Conversely, a less dense waste material may be selected such that the sustainable barrier is less dense and/or softer. The less dense/softer sustainable barrier may be useful for specific uses or specific environments. For example, the less dense/softer sustainable barriers may be useful for situations where a barrier is needed but the barrier needs to give to protect the object impacting the barrier. For example, barriers at bumper car facilities or go-cart racetracks need to stop the bumper car or go-cart without hurting the occupant or damaging the bumper car or go-cart. Certain waste materials are denser than others and may be suitable for specific situations. For example, tires suitable for large commercial vehicles (such as constructions vehicles and tractor trailers) are typically denser/harder than tires for residential vehicles and bicycles. The density of the sustainable barrier may be tuned by selecting the material the sustainable barrier is made from based on the materials density. Additionally, the density of the sustainable barrier may also be varied based on the compression pressure used to form the barrier. A higher compression pressure increases the density of the sustainable barrier and a lower compression pressure decreases the density of the sustainable barrier.

Furthermore, different mixtures of materials may form different parts of the same barrier with different densities to perform different functions. For example, a first uncured batter (combination of the waste material and the binder in an uncured slurry) may be poured into a mold to form a core of the barrier. The first uncured batter may be tailored to have a high density such that the core provides structural support for the barrier. A second uncured batter may be poured around the core to form a skin of the barrier. The second uncured batter may be tailored to have a lower density such that the skin gives upon impact with the barrier. As such, the densities of the sustainable materials use to form the barriers may be tailored to a specific use for the barrier.

The shape of the sustainable barriers may also be tailored to different uses. That is, the mold used to cure the batter may be configured to have different shapes such that the sustainable barriers are useful for other applications. For example, the sustainable barriers may have the traditional Jersey Barrier shape for use as a traffic divider. In other embodiments, the sustainable barriers may be blocks instead of the traditional Jersey style barrier. The blocks may be stackable on each other such that the sustainable barriers can be formed into a makeshift wall. In still other embodiments, the sustainable barriers may resemble the traditional Jersey Barrier but may have different angles to deflect vehicles in different directions upon impact. As such, the shape of the sustainable barriers may be tailored to different configurations depending on their use.

Furthermore, because the sustainable barriers are made from a waste material (in this case recycled tires), the sustainable barriers are substantially less brittle than traditional concrete barriers and are substantially less likely to break or chip when moved. As describe above, traditional concrete barriers often chip or even break when moved at a construction site. The barriers described herein do not break or chip like traditional concrete barriers. Specifically, the recycled tires used to form the sustainable barriers are flexible and, as such, the sustainable barriers typically bounce or temporarily deform when impacted or dropped. That is, the sustainable barriers described herein do not break or chip like traditional concrete barriers. Accordingly, the sustainable barriers described herein may be more robust than traditional concrete barriers.

Because the sustainable barriers are formed of less brittle, more flexible materials, the sustainable barriers may be stacked on top of each other several levels high for storage or for creating larger barrier structures. For example, the sustainable barriers may be sized and shaped such that the barriers are stacked several levels high on top of each other to form a makeshift wall. In contrast, the traditional Jersey Barriers cannot be stacked to form tall structures that are several levels high.

The sustainable barriers described herein may also include connectors that enable the sustainable barriers to be connected to each other. In some embodiments, the connectors include loops of rebar that extend out from a side of the sustainable barrier and are capable of interfacing with connectors of other sustainable barriers to form an extended barrier structure. The material of the connectors may also reinforce the structure of the barrier. For example, the rebar may extend into the body of the barrier such that the rebar also acts as a barrier if the sustainable barrier is struck by a vehicle. In some embodiments, the connectors may include shaped ends with corresponding shapes that interconnect with each other to interlock. In some embodiments, the connectors may include a shaped connector that interlocks with identical shaped ends of the sustainable barrier.

In some embodiments, the rebar of the connector extends from one side of the sustainable barrier to the other. More specifically, the connectors may include a rebar loop that extends from a connector on one side of the sustainable barrier to a connector on the other side of the sustainable barrier. As such, the rebar loop forms an extra structural component that strengthens the barrier.

In alternative embodiments, the rebar connectors may not extend throughout the sustainable barrier. Rather, the rebar connector only extends into the sustainable barrier a short distance. In this embodiment, the connector does not provide as much structural reinforcement as the rebar loop embodiment described above and may be designed to separate in the event of an impact. In this embodiment, the rebar connector may be sized and shaped to maintain the connector within the sustainable barrier. For example, the ends of the connector may be turned up or may be twisted to create a tortuous pull-out path in the event of an impact.

Accordingly, the embodiments of sustainable barriers described herein are formed of a sustainable material that may be tailored to a specific use. Specifically, the density of the material may be tailored such that the relative hardness of the material of portions of the sustainable barriers may be tailored for different uses. Furthermore, the shape of the sustainable barriers may also be tailored for different uses. As such, the sustainable barriers described herein may be tailored for different uses and are entirely sustainable.

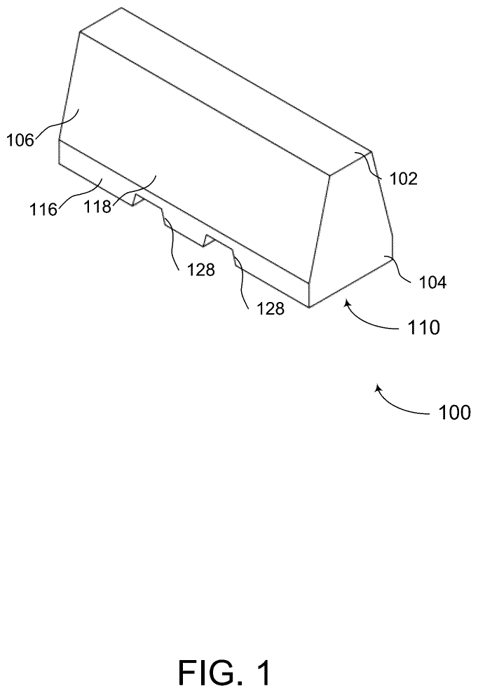

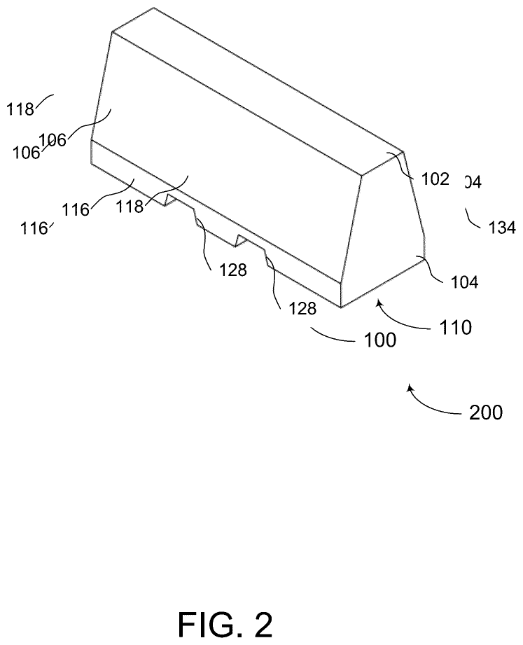

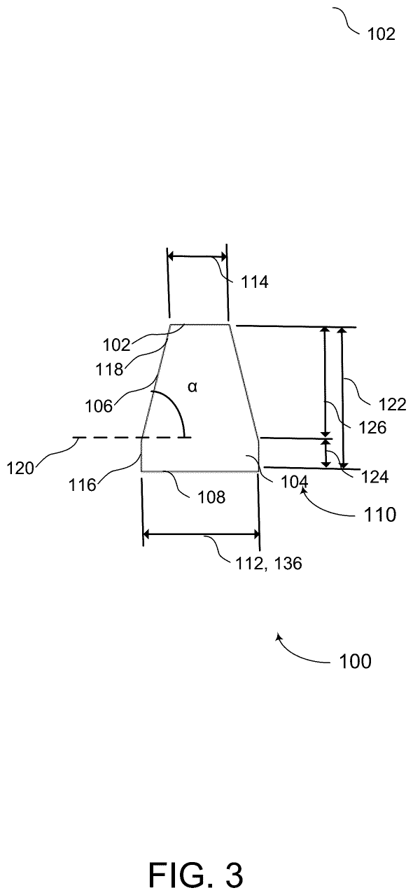

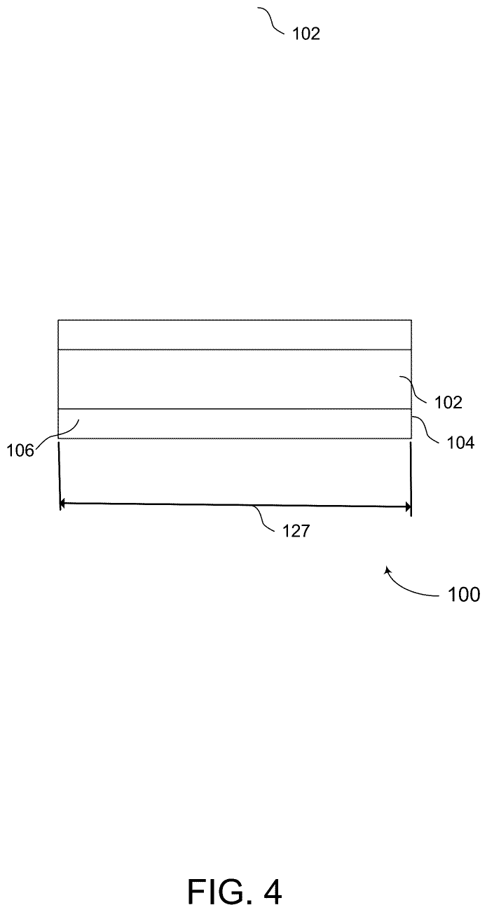

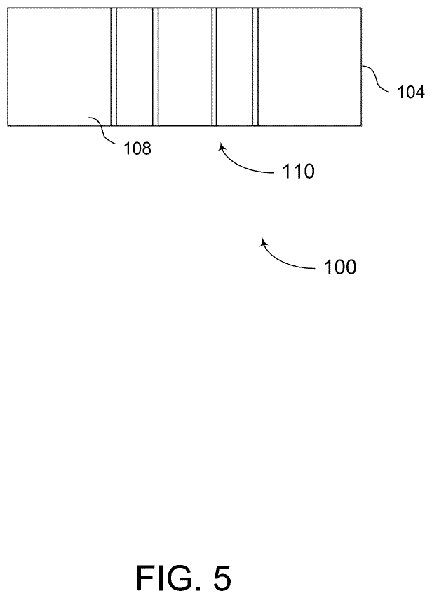

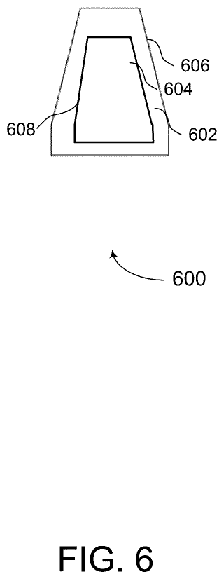

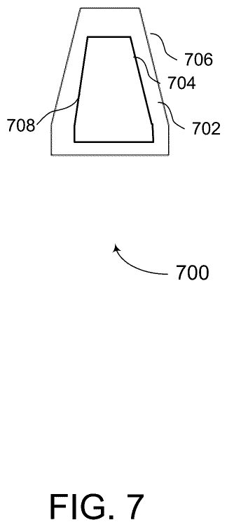

FIG. 1 illustrates a perspective view of an example sustainable barrier 100. FIG. 2 illustrates a front view of the sustainable barrier 100 illustrated in FIG. 1. FIG. 3 illustrates a side view of the sustainable barrier 100 illustrated in FIG. 1. FIG. 4 illustrates a top view of the sustainable barrier 100 illustrated in FIG. 1. FIG. 5 illustrates a bottom view of the sustainable barrier 100 illustrated in FIG. 1. FIG. 6 illustrates a first cut-away side view of the sustainable barrier 100 illustrated in FIG. 1. FIG. 7 illustrates a second cut-away side view of the sustainable barrier 100 illustrated in FIG. 1.

As shown in FIGS. 1-7, the sustainable barrier 100 includes a top 102, two narrow sides 104, two broad sides 106, and a bottom 108. In the illustrated embodiment, the two narrow sides 104 have substantially the same shape such that the two narrow sides 104 are substantially the same. Similarly, the two broad sides 106 have substantially the same shape such that t two broad sides 106 are substantially the same. In alternative embodiments, the two narrow sides 104 and the two broad sides 106 may each have a unique shape such that each of the two narrow sides 104 and the two broad sides 106 are different from each other.

In the illustrated embodiment, the sustainable barrier 100 has a wide base 110 and a narrow top 102. The two broad sides 106 are angled to shape both the wide base 110 and the narrow top 102. The narrow top 102 is substantially flat to facilitate stacking a plurality of sustainable barriers 100 on top of each other. The two narrow sides 104 are substantially flat to facilitate aligning a plurality of sustainable barriers 100 in a row to form a long, continuous barrier. For example, a plurality of sustainable barriers 100 may be arranged by aligning one of the narrow sides 104 of a first sustainable barrier 100 with one of the narrow sides 104 of a second sustainable barrier 100 and the other of the narrow sides 104 of the first sustainable barrier 100 with one of the narrow sides 104 of a third sustainable barrier 100 to form a row in the median of a road. This long, continuous barrier in the middle of the road reduces the risk of head on collisions and improves the overall safety of traveling on the road.

As shown in FIG. 3, the bottom 108 is substantially flat and defines a bottom width 112. The top 102 is also substantially flat and defines a top width 114. In the illustrated embodiment, the bottom width 112 is approximately 18 inches to approximately 24 inches wide and the top width 114 is approximately 7 inches to approximately 16 inches wide. In alternative embodiments, the bottom width 112 and the top width 114 may be any width that enables the sustainable barrier 100 to operate as described herein.

In the illustrated embodiment, the two broad sides 106 each include a vertical base 116 and an angled top 118. The vertical base 116 extends substantially vertically from the bottom 108 and the angle top 118 extends at an angle α relative to grade or a horizontal line 120 parallel to grade from the vertical base 116 to the top 102. The two broad sides 106 each define a sustainable barrier height 122, the two vertical bases 116 each define a vertical base height 124, and the two angle tops 118 each define an angled top height 126. In the illustrated embodiment, the sustainable barrier height 122 is approximately 30 inches to approximately 42 inches high, the vertical base height 124 is approximately 0 inches to approximately 12 inches high, the angled top height 126 is approximately 0 inches to approximately 42 inches high, and the angle α is approximately 70° to approximately 90°. More specifically, in the illustrated embodiment, the sustainable barrier height 122 is 30, 32, 36, or 40 inches high, the vertical base height 124 is 8 inches high, the angled top height 126 is 24 inches high, and the angle α is 76°. In alternative embodiments, the sustainable barrier height 122, the vertical base height 124, the angled top height 126, and the angle α may be any height or angle that enables the sustainable barrier 100 to operate as described herein.

As shown in FIG. 2, the top 102 and the two broad sides 106 each define a sustainable barrier length 127. In the illustrated embodiment, the sustainable barrier length 127 is approximately 48 inches to approximately 240 inches long. More specifically, in the illustrated embodiment, the sustainable barrier length 127 may be any 2-foot increment length between 4 feet and 20 feet. In alternative embodiments, the sustainable barrier length 127 may be any length that enables the sustainable barrier 100 to operate as described herein. Additionally, the wide base 110, the bottom 108, and the vertical bases 116 each define at least one drainage slot 128. In the illustrated embodiment, the sustainable barrier 100 includes two drainage slots 128. In alternative embodiments, the sustainable barrier 100 may include any number of drainage slots 128 including, but not limited to, one, three, four, or more drainage slots 128.

The drainage slots 128 facilitate water drainage from one side of the sustainable barrier 100 to the other. In alternative embodiments the drainage slot 128 may extend along a length of the sustainable barrier rather than across the width of the sustainable barrier. Additionally, the drainage slots 128 may also be used to facilitate movement of the sustainable barrier 100. More specifically, in the illustrated embodiment, the drainage slots 128 are positioned to enable a forklift (not shown) or some other equipment to pick up and move the sustainable barrier 100. More specifically, in the illustrated embodiment, the drainage slots 128 each define a drainage slot bottom width 130, a drainage slot top width 132, a drainage slot height 134, and a drainage slot length 136. In the illustrated embodiment, the drainage slot length 136 is equal to the bottom width 112 such that the drainage slots 128 each extend through the wide base 110 of the sustainable barrier 100. Additionally, the drainage slot widths 130 and 132 and the drainage slot height 134 are each sized and shaped to enable water to drain from one side of the sustainable barrier 100 to the other and to enable the prongs of a forklift to be inserted into the drainage slots 128 for picking up the sustainable barrier 100. In the illustrated embodiment, the drainage slot bottom width 130 is approximately 12 inches to approximately 24 inches wide, the drainage slot top width 132 is approximately 12 inches to approximately 26 inches wide, the drainage slot height 134 is approximately 3 inches to approximately 6 inches high, and the drainage slot length 136 is approximately 18 inches to approximately 24 inches long. More specifically, for a sustainable barrier with a length 127 of approximately 6 feet, the drainage slot bottom width 130 is 11 inches wide, the drainage slot top width 132 is 10 inches wide, the drainage slot height 134 is 3.5 inches high, and the drainage slot length 136 is 24 inches long. Additionally, for a sustainable barrier with a length 127 of approximately 8 feet, the drainage slot bottom width 130 is 26 inches wide, the drainage slot top width 132 is 25 inches wide, the drainage slot height 134 is 3.5 inches high, and the drainage slot length 136 is 18 inches long. In alternative embodiments, the drainage slot bottom width 130, the drainage slot top width 132, the drainage slot height 134, and the drainage slot length 136 may be any length that enables the sustainable barrier 100 to operate as described herein.

As discussed above, the sustainable barriers 100 described herein are formed of a waste material and a binder that binds the waste material into a specific shape for a specific use. The waste material and the binder may be combined in different ratios with different compositions such that the material that forms the sustainable barrier 100 may have portions with different densities. Additionally, the shape of the sustainable barriers 100 may be tailored to a specific shape to suit a specific function. Accordingly, the sustainable barriers 100 described herein are formed of a sustainable material with a tailored composition and shape to suit a specific function.

Specifically, in the illustrated embodiments, the waste material used to form the sustainable barriers 100 described herein is used tires. In alternative embodiments, the waste material may be any material including, but not limited to, recycled plastics, recycled wood, and/or any other sustainable or recyclable material. The used tires are ground to form a crumb rubber and the binder is formulated to bind the crumb rubber into a formed sustainable barrier 100. In the illustrated embodiments, the waste material is approximately 90% to approximately 99% by weight of the sustainable barrier 100, approximately 91% to approximately 99% by weight of the sustainable barrier 100, approximately 92% to approximately 99% by weight of the sustainable barrier 100, approximately 93% to approximately 99% by weight of the sustainable barrier 100, approximately 94% to approximately 99% by weight of the sustainable barrier 100, approximately 95% to approximately 99% by weight of the sustainable barrier 100, or approximately 95% to approximately 98% by weight of the sustainable barrier 100. In alternative embodiments, the composition of the waste material in the sustainable barriers 100 described herein may be any amount that enables the sustainable barriers 100 to operate as described herein.

The properties of the waste material and/or the processing conditions may be varied to tune or specify the final properties of the sustainable barrier. Specifically, a specific type of waste material may be selected to achieve a desired physical property within the sustainable barrier. For example, a denser waste material may be selected such that the sustainable barrier is denser and/or harder. The denser/harder sustainable barrier may be useful for specific uses or harsh environments. For example, the denser/harder sustainable barriers may be tailored such that the density is greater than the density of water and may be useful for flood control. Additionally, the denser/harder sustainable barriers may be useful for barriers in high traffic/high speed highways where collisions may cause damage to softer/less dense barriers. In some embodiments, the waste material may be crumb rubber including 10/20 mesh size granules, 10 mesh size granules, 20 mesh size granules, and/or any size granules.

Conversely, a less dense waste material may be selected such that the sustainable barrier is less dense and/or softer. The less dense/softer sustainable barrier may be useful for specific uses or specific environments. For example, the less dense/softer sustainable barriers may be useful for situations where a barrier is needed but the barrier needs to give to protect the object impacting the barrier. For example, barriers at bumper car facilities or go-cart racetracks need to stop the bumper car or go-cart without hurting the occupant or damaging the bumper car or go-cart. Certain waste materials are denser than others and may be suitable for specific situations. For example, tires suitable for large commercial vehicles (such as constructions vehicles and tractor trailers) are typically denser/harder than tires for residential vehicles and bicycles. The density of the sustainable barrier may be tuned by selecting the material the sustainable barrier is made from based on the materials density. Additionally, the density of the sustainable barrier may also be varied based on the compression pressure used to from the barrier. A higher compression pressure increases the density of the sustainable barrier and a lower compression pressure decreases the density of the sustainable barrier.

The binder includes a polyurethane binder, an optional colorant, a catalyst, and a small amount of water. The binder has been formulated to bind the crumb rubber into the sustainable barriers 100 described herein without using heat. More specifically, the catalyst within the binder quickly forms the sustainable barriers 100 such that heat is not required to cure the sustainable barriers 100. In the illustrated embodiments, the binder is approximately 10% to approximately 1% by weight of the sustainable barrier 100, approximately 9% to approximately 1% by weight of the sustainable barrier 100, approximately 8% to approximately 1% by weight of the sustainable barrier 100, approximately 7% to approximately 1% by weight of the sustainable barrier 100, approximately 6% to approximately 1% by weight of the sustainable barrier 100, approximately 5% to approximately 1% by weight of the sustainable barrier 100, or approximately 5% to approximately 2% by weight of the sustainable barrier 100. In alternative embodiments, the composition of the binder in the sustainable barriers 100 described herein may be any amount that enables the sustainable barriers 100 to operate as described herein.

The polyurethane binder includes a polyurethane adhesive. In the illustrated embodiment, the polyurethane binder includes an aromatic polyurethane binder. More specifically, the polyurethane binder may include Stobicoll® R 1142, Stobicoll® R 359, Stobicoll® R 1129, Stobicoll® R 382, Stobicoll® R 401, Stobicoll® R 1160, Polyval® GN416, Polyval® GN418, and/or Poly Tree® Fusion. In the illustrated embodiments, the polyurethane binder is approximately 10% to approximately 1% by weight of the waste material, approximately 10% to approximately 1.5% by weight of the waste material, approximately 9% to approximately 1% by weight of the waste material, approximately 8% to approximately 1% by weight of the waste material, approximately 7% to approximately 1% by weight of the waste material, approximately 6% to approximately 1% by weight of the waste material, approximately 5% to approximately 1% by weight of the waste material, or approximately 2.5% to approximately 2% by weight of the waste material. In alternative embodiments, the composition of the polyurethane binder in the sustainable barriers 100 described herein may be any amount that enables the sustainable barriers 100 to operate as described herein.

The colorant includes any material configured to dye the waste material and the binder a color. In the illustrated embodiments, the colorant is approximately 10% to approximately 1% by weight of the waste material, approximately 10% to approximately 1.5% by weight of the waste material, approximately 9% to approximately 1% by weight of the waste material, approximately 8% to approximately 1% by weight of the waste material, approximately 7% to approximately 1% by weight of the waste material, approximately 6% to approximately 1% by weight of the waste material, approximately 5% to approximately 1% by weight of the waste material, or approximately 5% to approximately 2.5% by weight of the waste material. In alternative embodiments, the composition of the colorant in the sustainable barriers 100 described herein may be any amount that enables the sustainable barriers 100 to operate as described herein.

The catalyst or accelerant includes a polyether polyol-based catalyst configured increase polyurethane reactivity. In the illustrated embodiment, the catalyst or accelerant includes Stobiblend® Z 952.50, Stobiblend® Z 1959, and/or Polyval® 910624. In the illustrated embodiments, the catalyst is approximately 1% to approximately 0.001% by weight of the waste material, approximately 0.5% to approximately 0.001% by weight of the waste material, approximately 0.1% to approximately 0.001% by weight of the waste material, approximately 0.05% to approximately 0.001% by weight of the waste material, approximately 0.01% to approximately 0.001% by weight of the waste material, approximately 0.005% to approximately 0.001% by weight of the waste material, approximately 0.003% to approximately 0.001% by weight of the waste material, or approximately 0.002% by weight of the waste material. In alternative embodiments, the composition of the catalyst in the sustainable barriers 100 described herein may be any amount that enables the sustainable barriers 100 to operate as described herein. In some embodiments, the catalyst may not be included in the sustainable barrier 100. Rather, environmental conditions such as temperature and humidity levels will determine if catalyst is used, and how much catalyst is used.

In the illustrated embodiments, water is approximately 1% to approximately 0.01% by weight of the waste material, approximately 0.5% to approximately 0.01% by weight of the waste material, approximately 0.1% to approximately 0.01% by weight of the waste material, approximately 0.05% to approximately 0.01% by weight of the waste material, approximately 0.04% to approximately 0.01% by weight of the waste material, approximately 0.03% to approximately 0.01% by weight of the waste material, approximately 0.02% to approximately 0.01% by weight of the waste material, or approximately 0.02% by weight of the waste material. n alternative embodiments, the composition of water in the sustainable barriers 100 described herein may be any amount that enables the sustainable barriers 100 to operate as described herein. In some embodiments, water may not be included in the sustainable barrier 100. Rather, environmental conditions such as temperature and humidity levels will determine if water is used, and how much catalyst is used.

The waste material and the binder are combined into a batter. The batter is put into a mold and the mold cures the batter into the sustainable barriers 100 described herein at high pressure. The sustainable barrier 100 is then removed from the mold. In the illustrated embodiment, the catalyst enables the sustainable barrier 100 to be cured without the use of heat to cure the binder, substantially reducing costs and the complexity of the manufacturing process.

The sustainable barrier 100 may be cured from a single batter. However, in some embodiments, the sustainable barrier 100 may be formed of more than one batter. For example, as shown in FIGS. 6 and 7 illustrate cut-away side views of the sustainable barriers 100 described herein. Specifically, FIG. 6 illustrates a sustainable barrier 600 including a first layer 602 and a second layer 604. The first layer 602 forms an outer skin 606 of the sustainable barrier 600 and is formed from a batter that includes a relatively low dense waste material and/or was formed with a lower compression pressure. The second layer 604 forms a core 608 of the sustainable barrier 600 and is formed from a batter that includes a relatively high dense waste material and/or was formed with a higher compression pressure. As such, the first layer 602 has a lower density than the second layer 604 and has a lower hardness than the second layer 604. As such, the sustainable barrier 600 has a softer outer skin 606 that absorbs impacts and a harder core 608 that provides structural stability to the sustainable barrier 600.

FIG. 7 illustrates a sustainable barrier 700 including a first layer 702 and a second layer 704. The first layer 702 forms an outer skin 706 of the sustainable barrier 700 and is formed from a batter that includes a relatively high dense waste material and/or was formed with a higher compression pressure. The second layer 704 forms a core 708 of the sustainable barrier 700 and is formed from a batter that includes a relatively low dense waste material and/or was formed with a lower compression pressure. As such, the first layer 702 has a higher density than the second layer 704 and has a higher hardness than the second layer 704. As such, the sustainable barrier 700 has a harder outer skin 706 for increased durability and a softer core 708 that provides flexibility to the sustainable barrier 700.

As described above, the sustainable barriers 100, 600, and 700 may be designed for different uses. For example, a motorcycle racetrack may require a barrier with a softer outer skin and a harder core. Riders may crash into the barriers and the softer outer skin may improve the safety of the motorcycle racetrack. However, a racetrack for traditional vehicles may require a barrier with a harder outer skin and a softer core to improve the durability of the barriers while also allowing the barriers to be flexible and absorb impacts. As such, the composition of the waste material and the binder may be tuned to produce layers or entire barriers with different properties that have different uses.

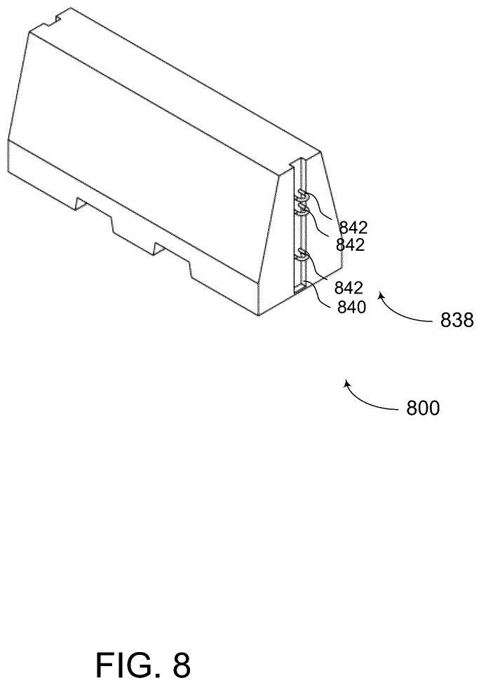

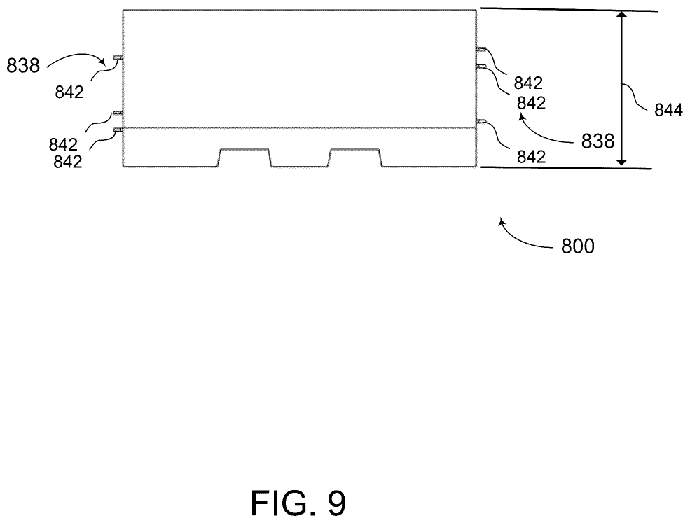

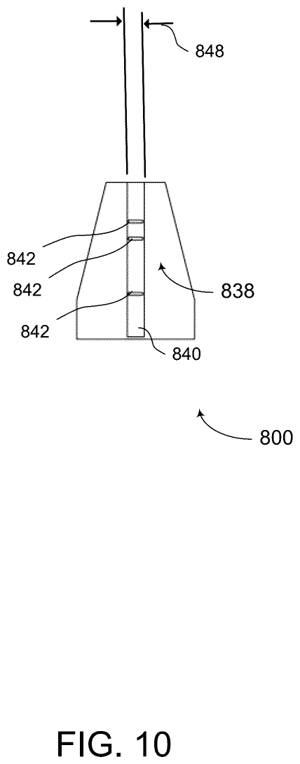

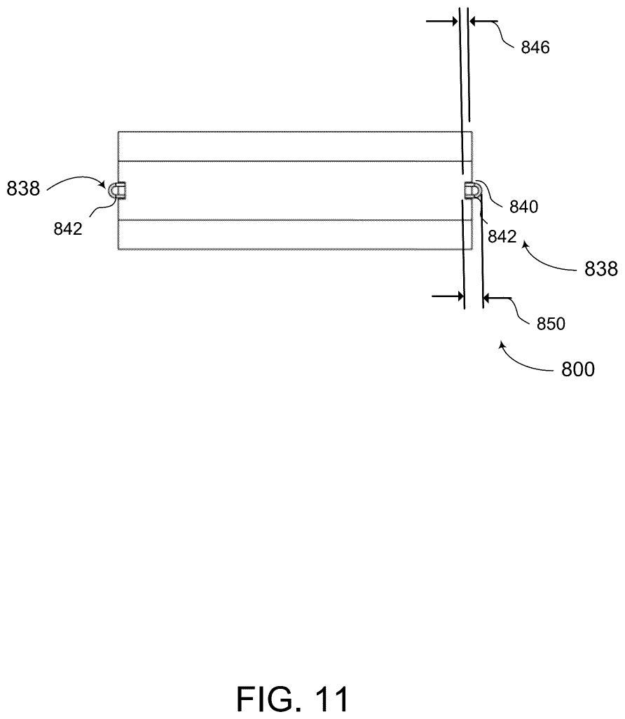

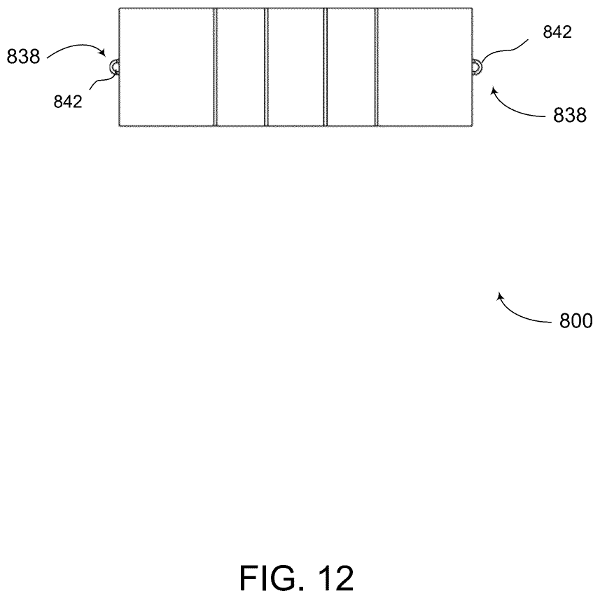

FIGS. 8-12 illustrate a sustainable barrier 800 including a connector system 838. FIG. 8 illustrates a perspective view of the sustainable barrier 800 including a connector system. FIG. 9 illustrates a front view of the sustainable barrier 800 illustrated in FIG. 8. FIG. 10 illustrates a side view of the sustainable barrier 800 illustrated in FIG. 8. FIG. 11 illustrates a top view of the sustainable barrier 800 illustrated in FIG. 8. FIG. 12 illustrates a bottom view of the sustainable barrier 800 illustrated in FIG. 8. As shown in FIGS. 8-12, the sustainable barrier 800 is substantially similar to the sustainable barriers 100, 600, and 700 except that the two narrow sides 804 include a groove 840 and the connector system 838 extends from the groove 840. The connector system 838 includes at least one loop 842 extending from the groove 840. In the illustrated embodiment, the connector system 838 includes a plurality of loops 842 extending from the groove 840. Specifically, in the illustrated embodiments, the connector system 838 includes three loops 842 extending from the groove 840 on each of the two narrow sides 804. In alternative embodiments, the connector system 838 may include any number loops 842 extending from the groove 840 on each of the two narrow sides 804. In the illustrated embodiment, the loops 842 include rebar loops, solid steel loops, stainless steel loops, fiberglass loops, and/or composite loops. In alternative embodiments, the loops 842 may be formed of any material that enables the connector system 838 to operate as described herein.

The groove 840 defines a groove height 844, a groove depth 846, and a groove width 848. Additionally, the loops 842 each define a loop length 850. The groove depth 846 and the loop length 850 are configured to enable the loops 842 of a first barrier 800 to be inserted into the groove 840 of a second barrier 800 such that the narrow side 804 of the first barrier 800 is flush with the narrow side 804 of the second barrier 800 to form a longer, extend barrier. The loops 842 are each positioned at different heights such that each loop 842 cannot interfere with another loop 842 when the loops 842 are inserted into the grooves 840. Additionally, a connector (not shown) is inserted into the loops 842 of both the first barrier 800 and the second barrier 800 to hold the two barriers together. As such, the connector system 838 enables the sustainable barriers 800 to be connected to each other to strengthen the connected barriers.

In the illustrated embodiment, the groove height 844 is about 30 inches to about 42 inches, the groove depth 846 is about 1 inch to about 2 inches, the groove width 848 is about 3 inches to about 5 inches, and the loop length 850 is about 2 inches to about 4 inches. Specifically, in the illustrated embodiment, the groove height 844 is about 30 inches, the groove depth 846 is about 1.375 inches, the groove width 848 is about 3.5 inches, and the loop length 850 is about 3.25 inches. In alternative embodiments, the groove height 844, the groove depth 846, the groove width 848, and the loop length 850 may be any length that enables the sustainable barriers 800 described herein to operate as described herein.

To strengthen the connections between the barriers 800, the loops 842 may be set into the batter before the batter is cured into the sustainable barriers 800. As such, the connections between the barriers 800 are strengthened because the sustainable barriers 800 are cured around the loops 842 and the binder adheres the loops 842 to the rest of the sustainable barriers 800. However, to further strengthen the connections between the barriers 800, shape of the loops 842 within the sustainable barriers 800 may be varied to improve the strength of the loops 842 and the bond between the loops 842 and the sustainable barriers 800.

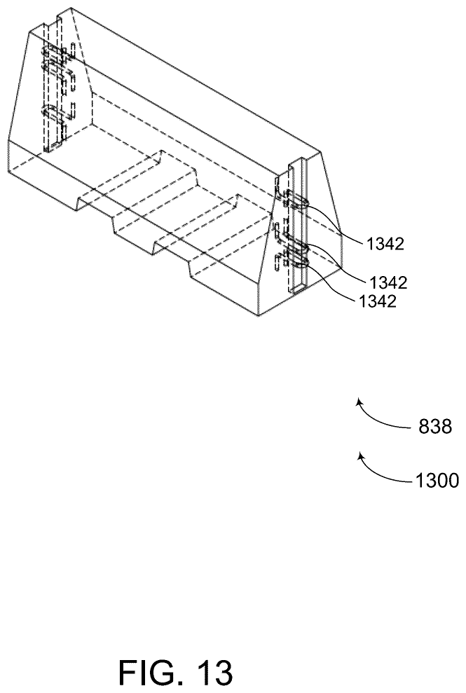

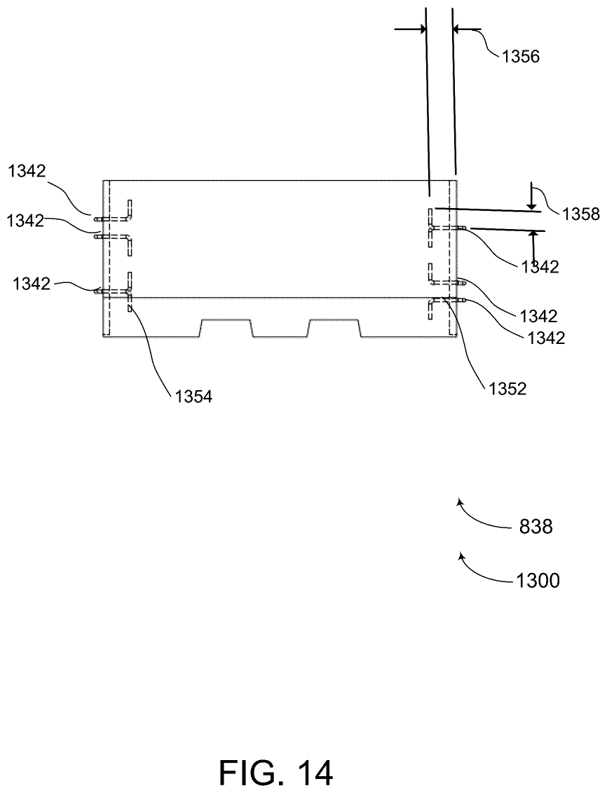

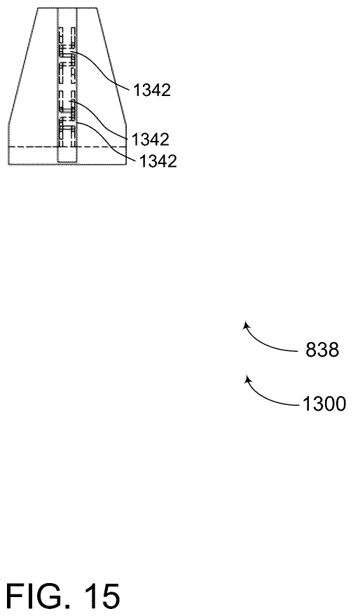

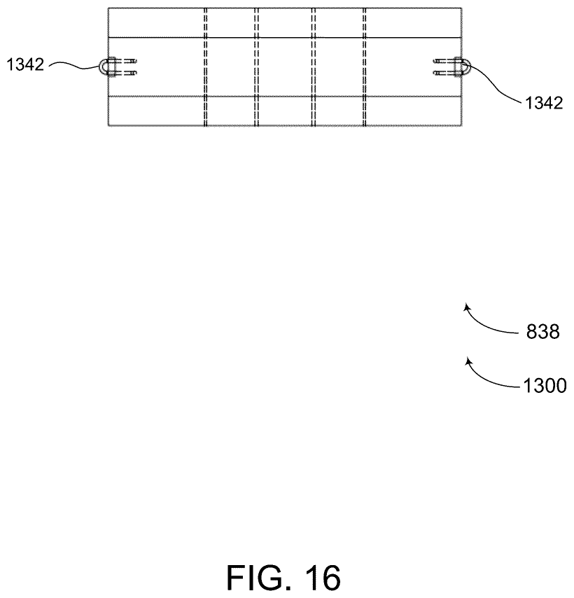

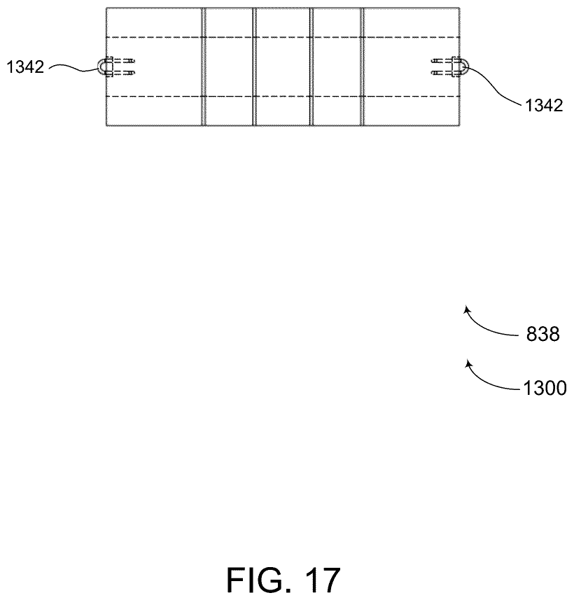

For example, FIGS. 13-17 illustrate a sustainable barrier 1300 including the connector system 838 including loops 1342 with ends extending different directions within the sustainable barrier 1300. FIG. 13 illustrates a partially transparent perspective view of the sustainable barrier 1300 including a connector system. FIG. 14 illustrates a partially transparent front view of the sustainable barrier 1300 illustrated in FIG. 13. FIG. 15 illustrates a partially transparent side view of the sustainable barrier 1300 illustrated in FIG. 13. FIG. 16 illustrates a partially transparent top view of the sustainable barrier 1300 illustrated in FIG. 13. FIG. 17 illustrates a partially transparent bottom view of the sustainable barrier 1300 illustrated in FIG. 13. As shown in FIGS. 13-17, the loops 1342 each include two horizontal portions 1352 and two ends 1354 that are oriented in opposite directions. The connection of the loops 1342 to the sustainable barriers 1300 is strengthened because the two horizontal portions 1352 each extend a horizontal portion distance 1356 into the sustainable barrier 1300 and the two ends 1354 each extend substantially orthogonally from the two horizontal portions 1352 an end distance 1358 in opposite directions. As such, the loops 1342 are substantially more difficult to pull out of the sustainable barriers 1300 because the two horizontal portions 1352 and are shaped to resist a pulling force two ends 1354. In the illustrated embodiment, the horizontal portion distance 1356 is about 7 inches to about 10 inches and the end distance 1358 is about 4 inches to about 6 inches. In alternative embodiments, the horizontal portion distance 1356 and the end distance 1358 may be any length that enables the sustainable barriers 1300 described herein to operate as described herein.

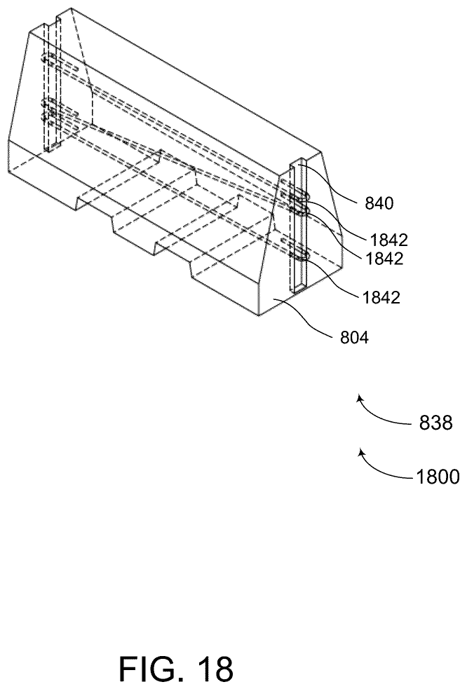

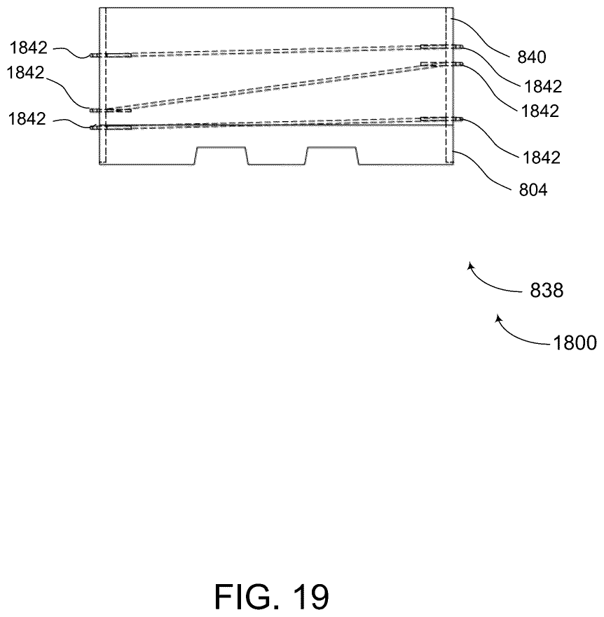

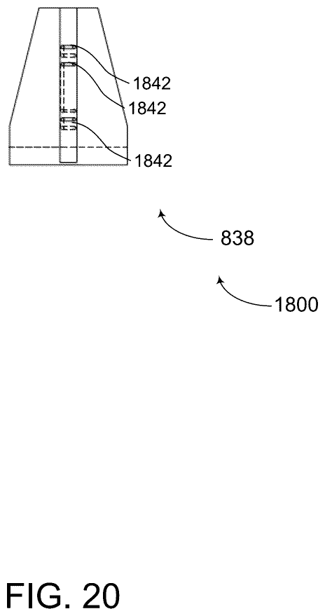

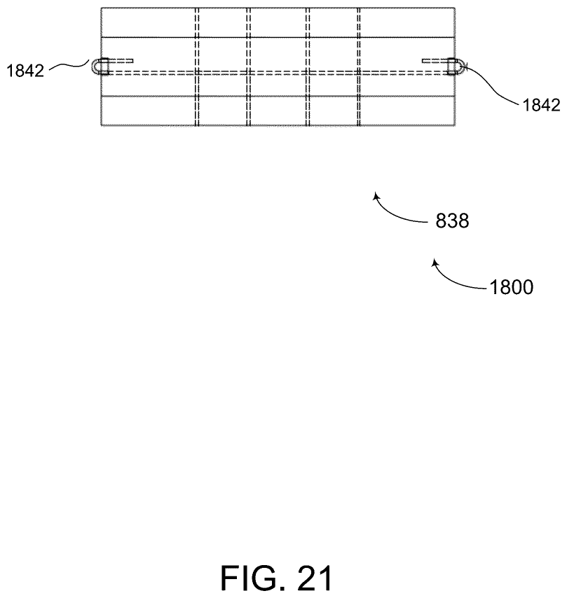

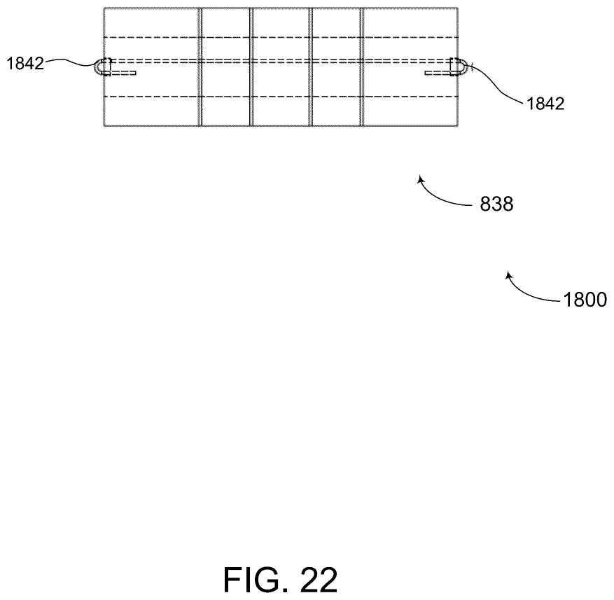

FIGS. 18-22 illustrate a sustainable barrier 1800 including the connector system 838 including loops 1842 that extend through the sustainable barrier length 127 of the sustainable barrier 1800. FIG. 18 illustrates a partially transparent perspective view of the sustainable barrier 1800 including a connector system. FIG. 19 illustrates a partially transparent front view of the sustainable barrier 1800 illustrated in FIG. 18. FIG. 20 illustrates a partially transparent side view of the sustainable barrier 1800 illustrated in FIG. 18. FIG. 21 illustrates a partially transparent top view of the sustainable barrier 1800 illustrated in FIG. 18. FIG. 22 illustrates a partially transparent bottom view of the sustainable barrier 1800 illustrated in FIG. 18. As shown in FIGS. 18-22, the loops 1842 are formed of a single piece of rebar that extend through the sustainable barrier length 127 of the sustainable barrier 1800 and form another loop 1842 extending from the opposite groove 840 on the opposite narrow side 804 of the sustainable barrier 1800. As such, the loops 1842 on opposite sides of the sustainable barriers 1800 are connected by a single piece of rebar that strengthens the connection of the loops 1842 to the sustainable barriers 1800 and the connection between the sustainable barriers 1800.

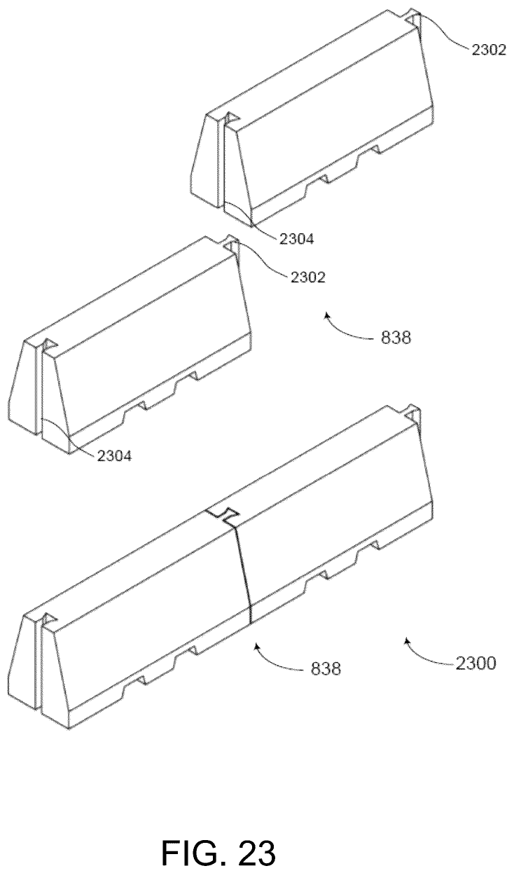

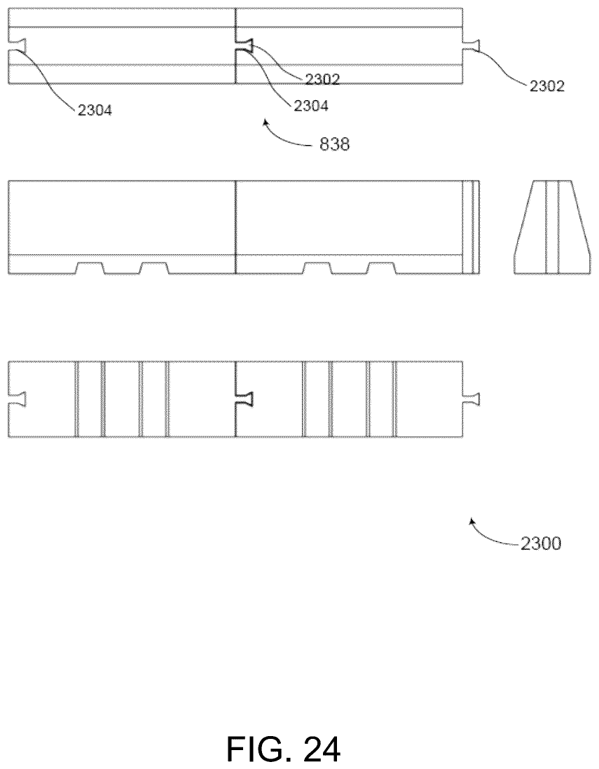

FIGS. 23-24 illustrate a sustainable barrier 2300 including the connector system 838 including a tongue 2302 and a groove 2304. FIG. 23 illustrates two perspective views of the sustainable barrier 2300 including a connector system. FIG. 24 illustrates a front view, a side view, a top view, and a bottom view of the sustainable barrier 2300 illustrated in FIG. 23. As shown in FIGS. 23-24, the tongue 2302 is integrally formed with the sustainable barrier 2300 and extends from a first end of the sustainable barrier 2300. The groove 2304 is integrally formed into a second end of the sustainable barrier 2300. In the illustrated embodiment, the tongue 2302 and the groove 2304 each have complementary shapes. For example, in the illustrated embodiment, the tongue 2302 has a trapezoidal shape and the groove 2304 has a correspond trapezoidal shape. In order to connect adjacent sustainable barriers 2300, one of the sustainable barriers 2300 is lifted above another sustainable barrier 2300 such that one of the tongue 2302 or the groove 2304 align with the one of the tongue 2302 or the groove 2304 of the other sustainable barrier 2300. The sustainable barrier 2300 is lowered such that the tongue 2302 of the sustainable barrier 2300 slides into the groove 2304 of the other sustainable barrier 2300. As such, the tongue 2302 and the groove 2304 on opposite sides of the sustainable barriers 2300 facilitate connecting sustainable barriers 2300.

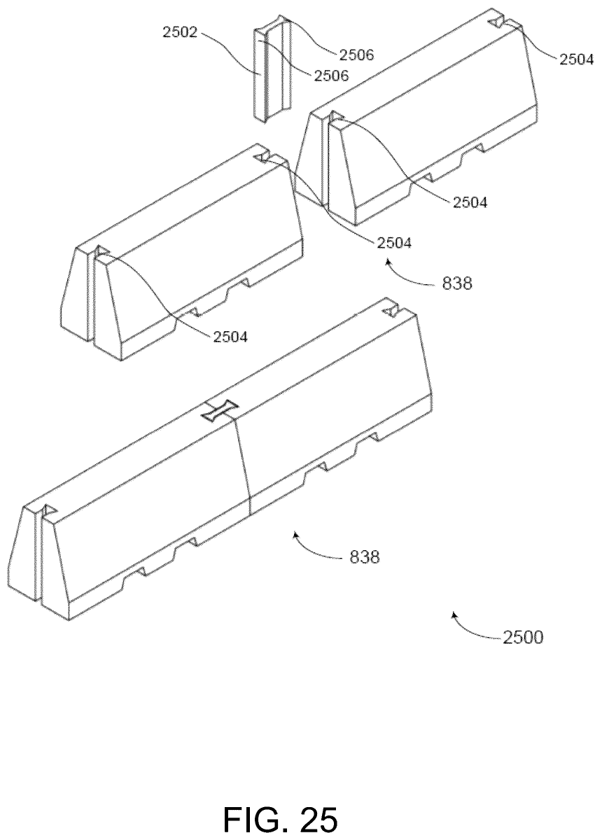

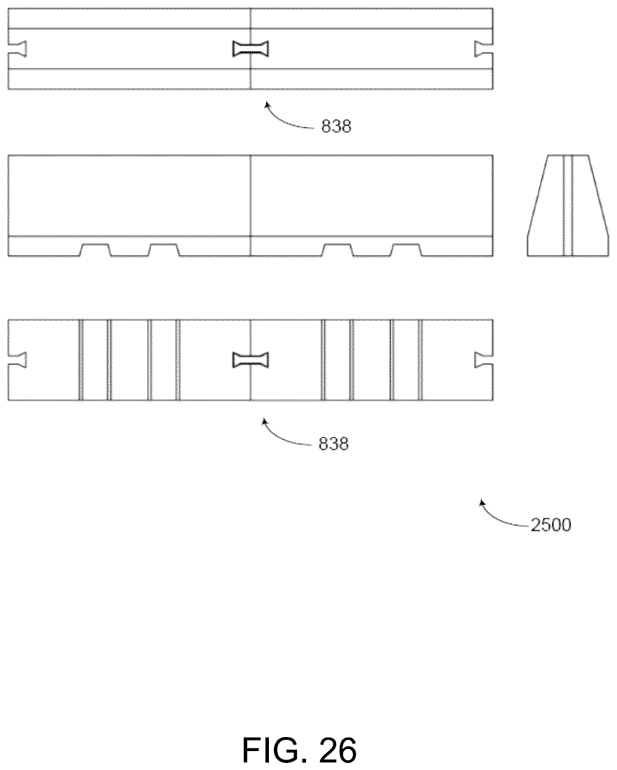

FIGS. 25-26 illustrate a sustainable barrier 2500 including the connector system 838 including a connector 2502 and a groove 2504. The connector 2502 includes two tongues 2306. FIG. 25 illustrates two perspective views of the sustainable barrier 2500 including a connector system. FIG. 26 illustrates a front view, a side view, a top view, and a bottom view of the sustainable barrier 2500 illustrated in FIG. 25. As shown in FIGS. 25-26, the connector 2502 is formed separately from the sustainable barrier 2500 and the tongues 2506 are configured to slide into the grooves 2504. The grooves 2504 are integrally formed into both ends of the sustainable barrier 2500. In the illustrated embodiment, the tongues 2506 and the grooves 2504 each have complementary shapes. For example, in the illustrated embodiment, the tongues 2506 has a trapezoidal shape and the grooves 2504 has a correspond trapezoidal shape. In order to connect adjacent sustainable barriers 2500, the connector 2502 is lifted above the sustainable barriers 2500 such that each of the tongues 2506 aligns with each of the grooves 2504. The connector 2502 is lowered such that the tongues 2506 slides into the grooves 2504 of the sustainable barriers 2500. As such, the connector 2502 facilitates connecting sustainable barriers 2500.

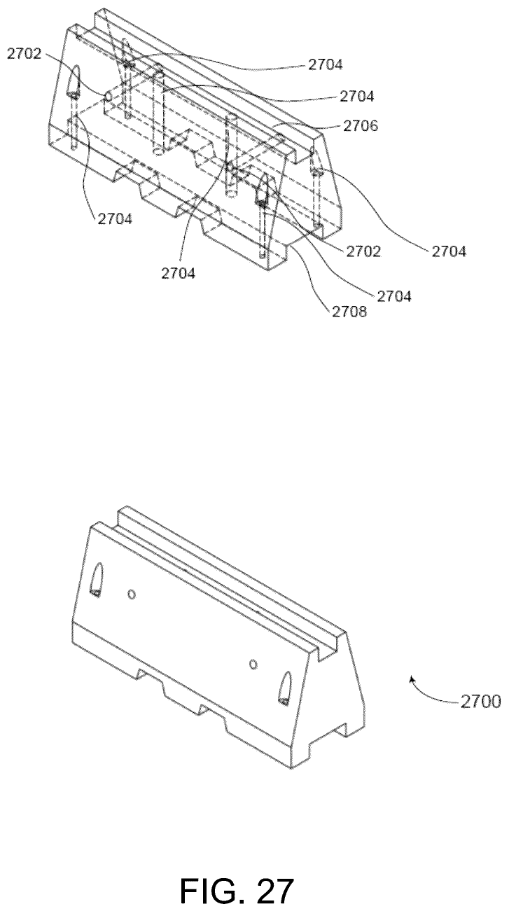

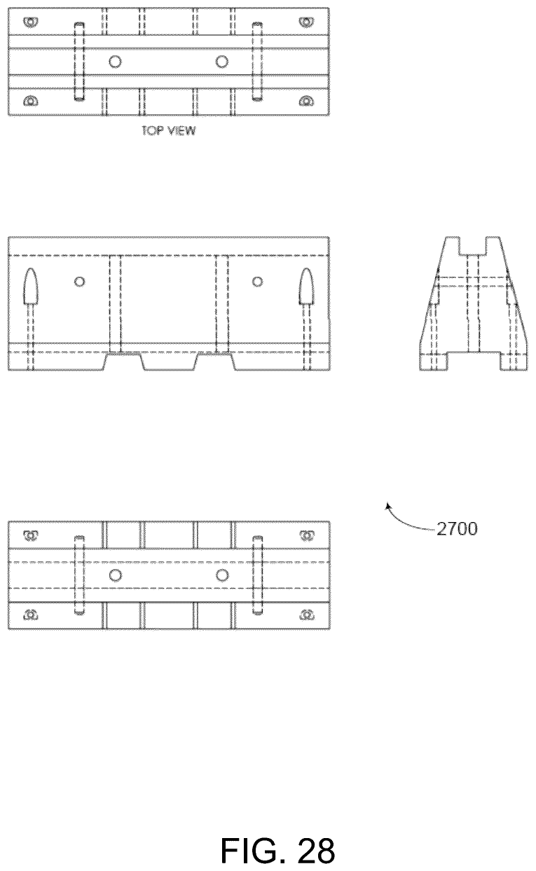

FIGS. 27-28 illustrate a sustainable barrier 2700 including lifting holes 2702, mounting holes 2704, a top trough 2706, and a bottom trough 2708. FIG. 27 illustrates two perspective views of the sustainable barrier 2700. FIG. 28 illustrates a front view, a side view, a top view, and a bottom view of the sustainable barrier 2700 illustrated in FIG. 28. In the illustrated embodiment, the sustainable barrier 2700 includes two lifting holes 2702 and two mounting holes 2704. In alternative embodiments, the sustainable barrier 2700 may include any number of lifting holes 2702 and mounting holes 2704 that enable the sustainable barrier 2700 to operate as described herein. The lifting holes 2702 are oriented horizontally and facilitate lifting the sustainable barrier 2700. The mounting holes 2704 are oriented vertically and facilitate mounting additional equipment to the sustainable barrier 2700 and/or anchoring the sustainable barrier 2700 to the ground. The top trough 2706 and the bottom trough 2708 facilitate drainage, accessory mounting, and/or utility routing. The top trough 2706 and the bottom trough 2708 may extend along a length or a width of the sustainable barrier 2700.

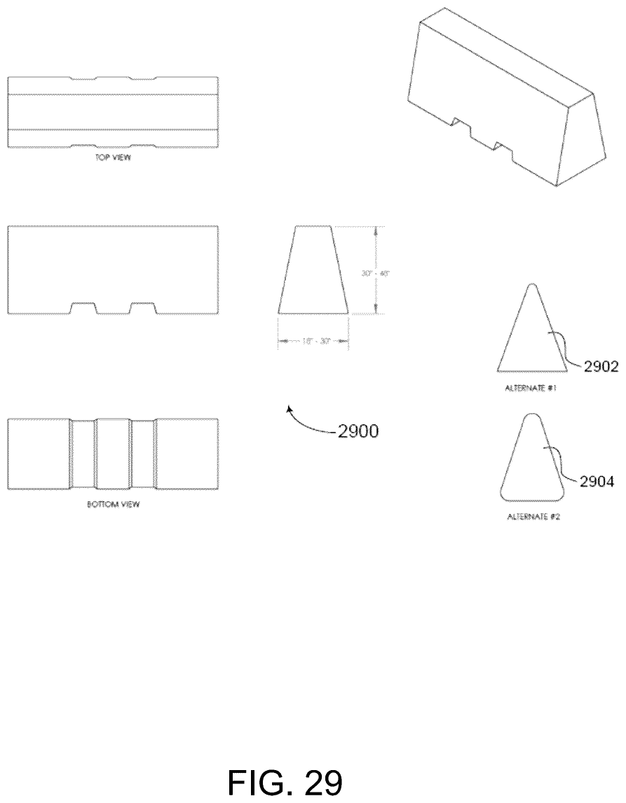

In alternative embodiments, the sustainable barrier 100 may have a different shape than the shape illustrated in FIGS. 1-28. For example, the sustainable barrier 100 may have a traditional Jersey barrier shape, a constant slope barrier shape, a concrete step barrier shape, and/or a F-shape barrier shape. Moreover, the sustainable barrier 100 may have any shape that enables the sustainable barrier 100. For example, FIGS. 29-37 illustrate additional embodiments of the sustainable barrier 100 with different shapes.

FIG. 29 illustrates a perspective view, a side view, a top view, a front view, and a bottom view of a sustainable barrier 2900. In the illustrated embodiment, the sustainable barrier 2900 has a trapezoidal shape. FIG. 29 also illustrates a side view of a sustainable barrier 2902 and a side view of a sustainable barrier 2904. The sustainable barrier 2902 has a triangular shape and the sustainable barrier 2904 has a triangular shape with rounded vertices.

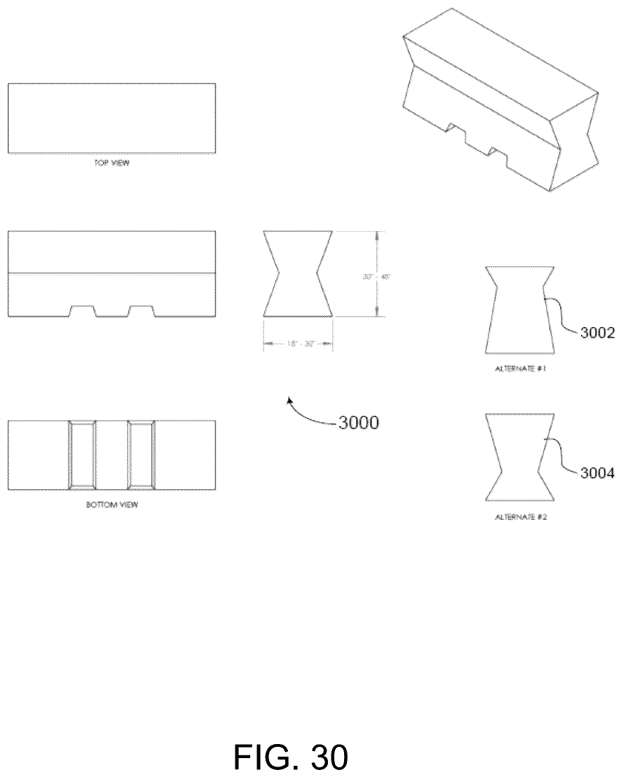

FIG. 30 illustrates a perspective view, a side view, a top view, a front view, and a bottom view of a sustainable barrier 3000. In the illustrated embodiment, the sustainable barrier 3000 has an hourglass or torus shape. FIG. 30 also illustrates a side view of a sustainable barrier 3002 and a side view of a sustainable barrier 3004. The sustainable barrier 3002 and the sustainable barrier 3004 each have an hourglass or torus shape with sides of different lengths.

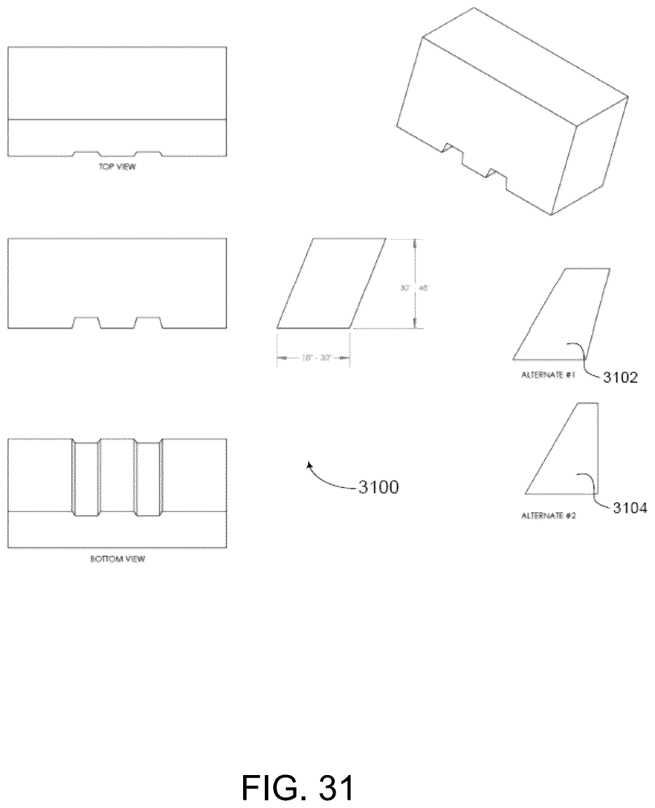

FIG. 31 illustrates a perspective view, a side view, a top view, a front view, and a bottom view of a sustainable barrier 3100. In the illustrated embodiment, the sustainable barrier 3100 has a rhomboid shape. FIG. 31 also illustrates a side view of a sustainable barrier 3102 and a side view of a sustainable barrier 3104. The sustainable barrier 3102 and the sustainable barrier 3104 each have a rhomboid shape with vertices having different angles.

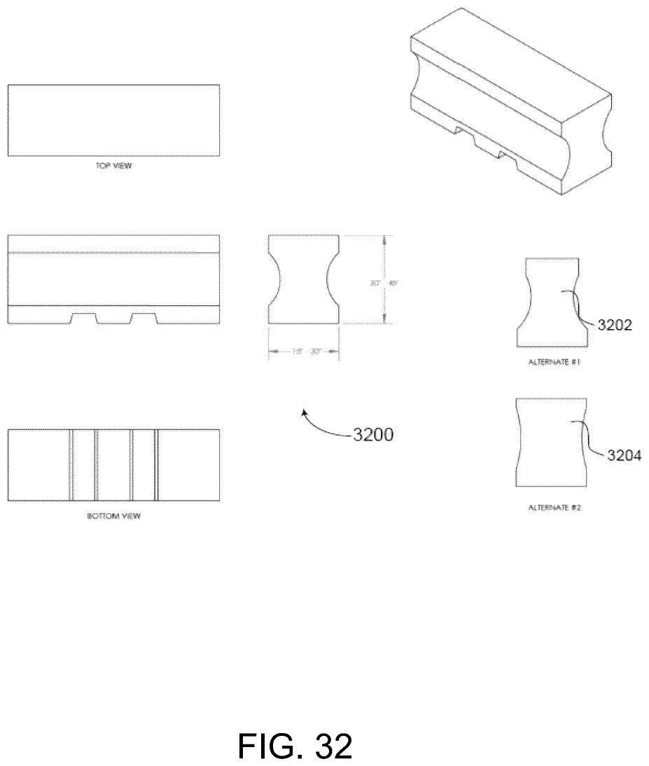

FIG. 32 illustrates a perspective view, a side view, a top view, a front view, and a bottom view of a sustainable barrier 3200. In the illustrated embodiment, the sustainable barrier 3200 has an hourglass or torus shape with curved sides. FIG. 32 also illustrates a side view of a sustainable barrier 3202 and a side view of a sustainable barrier 3204. The sustainable barrier 3202 and the sustainable barrier 3204 each have an hourglass or torus shape with curved sides having different radii.

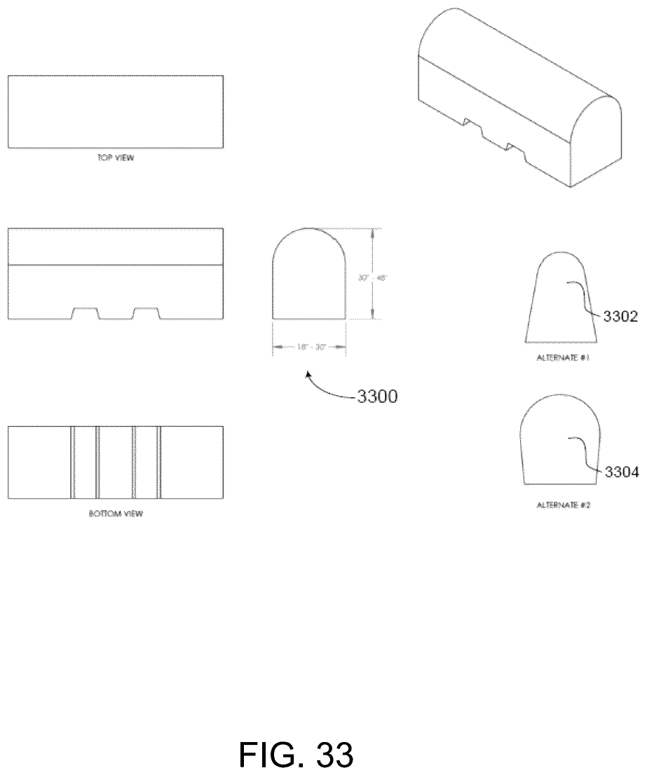

FIG. 33 illustrates a perspective view, a side view, a top view, a front view, and a bottom view of a sustainable barrier 3300. In the illustrated embodiment, the sustainable barrier 3300 has a rectangular shape having a curved top. FIG. 33 also illustrates a side view of a sustainable barrier 3302 and a side view of a sustainable barrier 3304. The sustainable barrier 3302 and the sustainable barrier 3304 each have a rectangular shape having a curved top with sides having different angles.

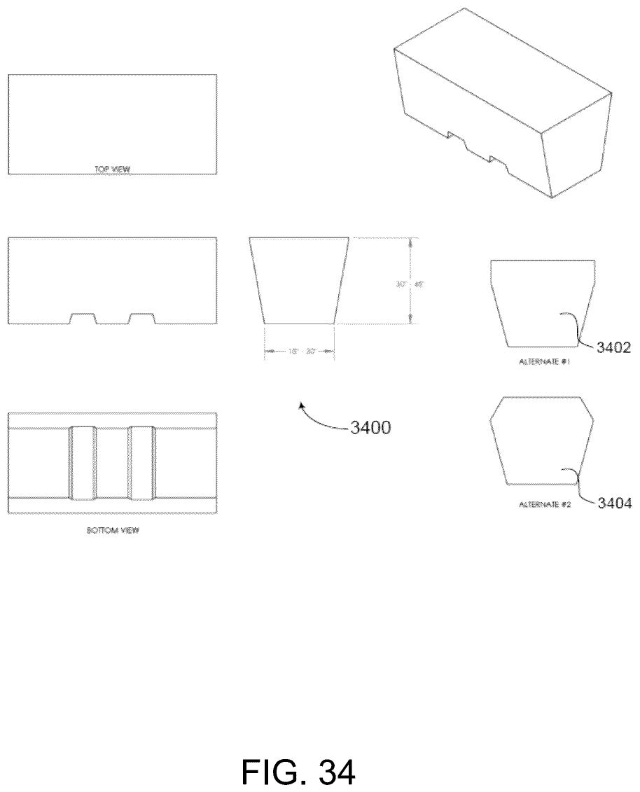

FIG. 34 illustrates a perspective view, a side view, a top view, a front view, and a bottom view of a sustainable barrier 3400. In the illustrated embodiment, the sustainable barrier 3400 has an isosceles trapezoidal shape. FIG. 34 also illustrates a side view of a sustainable barrier 3402 and a side view of a sustainable barrier 3404. The sustainable barrier 3402 and the sustainable barrier 3404 each have an irregular hexagon shape.

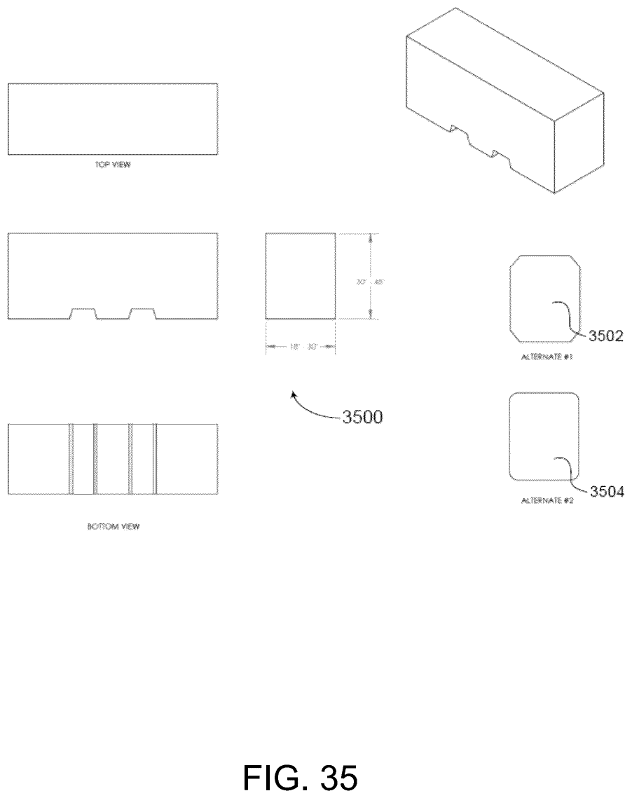

FIG. 35 illustrates a perspective view, a side view, a top view, a front view, and a bottom view of a sustainable barrier 3500. In the illustrated embodiment, the sustainable barrier 3500 has a rectangular shape. FIG. 35 also illustrates a side view of a sustainable barrier 3502 and a side view of a sustainable barrier 3504. The sustainable barrier 3502 and the sustainable barrier 3504 each have a rectangular shape with chamfered or rounded corners.

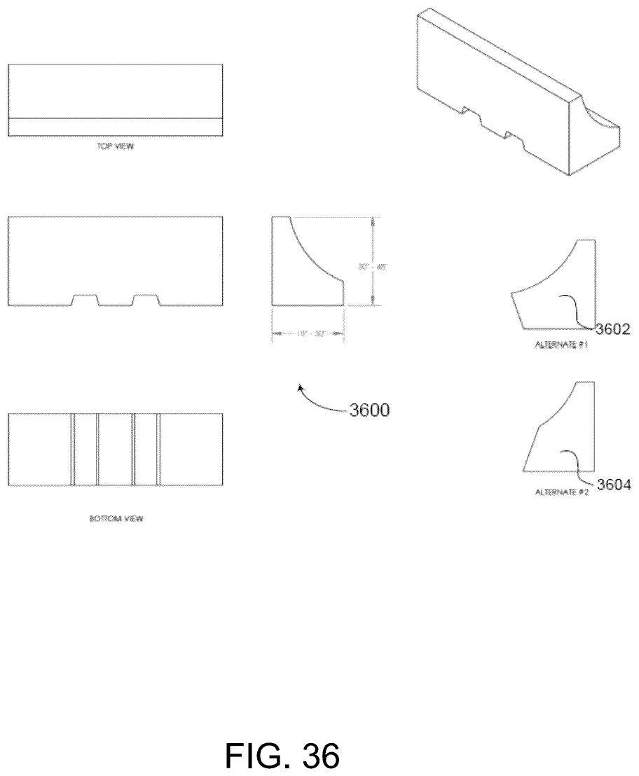

FIG. 36 illustrates a perspective view, a side view, a top view, a front view, and a bottom view of a sustainable barrier 3600. In the illustrated embodiment, the sustainable barrier 3600 has a rectangular shape with a circular cut out at one corner. FIG. 36 also illustrates a side view of a sustainable barrier 3602 and a side view of a sustainable barrier 3604. The sustainable barrier 3602 and the sustainable barrier 3604 each have a rectangular shape with a circular cut out at one corner with sides of different angles.

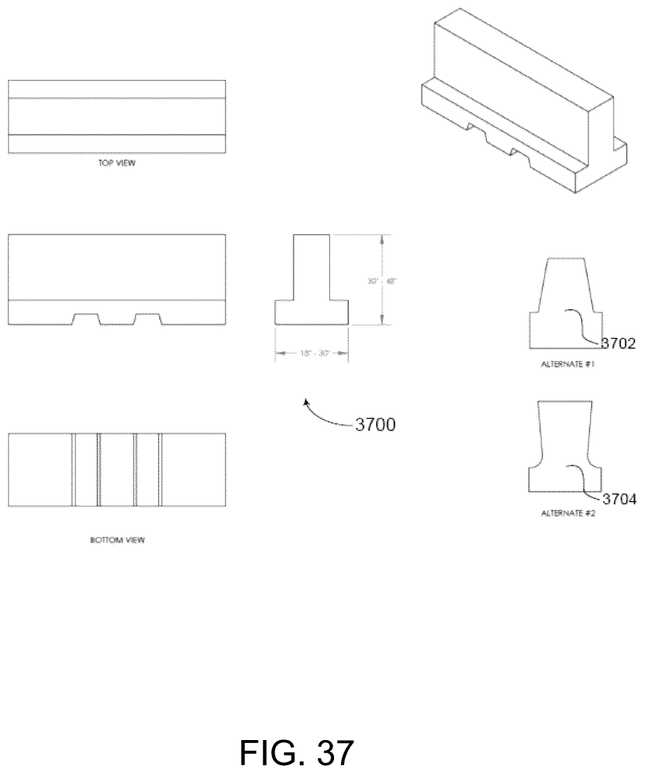

FIG. 37 illustrates a perspective view, a side view, a top view, a front view, and a bottom view of a sustainable barrier 3700. In the illustrated embodiment, the sustainable barrier 3700 has a T-shape. FIG. 37 also illustrates a side view of a sustainable barrier 3702 and a side view of a sustainable barrier 3704. The sustainable barrier 3702 and the sustainable barrier 3704 each have a T-shape with sides of different angles.

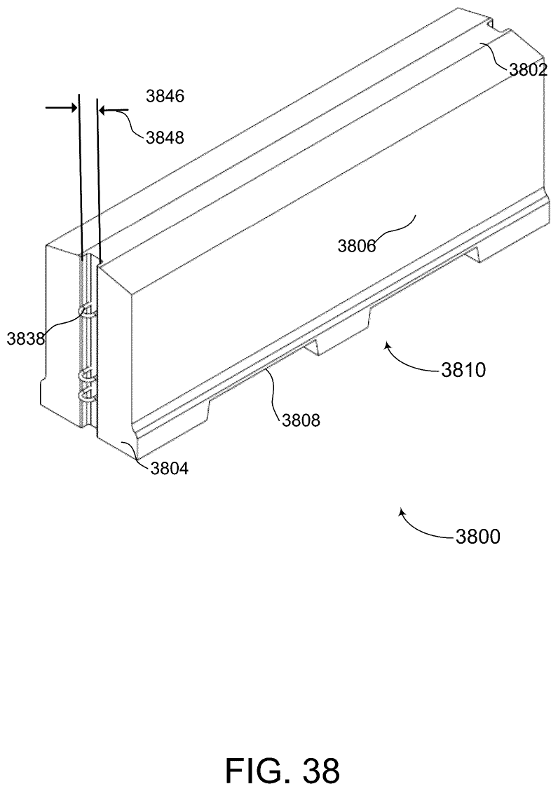

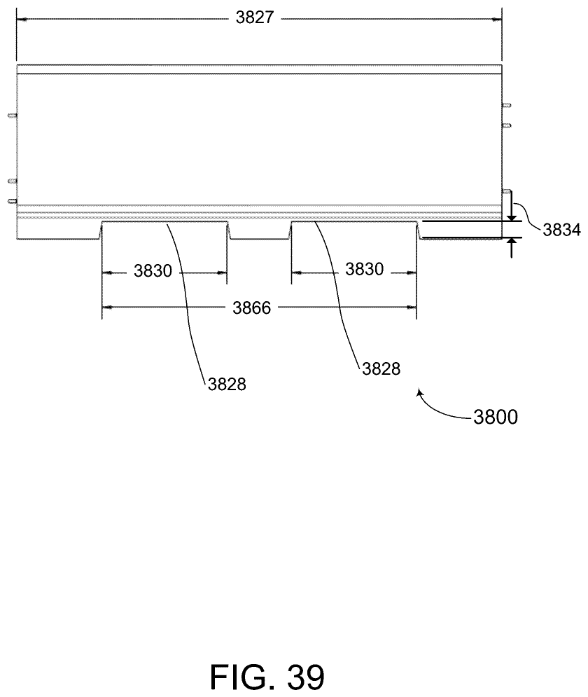

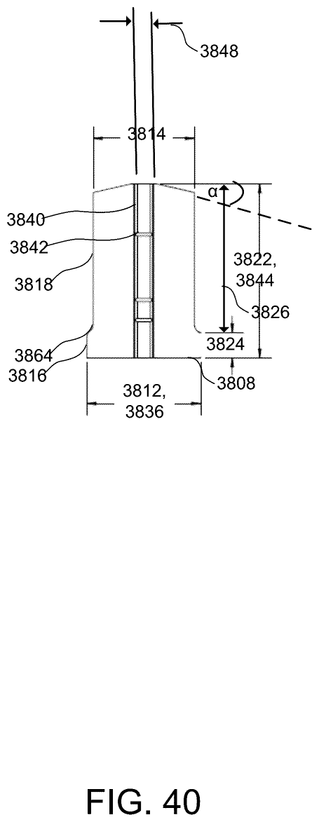

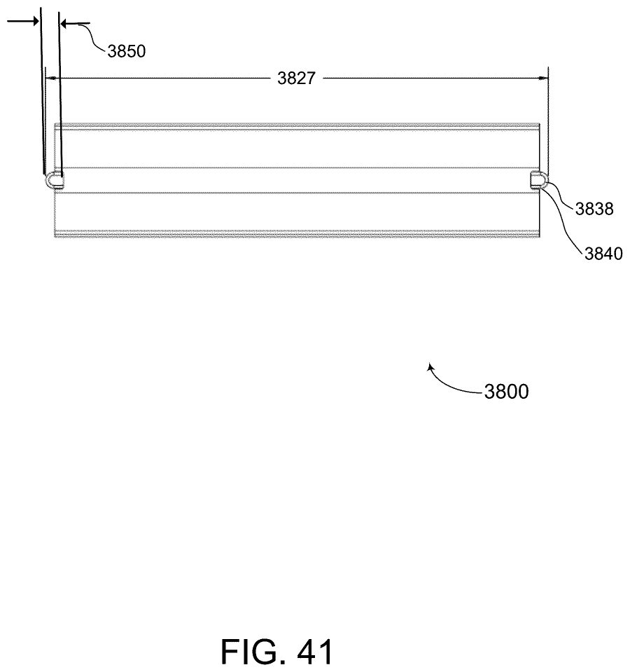

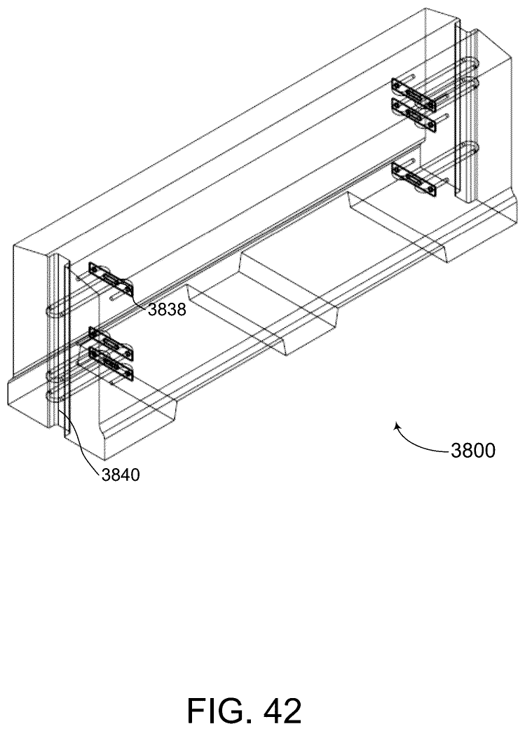

FIG. 38 illustrates a perspective view of an example sustainable barrier 3800. FIG. 39 illustrates a front view of the sustainable barrier 3800 illustrated in FIG. 38. FIG. 40 illustrates a side view of the sustainable barrier 3800 illustrated in FIG. 38. FIG. 41 illustrates a top view of the sustainable barrier 3800 illustrated in FIG. 38. FIG. 42 illustrates a partially transparent perspective view of the sustainable barrier 3800 illustrated in FIG. 38.

The sustainable barriers 3800 described herein are capable of being certified under the Manual for Assessing Safety Hardware (“MASH”) guidelines. MASH is a criteria created by AASHTO (American Association of State Highway and Transportation Officials) that presents uniform guidelines for crash testing permanent and temporary highway safety features and recommends evaluation criteria to assess test results. Specifically, in the illustrated embodiment, the sustainable barriers 3800 are capable of being certified under MASH Test Level-2 (“TL-2”) Criteria. More specifically, the sustainable barriers 3800 have been tested and have been certified under MASH TL-2 Criteria.

MASH includes 6 test levels which increase in test speed and vehicle size as the test level increases. Test Levels are determined by the in-field application of the traffic safety device being tested (city roads, rural roads, highways, etc). To achieve a rating, the physical crash test of a traffic safety device must have met certain criteria regarding where the car ended up, how it got there and what kind of damage occurred. The basic differences per test level are noted below:
TL-1: cars and pick-up trucks at 31 miles per hour (mph)
TL-2: cars and pick-up trucks at 44 mph
TL-3: cars and pick-up trucks at 62 mph
TL-4: cars, pick-up trucks, and single unit trucks at 62 mph and 56 mph respectively
TL-5: cars, pick-up trucks, and tractor trailers at 62 mph and 50 mph respectively
TL-6: cars, pick-up trucks, and tractor tank trailers at 62 mph and 50 mph respectively

Specifically, MASH TL-2 certification test includes:
1. Connecting the sustainable barriers 3800 in a straight line using a quantity to satisfy the Length-of-Need.
2. Impacting the connected sustainable barriers 3800 with a passenger car of approximately 1,100 kilograms (“kg”) at an angle of approximately 25 degrees from parallel to the connected sustainable barriers 3800 at a speed of approximately 44 mph.
3. Impacting the connected sustainable barriers 3800 with a pick-up truck of approximately 2,270 kg at an angle of approximately 25 degrees from parallel to the connected sustainable barriers 3800 at a speed of approximately 44 mph.

The connected sustainable barriers must satisfy the following conditions to pass MASH TL-2 certification test:
1. The connected sustainable barriers 3800 must contain and redirect the vehicle or bring the vehicle to a controlled stop. The vehicle should not penetrate, underride, or overrider the installation.
2. The vehicle should remain upright during and after the collision, with a maximum roll and pitch angle not to exceed 75 degrees.
3. Occupant impact velocities, both longitudinal and lateral, may not exceed 12.2 meters per second (“m/s”).
4. Occupant ridedown acceleration, both longitudinal and lateral, may not exceed 20.49 G.

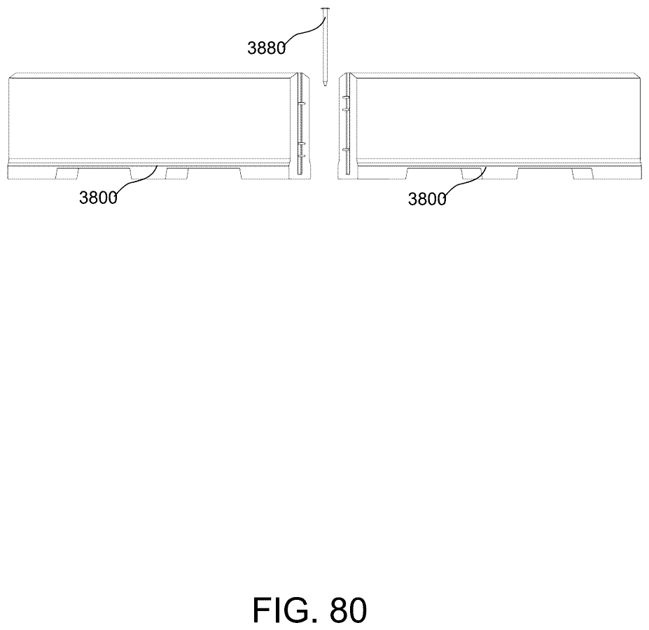

As described below, the sustainable barrier 3800 described herein include a connector system 3838 configured to connect the sustainable barriers 3800 together during the MASH TL-2 certification test and during use. FIG. 80 illustrates an exploded view of the sustainable barriers 3800 attached to each other by a connector 3880. The connector 3880 includes a rod inserted into the loops 3842 described below that attach the sustainable barriers 3800 together. During the MASH TL-2 certification test, at least two sustainable barriers 3800 were connected together using the connector 3880 illustrated in FIG. 80 to satisfy the Length-of-Need requirement of the MASH TL-2 certification test.

The sustainable barriers 3800 were tested under the MASH TL-2 certification parameters listed above and were certified under MASH TL-2. Specifically, the physical characteristics of the sustainable barriers 3800 enabled the sustainable barriers 3800 to be certified under MASH TL-2. More specifically, as described below, the sustainable barriers 3800 described herein include substantially vertical broad sides 3806 that at least partially enabled the sustainable barriers 3800 to be certified under MASH TL-2. In alternative embodiments, the broad sides 3806 may not need to be substantially vertical for the sustainable barriers 3800 to be certified under MASH TL-2. For example, the angle of the broad sides 3806 may be between 80° and 100° relative to grade and the sustainable barriers 3800 may still be capable of being certified under MASH TL-2.

Additionally, the sustainable barrier height 3822 of the sustainable barrier 3800 also enabled the sustainable barriers 3800 to be certified under MASH TL-2. In the illustrated embodiments, the sustainable barrier height 3822 is 30, 32, 34.5, 36, or 40 inches high. The sustainable barriers 3800 having a height of at least 30 inches enables the sustainable barriers 3800 to be certified under MASH TL-2.

During the certification test the sustainable barriers 3800 were free standing and were not physically attached to the ground in any way. Even without physical attachments to the ground, the sustainable barriers 3800 were certified under MASH TL-2. In alternative embodiments, the sustainable barriers 3800 may be attached to the ground by pinning, gluing, and/or any other attachments. Attaching the sustainable barriers 3800 to the ground during the test would also enable the sustainable barriers 3800 to be certified under MASH TL-2.

Finally, the wide base of the sustainable barriers 3800 enables the sustainable barriers 3800 to be certified under MASH TL-2. That is, the bottom width 3812 of the sustainable barrier 3800 also enabled the sustainable barriers 3800 to be certified under MASH TL-2. In the illustrated embodiments, the bottom width 3812 is approximately 18 inches to approximately 26 inches wide or approximately 22.5 inches wide. The sustainable barriers 3800 having a bottom width 3812 of at least 20 inches enables the sustainable barriers 3800 to be certified under MASH TL-2.

In alternative embodiments, the sustainable barriers 3800 are also capable of being certified under the MASH TL-3 certification test without any modifications. The requirements of the MASH TL-3 certification test are the same as the MASH TL-2 certification test except that the passenger car and the pick-up truck impact the sustainable barriers 3800 at a speed of approximately 62 mph. In some embodiments, the sustainable barriers 3800 are also capable of being certified under the MASH TL-3 certification test without any modifications. In other embodiments, the sustainable barriers 3800 are also capable of being certified under the MASH TL-3 certification test with minor modifications. For example, the sustainable barriers 3800 may be modified by increasing the sustainable barrier height 3822 of the sustainable barrier 3800, pinning the sustainable barriers 3800 to the ground, strengthening the connector system 3838 of the sustainable barriers 3800 by increasing the number of loops 3842 or increasing the amount of rebar in the connector system 3838, and/or increasing the tensile modulus, compressive modulus, and/or the flexural modulus of the sustainable barriers 3800 to ensure the sustainable barriers 3800 are capable of being certified under the MASH TL-3 certification test.

The sustainable barriers 3800 have performance advantages over traditional concrete barriers, and purpose built metal stands, in a load rated applications. More specifically, traditional concrete barriers are not designed to support large loads upon them because they offer no benefits over purpose built stands or supports and may be too brittle. Metal load rated stands are typically rated for up to 20,000 pounds and can damage the equipment placed upon them due to the hard metal surface. In contrast, the sustainable barrier 3800 described herein has a maximum load rating of at least 25,000 pounds with a safety factor of 3 for total load for a barrier 3800 that is at least 6 ft in length. In some embodiments, the maximum load rating may be at least 32,000 pounds with a safety factor of 3 for total load for a barrier 3800 that is at least 8 ft in length. Additionally, the sustainable barrier 3800 described herein has a maximum surface pressure rating of at least 150 pound per square inch with a safety factor of 4 for pressure. Furthermore, the sustainable barrier 3800 described herein have undergone further testing and have withstood a surface pressure of over 600 pound per square inch and a total load of over 80,000 pounds without any signs of damage. Furthermore, the sustainable barriers 3800 are also capable of supporting a substantial load for an extended period of time (more than a month) without sustaining any damage.

As such, the sustainable barriers 3800 may be used to support equipment, like industrial saw horses do, because the sustainable barriers 3800 have a high load rating. Specifically, the sustainable barriers 3800 have a maximum load rating of at least 25,000 pounds (greater than 10 tons) and, because the sustainable barriers 3800 are made of softer waste materials, the sustainable barriers 3800 do not damage the other equipment, they contour to the load, and have high friction against the load.

Additionally, the sustainable barriers 3800 also have a maximum elongation at failure of at least approximately 50 percent. Specifically, the sustainable barriers 3800 have a maximum elongation at failure of at least approximately 50 percent to at least approximately 200 percent. In the illustrated embodiment, the sustainable barriers 3800 have a maximum elongation at failure of at least approximately 50 percent to at least approximately 74 percent or approximately 62 percent. Having a higher maximum elongation of the sustainable barrier 3800 allows for larger deformations without failure. Increasing the maximum elongation increases the ability to absorb energy over a longer duration, which could allow for higher speed impacts without risk of failure of the sustainable barrier 3800. If an equivalent amount of energy is absorbed over a longer duration, then the peak deacceleration of the object impacting the sustainable barrier 3800 would be reduced, which is generally safer. Having a low maximum elongation to failure value, as is typical in materials like concrete, results in a more brittle, sudden failure with very little deformation. Successful use of a sustainable barrier 3800 with a minimal maximum elongation at failure value allows for simplification in the manufacturing process since higher elongation values are more challenging to achieve. A broader set of materials can be used with lower elongation targets.

Additionally, the sustainable barriers 3800 also have a maximum tensile strength of, at least, approximately 450 kPa to approximately 1 GPa. Specifically, the sustainable barriers 3800 have a maximum tensile strength of, at least, approximately 450 kPa to approximately 590 kPa or approximately 520 kPa. The maximum tensile strength provides a number of benefits related to the ability to resist damage to the sustainable barrier 3800. Upon impact, a higher maximum tensile strength would lead to less rupture, cracking, and tearing. With less damage incurred, the sustainable barrier 3800 has a greater chance of being reused after an impact. Greater maximum tensile strength allows for higher speed impacts before failing. Successful use of a sustainable barrier 3800 with a minimal maximum tensile strength allows for simplification in the manufacturing process since higher maximum tensile strength values are more challenging to achieve. A broader set of materials can be used with lower maximum tensile strength targets.

In addition, the sustainable barriers 3800 also have a tensile modulus of at least approximately 1,000 kPa to approximately 1 GPa. Specifically, the sustainable barriers 3800 have a tensile modulus of at least approximately 1,000 kPa to approximately 1,300 kPa or approximately 1,150 kPa. The tensile modulus enables the sustainable barriers 3800 to resist lengthening when stuck by an object, most noticeably when attached to subsequent sustainable barriers 3800, forming a chain of sustainable barriers 3800. A higher tensile modulus in the sustainable barrier 3800 would provide more resistance to deforming when pulled on, which would engage adjacent connect barriers more rapidly, allowing a system of barriers 3800 to deform less upon impact. This would be beneficial in preventing people or objects behind the barriers 3800 from being struck. Higher tensile modulus would also more fully resist internal rebar components, such as loop ends, from being removed from the barrier 3800. Using a sustainable barrier 3800 with the lowest tensile modulus possible provides a softer impact for the object, which in the case of a vehicle, means a safer impact for occupants.

Moreover, the sustainable barriers 3800 also have a compressive modulus of at least approximately 5,900 kPa to approximately 1 GPa. Specifically, the sustainable barriers 3800 have a compressive modulus of at least approximately 5,900 kPa to approximately 6,600 kPa or approximately 6,250 kPa. The compressive modulus is related to how far an object will deform into the sustainable barrier 3800 with a given load. A higher modulus would imply less deformation into the sustainable barrier 3800 with a given impact, and more redirection of the object. Using a sustainable barrier 3800 with the lowest compressive modulus possible provides a softer impact for the object, which in the case of a vehicle, means a safer impact for occupants.

Moreover, the sustainable barriers 3800 also have a flexural modulus of at least approximately 2,000 kPa to approximately 1 GPa. Specifically, the sustainable barriers 3800 also have a flexural modulus of at least approximately 2,000 kPa to approximately 2,400 kPa or approximately 2,200 kPa. The flexural modulus enables the sustainable barriers 3800 to resist bending when stuck by an object, most noticeably when struck in the mid-span of a long section. A higher flexural modulus in the sustainable barrier 3800 would provide more resistance to deforming when struck, providing a greater ability to redirect the object. Using a sustainable barrier 3800 with the lowest flexural modulus possible provides a softer impact for the object, which in the case of a vehicle, means a safer impact for occupants.

As shown in FIGS. 38-42, the sustainable barrier 3800 includes a top 3802, two narrow sides 3804, two broad sides 3806, and a bottom 3808. In the illustrated embodiment, the two narrow sides 3804 have substantially the same shape such that the two narrow sides 3804 are substantially the same. Similarly, the two broad sides 3806 have substantially the same shape such that t two broad sides 3806 are substantially the same. In alternative embodiments, the two narrow sides 3804 and the two broad sides 3806 may each have a unique shape such that each of the two narrow sides 3804 and the two broad sides 3806 are different from each other.

In the illustrated embodiment, the sustainable barrier 3800 has a wide base 3810 and a narrow top 3802. The two broad sides 3806 are substantially vertical to shape both the wide base 3810 and the narrow top 3802. The narrow top 3802 has a substantially flat portion 3860 and two sloped side portions 3862 to facilitate stacking a plurality of sustainable barriers 3800 on top of each other. The two narrow sides 3804 are substantially flat to facilitate aligning a plurality of sustainable barriers 3800 in a row to form a long, continuous barrier. For example, a plurality of sustainable barriers 3800 may be arranged by aligning one of the narrow sides 3804 of a first sustainable barrier 3800 with one of the narrow sides 3804 of a second sustainable barrier 3800 and the other of the narrow sides 3804 of the first sustainable barrier 3800 with one of the narrow sides 3804 of a third sustainable barrier 3800 to form a row in the median of a road, on the shoulder of the road, or to block off an existing lane. Additionally, the row of sustainable barriers 3800 may be used to protect construction workers on or near a roadway during maintenance or construction. This long, continuous barrier in the middle of the road reduces the risk of head on collisions and improves the overall safety of traveling on the road.

As shown in FIG. 40, the bottom 3808 is substantially flat and defines a bottom width 3812. The top 3802 also defines a top width 3814 including the substantially flat portion 3860 and the two sloped side portions 3862. The two sloped side portions 3862 extend at an angle α relative to grade or a horizontal line 120 parallel. In the illustrated embodiment, the bottom width 3812 is approximately 18 inches to approximately 26 inches wide or approximately 22.5 inches wide and the top width 3814 is approximately 18 inches to approximately 26 inches wide or approximately 20 inches wide. In alternative embodiments, the bottom width 3812 and the top width 3814 may be any width that enables the sustainable barrier 3800 to operate as described herein. In the illustrated embodiment, the angle α is approximately 0° to approximately 45°. More specifically, in the illustrated embodiment, the angle α is 13°.

In the illustrated embodiment, the two broad sides 3806 each include a vertical base 3816 and a vertical top 3818 separated by a curved shoulder 3864. The vertical base 3816 extends substantially vertically from the bottom 3808, the curved shoulder 3864 extends vertically and curves inward from the vertical base 3816, and the vertical top 3818 extends vertically from the curved shoulder 3864 to the top 3802. The two broad sides 3806 each define a sustainable barrier height 3822, the two vertical bases 3816 each define a vertical base height 3824, and the two vertical tops 3818 each define a vertical top height 3826. In the illustrated embodiment, the sustainable barrier height 3822 is approximately 30 inches to approximately 42 inches high, the vertical base height 3824 is approximately 0 inches to approximately 12 inches high, and the vertical top height 3826 is approximately 0 inches to approximately 42 inches high. More specifically, in the illustrated embodiment, the sustainable barrier height 3822 is 30, 32, 34.5, 36, or 40 inches high, the vertical base height 3824 is 5 inches high, and the vertical top 3818 is 29.5 inches high. In alternative embodiments, the sustainable barrier height 3822, the vertical base height 3824, and the vertical top 3818 may be any height or angle that enables the sustainable barrier 3800 to operate as described herein.

As shown in FIG. 39, the top 3802 and the two broad sides 3806 each define a sustainable barrier length 3827. In the illustrated embodiment, the sustainable barrier length 3827 is approximately 48 inches to approximately 240 inches long and may be any 2-foot increment length between 4 feet and 20 feet. More specifically, in the illustrated embodiment, the sustainable barrier length 3827 is approximately 96 inches. In alternative embodiments, the sustainable barrier length 3827 may be any length that enables the sustainable barrier 3800 to operate as described herein. Additionally, the wide base 3810, the bottom 3808, and the vertical bases 3816 each define at least one drainage slot 3828. In the illustrated embodiment, the sustainable barrier 3800 includes two drainage slots 3828. In alternative embodiments, the sustainable barrier 3800 may include any number of drainage slots 3828 including, but not limited to, one, three, four, or more drainage slots 3828.

The drainage slots 3828 facilitate water drainage from one side of the sustainable barrier 3800 to the other. In alternative embodiments the drainage slot 3828 may extend along a length of the sustainable barrier rather than across the width of the sustainable barrier. Additionally, the drainage slots 3828 may also be used to facilitate movement of the sustainable barrier 3800. More specifically, in the illustrated embodiment, the drainage slots 3828 are positioned to enable a forklift (not shown) or some other equipment to pick up and move the sustainable barrier 3800. More specifically, in the illustrated embodiment, the drainage slots 3828 each define a drainage slot width 3830, a drainage slot height 3834, a drainage slot length 3836, and a drainage slot total width 3866. In the illustrated embodiment, the drainage slot length 3836 is equal to the bottom width 3812 such that the drainage slots 3828 each extend through the wide base 3810 of the sustainable barrier 3800. Additionally, the drainage slot widths 3830 and 3832 and the drainage slot height 3834 are each sized and shaped to enable water to drain from one side of the sustainable barrier 3800 to the other and to enable the prongs of a forklift to be inserted into the drainage slots 3828 for picking up the sustainable barrier 3800. In the illustrated embodiment, the drainage slot bottom width 3830 is approximately 12 inches to approximately 36 inches wide, the drainage slot top width 3832 is approximately 12 inches to approximately 36 inches wide, the drainage slot height 3834 is approximately 3 inches to approximately 8 inches high, the drainage slot length 3836 is approximately 18 inches to approximately 26 inches wide or approximately 22.5 inches wide long, and the drainage slot total width 3866 is approximately 12 inches to approximately 36 inches wide. More specifically, for a sustainable barrier with a length 3827 of approximately 8 feet, the drainage slot bottom width 3830 is 26 inches wide, the drainage slot top width 3832 is 25 inches wide, the drainage slot height 3834 is 3.5 inches high, the drainage slot length 3836 is 22.5 inches long, and the drainage slot total width 3866 is 62 inches long. In alternative embodiments, the drainage slot bottom width 3830, the drainage slot top width 3832, the drainage slot height 3834, the drainage slot length 3836, and the drainage slot total width 3866 may be any length that enables the sustainable barrier 3800 to operate as described herein.

As discussed above, the sustainable barriers 3800 described herein are formed of a waste material and a binder that binds the waste material into a specific shape for a specific use. The waste material and the binder may be combined in different ratios with different compositions such that the material that forms the sustainable barrier 3800 may have portions with different densities. Additionally, the shape of the sustainable barriers 3800 may be tailored to a specific shape to suit a specific function. Accordingly, the sustainable barriers 3800 described herein are formed of a sustainable material with a tailored composition and shape to suit a specific function.

Specifically, in the illustrated embodiments, the waste material used to form the sustainable barriers 3800 described herein is used tires. In alternative embodiments, the waste material may be any material including, but not limited to, recycled plastics, recycled wood, shingles, composite materials (fiberglass and/or carbon fiber), and/or any other sustainable or recyclable material. The used tires are ground to form a crumb rubber and the binder is formulated to bind the crumb rubber into a formed sustainable barrier 3800. In the illustrated embodiments, the waste material is approximately 90% to approximately 99% by weight of the sustainable barrier 3800, approximately 91% to approximately 99% by weight of the sustainable barrier 3800, approximately 92% to approximately 99% by weight of the sustainable barrier 3800, approximately 93% to approximately 99% by weight of the sustainable barrier 3800, approximately 94% to approximately 99% by weight of the sustainable barrier 3800, approximately 95% to approximately 99% by weight of the sustainable barrier 3800, or approximately 95% to approximately 98% by weight of the sustainable barrier 3800. In alternative embodiments, the composition of the waste material in the sustainable barriers 3800 described herein may be any amount that enables the sustainable barriers 3800 to operate as described herein.

The properties of the waste material and/or the processing conditions may be varied to tune or specify the final properties of the sustainable barrier. Specifically, a specific type of waste material may be selected to achieve a desired physical property within the sustainable barrier. For example, a denser waste material may be selected such that the sustainable barrier is denser and/or harder. The denser/harder sustainable barrier may be useful for specific uses or harsh environments. For example, the denser/harder sustainable barriers may be tailored such that the density is greater than the density of water and may be useful for flood control. Additionally, the denser/harder sustainable barriers may be useful for barriers in high traffic/high speed highways where collisions may cause damage to softer/less dense barriers.

Conversely, a less dense waste material may be selected such that the sustainable barrier is less dense and/or softer. The less dense/softer sustainable barrier may be useful for specific uses or specific environments. For example, the less dense/softer sustainable barriers may be useful for situations where a barrier is needed but the barrier needs to give to protect the object impacting the barrier. For example, barriers at bumper car facilities or go-cart racetracks need to stop the bumper car or go-cart without hurting the occupant or damaging the bumper car or go-cart. Certain waste materials are denser than others and may be suitable for specific situations. For example, tires suitable for large commercial vehicles (such as constructions vehicles and tractor trailers) are typically denser/harder than tires for residential vehicles and bicycles. The density of the sustainable barrier may be tuned by selecting the material the sustainable barrier is made from based on the materials density. Additionally, the density of the sustainable barrier may also be varied based on the compression pressure used to from the barrier. A higher compression pressure increases the density of the sustainable barrier and a lower compression pressure decreases the density of the sustainable barrier.

The binder includes a polyurethane binder, an optional colorant, a catalyst, and a small amount of water. The binder has been formulated to bind the crumb rubber into the sustainable barriers 3800 described herein without using heat. More specifically, the catalyst within the binder quickly forms the sustainable barriers 3800 such that heat is not required to cure the sustainable barriers 3800. In the illustrated embodiments, the binder is approximately 10% to approximately 1% by weight of the sustainable barrier 3800, approximately 9% to approximately 1% by weight of the sustainable barrier 3800, approximately 8% to approximately 1% by weight of the sustainable barrier 3800, approximately 7% to approximately 1% by weight of the sustainable barrier 3800, approximately 6% to approximately 1% by weight of the sustainable barrier 3800, approximately 5% to approximately 1% by weight of the sustainable barrier 3800, or approximately 5% to approximately 2% by weight of the sustainable barrier 3800. In alternative embodiments, the composition of the binder in the sustainable barriers 3800 described herein may be any amount that enables the sustainable barriers 3800 to operate as described herein.

The polyurethane binder includes a polyurethane adhesive. In the illustrated embodiment, the polyurethane binder includes an aromatic polyurethane binder. More specifically, the polyurethane binder may include Stobicoll® R 1142, Stobicoll® R 359, Stobicoll® R 1129, Stobicoll® R 382, Stobicoll® R 401, Stobicoll® R 1160, Polyval® GN416, Polyval® GN418, and/or Poly Tree® Fusion. In the illustrated embodiments, the polyurethane binder is approximately 10% to approximately 1% by weight of the waste material, approximately 10% to approximately 1.5% by weight of the waste material, approximately 9% to approximately 1% by weight of the waste material, approximately 8% to approximately 1% by weight of the waste material, approximately 7% to approximately 1% by weight of the waste material, approximately 6% to approximately 1% by weight of the waste material, approximately 5% to approximately 1% by weight of the waste material, or approximately 2.5% to approximately 2% by weight of the waste material. In alternative embodiments, the composition of the polyurethane binder in the sustainable barriers 3800 described herein may be any amount that enables the sustainable barriers 3800 to operate as described herein.

The colorant includes any material configured to dye the waste material and the binder a color. In the illustrated embodiments, the colorant is approximately 10% to approximately 1% by weight of the waste material, approximately 10% to approximately 1.5% by weight of the waste material, approximately 9% to approximately 1% by weight of the waste material, approximately 8% to approximately 1% by weight of the waste material, approximately 7% to approximately 1% by weight of the waste material, approximately 6% to approximately 1% by weight of the waste material, approximately 5% to approximately 1% by weight of the waste material, or approximately 5% to approximately 2.5% by weight of the waste material. In alternative embodiments, the composition of the colorant in the sustainable barriers 3800 described herein may be any amount that enables the sustainable barriers 3800 to operate as described herein.

The catalyst or accelerant includes a polyether polyol-based catalyst configured increase polyurethane reactivity. In the illustrated embodiment, the catalyst or accelerant includes Stobiblend® Z 952.50, Stobiblend® Z 1959, and/or Polyval® 910624. In the illustrated embodiments, the catalyst is approximately 1% to approximately 0.001% by weight of the waste material, approximately 0.5% to approximately 0.001% by weight of the waste material, approximately 0.1% to approximately 0.001% by weight of the waste material, approximately 0.05% to approximately 0.001% by weight of the waste material, approximately 0.01% to approximately 0.001% by weight of the waste material, approximately 0.005% to approximately 0.001% by weight of the waste material, approximately 0.003% to approximately 0.001% by weight of the waste material, or approximately 0.002% by weight of the waste material. In alternative embodiments, the composition of the catalyst in the sustainable barriers 3800 described herein may be any amount that enables the sustainable barriers 3800 to operate as described herein. In some embodiments, the catalyst may not be included in the sustainable barrier 3800. Rather, environmental conditions such as temperature and humidity levels will determine if catalyst is used, and how much catalyst is used.

In the illustrated embodiments, water is approximately 1% to approximately 0.01% by weight of the waste material, approximately 0.5% to approximately 0.01% by weight of the waste material, approximately 0.1% to approximately 0.01% by weight of the waste material, approximately 0.05% to approximately 0.01% by weight of the waste material, approximately 0.04% to approximately 0.01% by weight of the waste material, approximately 0.03% to approximately 0.01% by weight of the waste material, approximately 0.02% to approximately 0.01% by weight of the waste material, or approximately 0.02% by weight of the waste material. n alternative embodiments, the composition of water in the sustainable barriers 3800 described herein may be any amount that enables the sustainable barriers 3800 to operate as described herein. In some embodiments, water may not be included in the sustainable barrier 3800. Rather, environmental conditions such as temperature and humidity levels will determine if water is used, and how much catalyst is used.

The waste material and the binder are combined into a batter. The batter is put into a mold and the mold cures the batter into the sustainable barriers 3800 described herein at high pressure. The sustainable barrier 3800 is then removed from the mold. In the illustrated embodiment, the catalyst enables the sustainable barrier 3800 to be cured without the use of heat to cure the binder, substantially reducing costs and the complexity of the manufacturing process.

The sustainable barrier 3800 may be cured from a single batter. However, in some embodiments, the sustainable barrier 3800 may be formed of more than one batter. For example, the sustainable barrier 3800 may be formed of more than one batter as shown in FIGS. 6 and 7 described herein. Specifically, the sustainable barrier 3800 may include the first layer 602 and the second layer 604. The first layer 602 forms an outer skin 606 of the sustainable barrier 3800 and is formed from a batter that includes a relatively low dense waste material and/or was formed with a lower compression pressure. The second layer 604 forms a core 608 of the sustainable barrier 3800 and is formed from a batter that includes a relatively high dense waste material and/or was formed with a higher compression pressure. As such, the first layer 602 has a lower density than the second layer 604 and has a lower hardness than the second layer 604. As such, the sustainable barrier 3800 has a softer outer skin 606 that absorbs impacts and a harder core 608 that provides structural stability to the sustainable barrier 3800. Alternatively, the sustainable barrier 3800 may include a first layer 702 and a second layer 704. The first layer 702 forms an outer skin 706 of the sustainable barrier 3800 and is formed from a batter that includes a relatively high dense waste material and/or was formed with a higher compression pressure. The second layer 704 forms a core 708 of the sustainable barrier 3800 and is formed from a batter that includes a relatively low dense waste material and/or was formed with a lower compression pressure. As such, the first layer 702 has a higher density than the second layer 704 and has a higher hardness than the second layer 704. As such, the sustainable barrier 3800 has a harder outer skin 706 for increased durability and a softer core 708 that provides flexibility to the sustainable barrier 3800.

As described above, the sustainable barrier 3800 may be designed for different uses. For example, a motorcycle racetrack may require a barrier with a softer outer skin and a harder core. Riders may crash into the barriers and the softer outer skin may improve the safety of the motorcycle racetrack. However, a racetrack for traditional vehicles may require a barrier with a harder outer skin and a softer core to improve the durability of the barriers while also allowing the barriers to be flexible and absorb impacts. As such, the composition of the waste material and the binder may be tuned to produce layers or entire barriers with different properties that have different uses.

As shown in FIGS. 38-42, the sustainable barrier 3800 includes a connector system 3838. Specifically, the two narrow sides 3804 include a groove 3840 and the connector system 3838 extends from the groove 3840. The connector system 3838 includes at least one loop 3842 extending from the groove 3840. In the illustrated embodiment, the connector system 3838 includes a plurality of loops 3842 extending from the groove 3840. Specifically, in the illustrated embodiments, the connector system 3838 includes three loops 3842 extending from the groove 3840 on each of the two narrow sides 3804. In alternative embodiments, the connector system 3838 may include any number loops 3842 extending from the groove 3840 on each of the two narrow sides 3804. In the illustrated embodiment, the loops 3842 include rebar loops, solid steel loops, stainless steel loops, fiberglass loops, and/or composite loops. In alternative embodiments, the loops 3842 may be formed of any material that enables the connector system 3838 to operate as described herein.

The groove 3840 defines a groove height 3844, a groove depth 3846, and a groove width 3848. Additionally, the loops 3842 each define a loop length 3850. The groove depth 3846 and the loop length 3850 are configured to enable the loops 3842 of a first barrier 3800 to be inserted into the groove 3840 of a second barrier 3800 such that the narrow side 3804 of the first barrier 3800 is flush with the narrow side 3804 of the second barrier 3800 to form a longer, extend barrier. The loops 3842 are each positioned at different heights such that each loop 3842 cannot interfere with another loop 3842 when the loops 3842 are inserted into the grooves 3840. Additionally, a connector (not shown) is inserted into the loops 3842 of both the first barrier 3800 and the second barrier 3800 to hold the two barriers together. As such, the connector system 3838 enables the sustainable barriers 3800 to be connected to each other to strengthen the connected barriers.

In the illustrated embodiment, the groove height 3844 is about 30 inches to about 42 inches, the groove depth 3846 is about 1 inch to about 2 inches, the groove width 3848 is about 3 inches to about 5 inches, and the loop length 3850 is about 2 inches to about 4 inches. Specifically, in the illustrated embodiment, the groove height 3844 is about 34.5 inches, the groove depth 3846 is about 1.375 inches, the groove width 3848 is about 3.5 inches, and the loop length 3850 is about 3.25 inches. In alternative embodiments, the groove height 3844, the groove depth 3846, the groove width 3848, and the loop length 3850 may be any length that enables the sustainable barriers 3800 described herein to operate as described herein.

To strengthen the connections between the barriers 3800, the loops 3842 may be set into the batter before the batter is cured into the sustainable barriers 3800. As such, the connections between the barriers 3800 are strengthened because the sustainable barriers 3800 are cured around the loops 3842 and the binder adheres the loops 3842 to the rest of the sustainable barriers 3800. However, to further strengthen the connections between the barriers 3800, shape of the loops 3842 within the sustainable barriers 3800 may be varied to improve the strength of the loops 3842 and the bond between the loops 3842 and the sustainable barriers 3800.

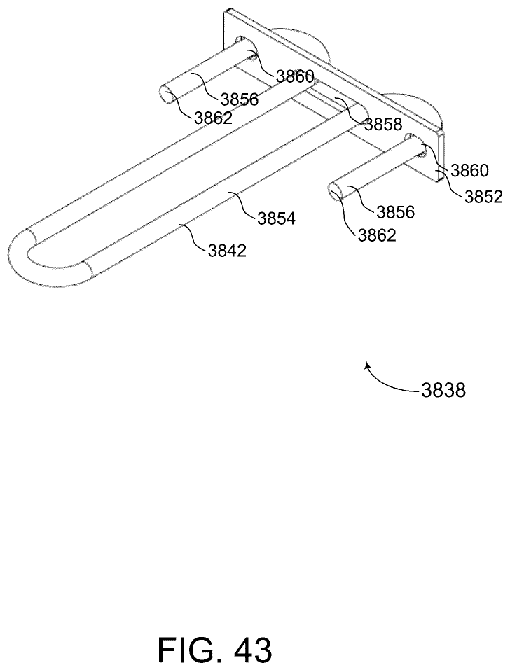

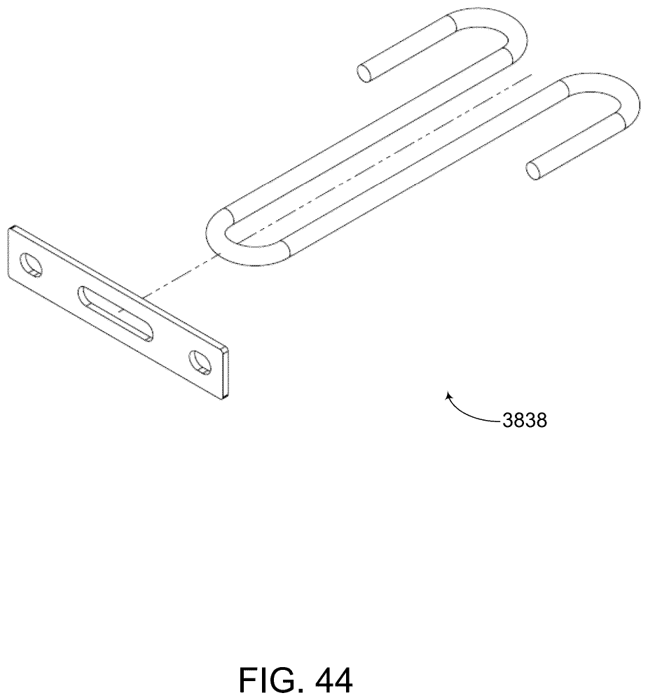

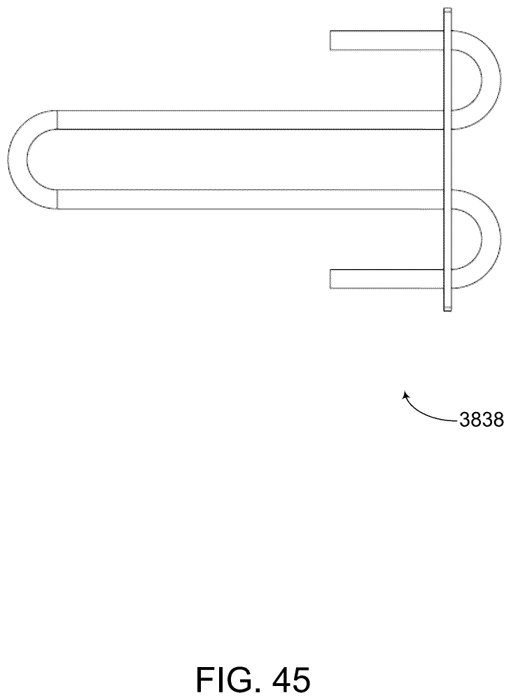

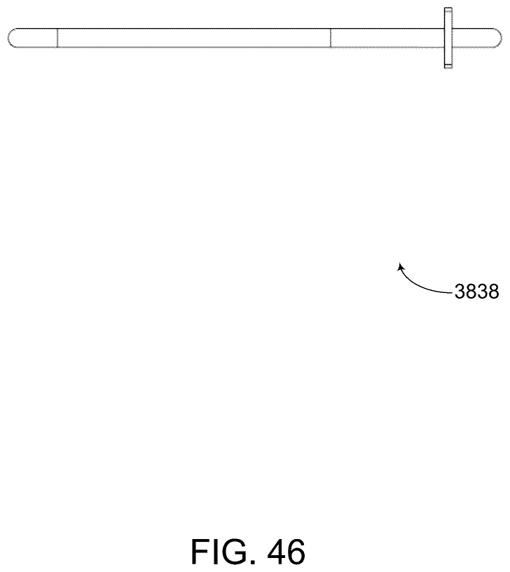

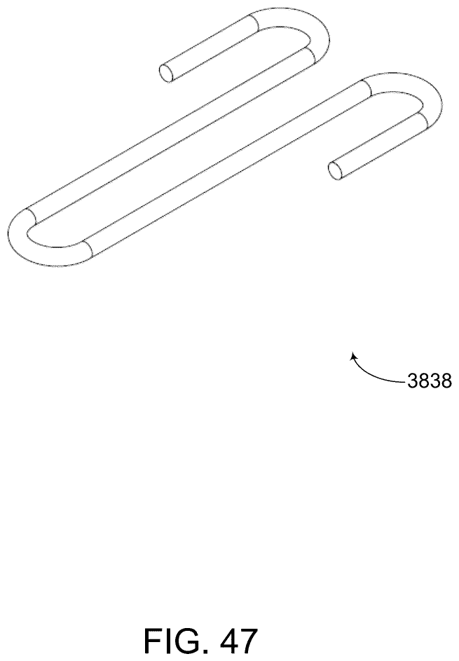

For example, FIGS. 43-47 illustrate the connector system 3838. FIG. 43 illustrates a perspective view of the connector system 3838. FIG. 44 illustrates another perspective view of the connector system 3838 illustrated in FIG. 43. FIG. 45 illustrates a top view of the connector system 3838 illustrated in FIG. 43. FIG. 46 illustrates a side view of the connector system 3838 illustrated in FIG. 43. FIG. 47 illustrates a partially perspective view of the connector system 3838 illustrated in FIG. 43. As shown in FIGS. 43-47, the connector system 3838 includes the loop 3842 and a plate 3852. In the illustrated embodiment, the loop 3842 is shaped such that the loop 3842 includes a primary loop 3854 and two secondary loops 3856. The plate 3852 includes a metallic (such as steel), fiberglass, and/or composite plate that defines a primary hole 3858 and two secondary holes 3860. The loop 3842 is shaped such that the primary loop 3854 extends through the primary hole 3858 and an end 3862 of each of the two secondary loops 3856 extends through the two secondary holes 3860. As described above, the connector system 3838 is cured into the barrier 3800 in the assembled configuration illustrated in FIG. 43. The shape of the loop 3842 wraps around the plate 3852 and the plate 3852 provides additional strength and resistance to maintain the connector system 3838 in the barrier 3800 during an impact or other event. Accordingly, the connector system 3838 describe herein increase the strength of the connection between barriers 3800 by incorporating the plate 3852 and the shaped loop 3842 such that the shaped loop 3842 wraps around the plate 3852 and the plate 3852 provides additional resistance and strength to the loop 3842 to reduce the likelihood of the loop 3842 being pulled out of the barriers 3800.

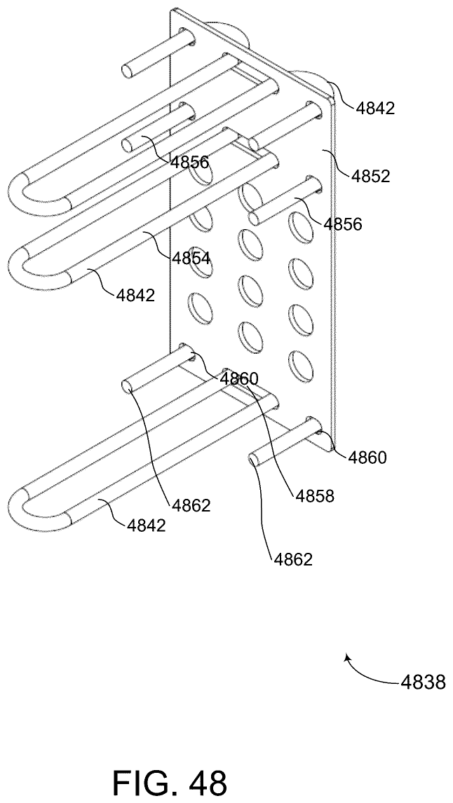

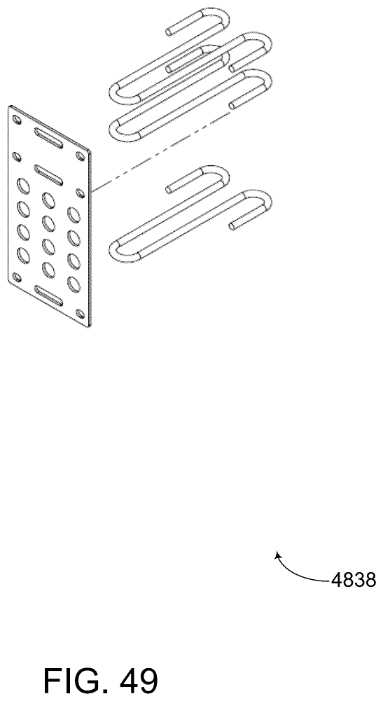

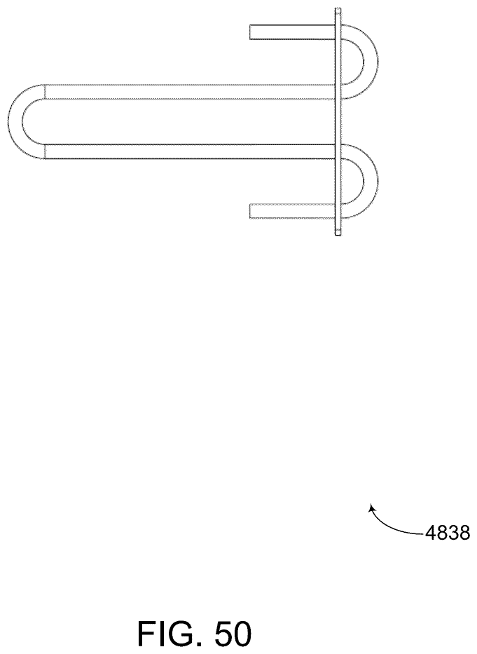

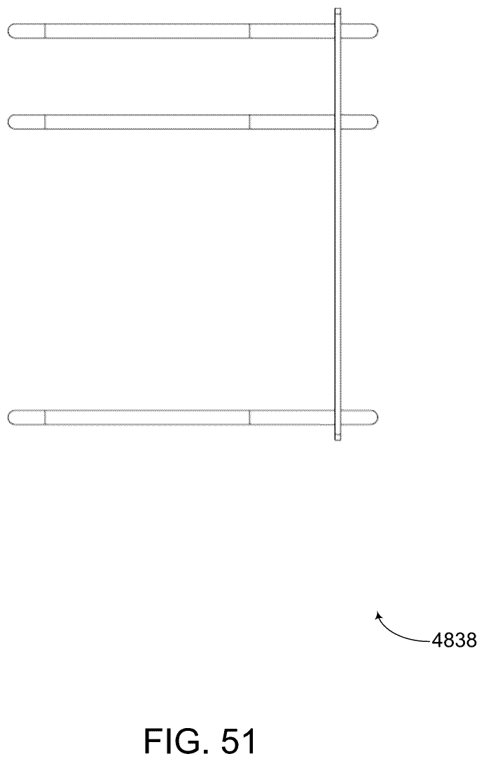

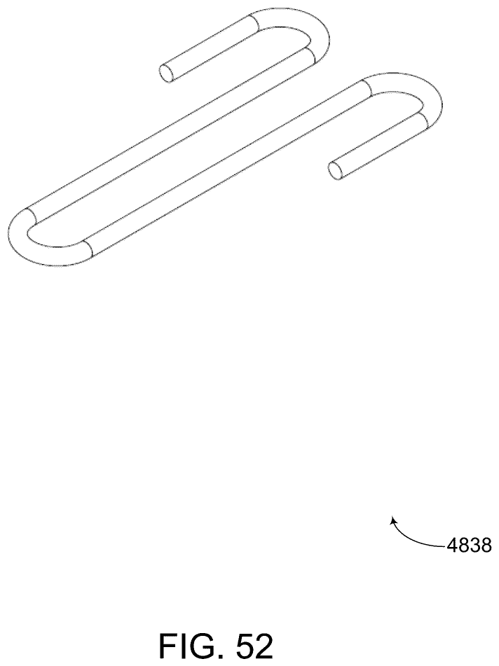

Additionally, FIGS. 48-52 illustrate an alternative connector system 4838. FIG. 48 illustrates a perspective view of the connector system 4838. FIG. 49 illustrates another perspective view of the connector system 4838 illustrated in FIG. 48. FIG. 50 illustrates a top view of the connector system 4838 illustrated in FIG. 48. FIG. 51 illustrates a side view of the connector system 4838 illustrated in FIG. 48. FIG. 52 illustrates a partially perspective view of the connector system 4838 illustrated in FIG. 48. As shown in FIGS. 48-52, the connector system 4838 includes a plurality of loops 4842 that are substantially similar to the loop 3842 described above and a plate 4852. In the illustrated embodiment, each loop 4842 is shaped such that the loop 4842 includes a primary loop 4854 and two secondary loops 4856. The plate 4852 is similar to the plate 3852 because the plate 4852 includes a metallic (such as steel), fiberglass, and/or composite plate that defines a plurality of primary holes 4858 and a plurality of secondary holes 4860 arranged on either side of the primary holes 4858. The loop 4842 is shaped such that the primary loop 4854 extends through the primary hole 4858 and an end 4862 of each of the secondary loops 4856 extends through the secondary holes 4860. Additionally, the plate 4852 is substantially longer than the plate 3852 such that the plate 4852 can accommodate or receive a plurality of loops 4842. As such, the plate 4852 provides additional strength and resistance to pull out as compared to the plate 3852. As described above, the connector system 4838 is cured into the barrier 3800 in the assembled configuration illustrated in FIG. 43. The shape of the loop 4842 wraps around the plate 4852 and the plate 4852 provides additional strength and resistance to maintain the connector system 4838 in the barrier 3800 during an impact or other event. Accordingly, the connector system 4838 describe herein increase the strength of the connection between barriers 3800 by incorporating the plate 4852 and the shaped loops 4842 such that the shaped loops 4842 wrap around the plate 4852 and the plate 4852 provides additional resistance and strength to the loops 4842 to reduce the likelihood of the loops 4842 being pulled out of the barriers 3800.

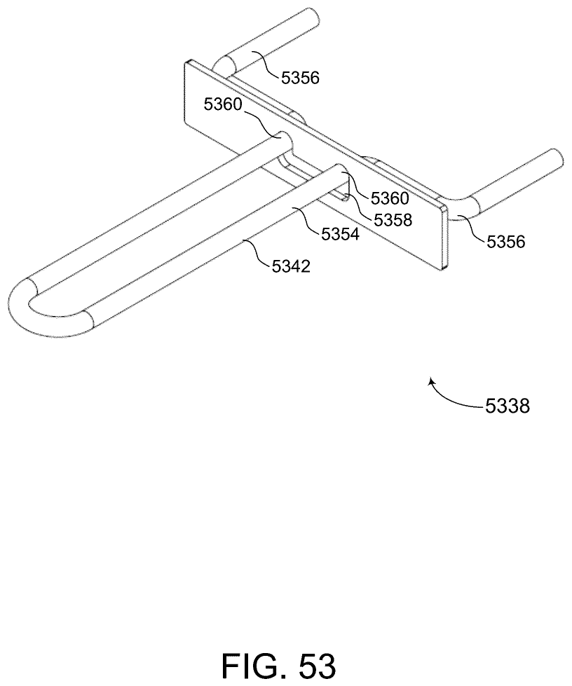

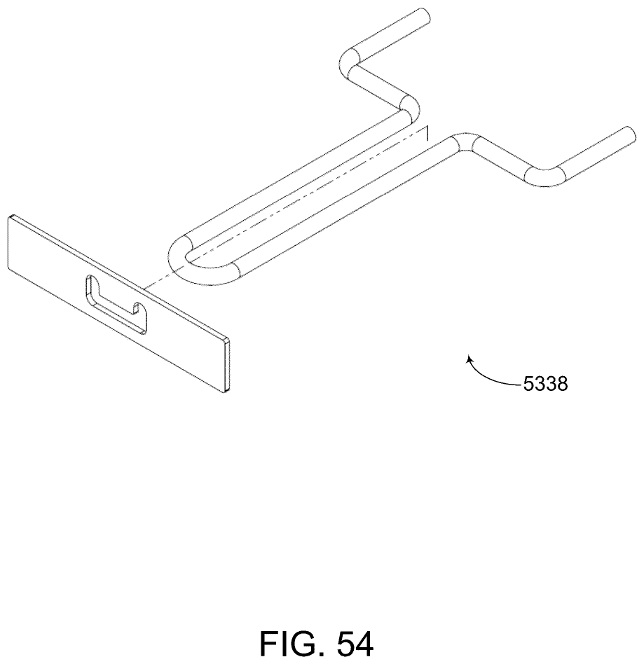

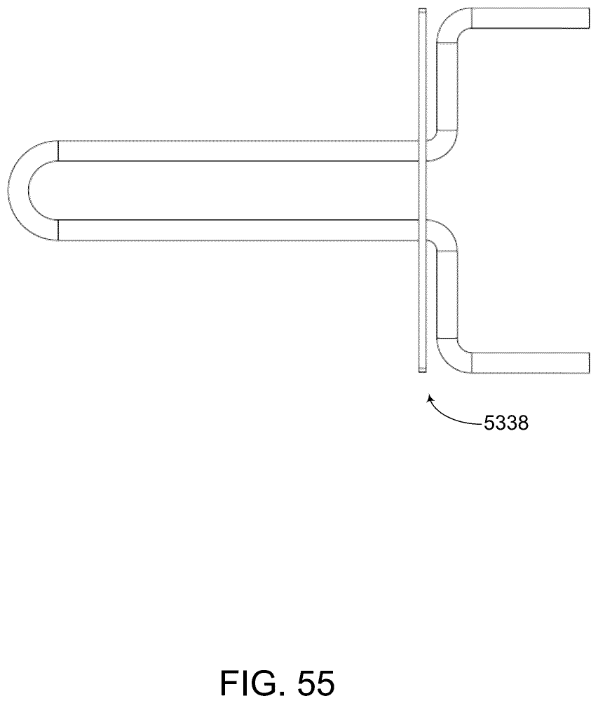

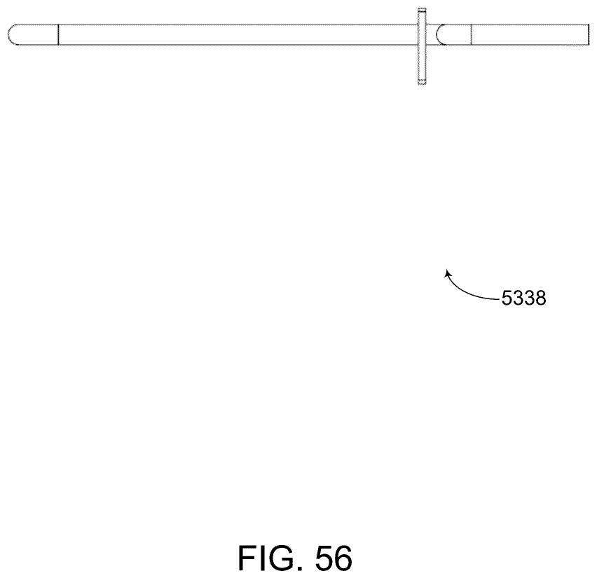

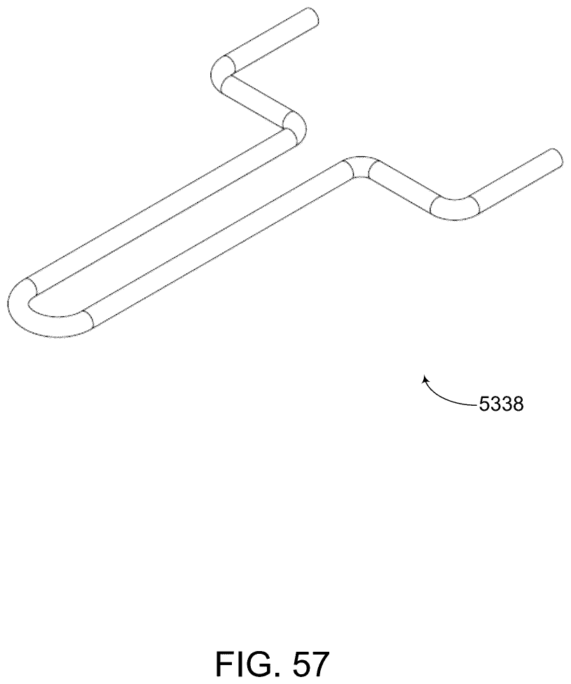

Additionally, FIGS. 53-57 illustrate the connector system 5338. FIG. 53 illustrates a perspective view of the connector system 5338. FIG. 54 illustrates another perspective view of the connector system 5338 illustrated in FIG. 53. FIG. 55 illustrates a top view of the connector system 5338 illustrated in FIG. 53. FIG. 56 illustrates a side view of the connector system 5338 illustrated in FIG. 53. FIG. 57 illustrates a partially perspective view of the connector system 5338 illustrated in FIG. 53. As shown in FIGS. 53-57, the connector system 5338 includes a loop 5342 and a plate 5352. In the illustrated embodiment, the loop 5342 is shaped such that the loop 5342 includes a primary loop 5354 and two flat portions 5356. The plate 5352 includes a metallic (such as steel), fiberglass, and/or composite plate that defines a primary hole 5358 and two slots 5360 positioned on top of the primary hole 5358. The loop 5842 is shaped such that the primary loop 5854 extends through the primary hole 5358 and portions of the primary loop 5854 slide into the tow slots 5360. The flat portions 5356 are pressed against the plate 5352. As described above, the connector system 5338 is cured into the barrier 3800 in the assembled configuration illustrated in FIG. 43. The shape of the loop 5342 presses against the plate 5352 and the plate 5352 provides additional strength and resistance to maintain the connector system 5338 in the barrier 3800 during an impact or other event. Accordingly, the connector system 5338 describe herein increase the strength of the connection between barriers 3800 by incorporating the plate 5352 and the shaped loop 5342 such that the shaped loop 5342 presses against the plate 5352 and the plate 5352 provides additional resistance and strength to the loop 5342 to reduce the likelihood of the loop 5342 being pulled out of the barriers 3800.

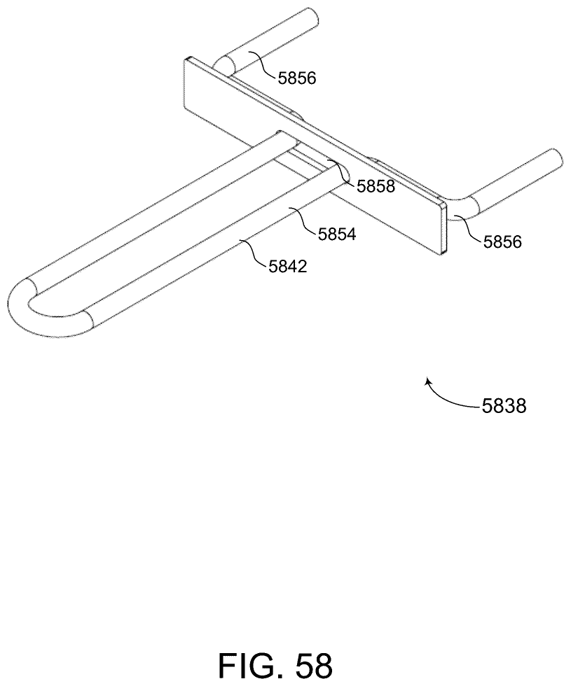

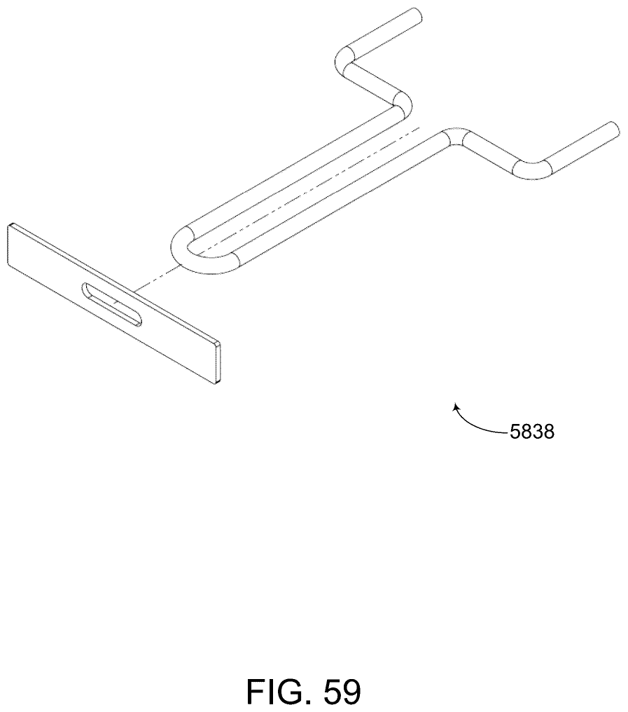

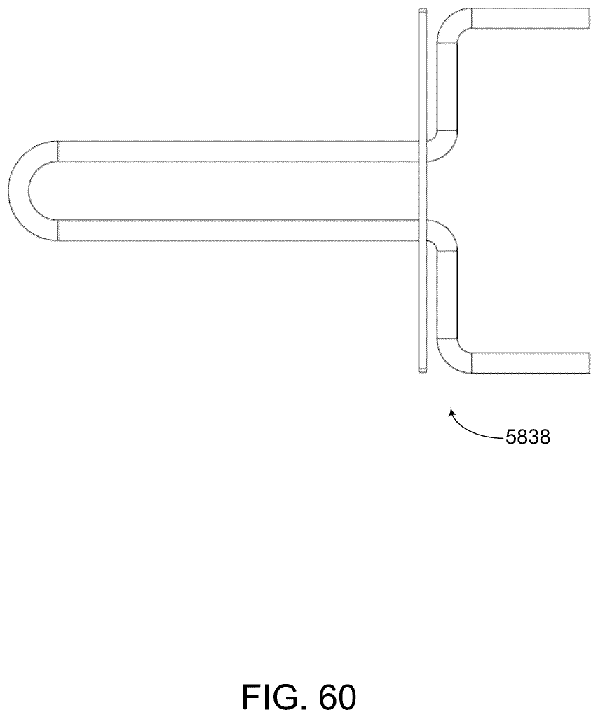

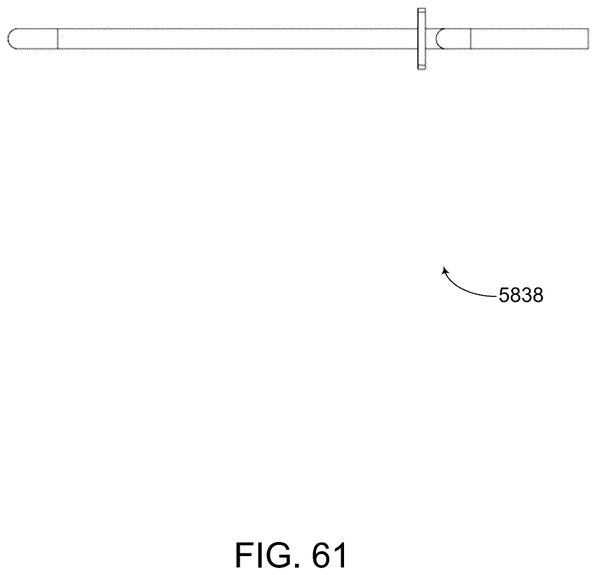

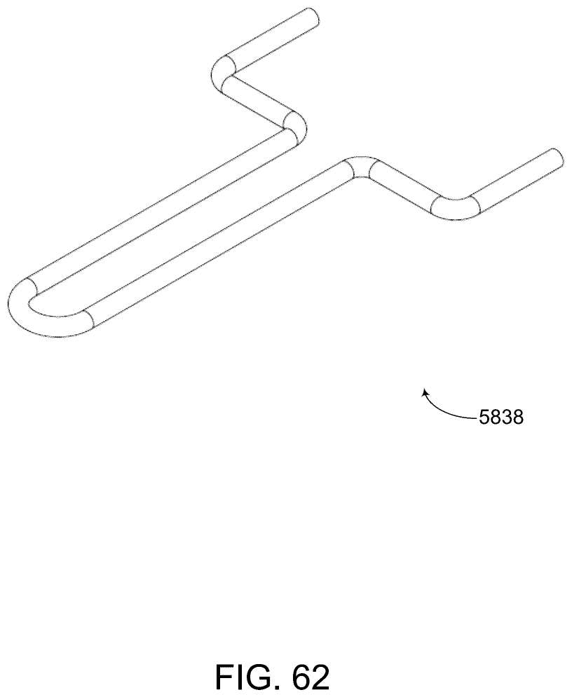

Additionally, FIGS. 58-62 illustrate the connector system 5838. FIG. 58 illustrates a perspective view of the connector system 5838. FIG. 59 illustrates another perspective view of the connector system 5838 illustrated in FIG. 58. FIG. 60 illustrates a top view of the connector system 5838 illustrated in FIG. 58. FIG. 61 illustrates a side view of the connector system 5838 illustrated in FIG. 58. FIG. 62 illustrates a partially perspective view of the connector system 5838 illustrated in FIG. 58. As shown in FIGS. 58-62, the connector system 5838 includes a loop 5842 and a plate 5852. In the illustrated embodiment, the loop 5842 is shaped such that the loop 5842 includes a primary loop 5854 and two flat portions 5856. The plate 5852 includes a metallic (such as steel), fiberglass, and/or composite plate that defines a primary hole 5858. The loop 5842 is shaped such that the primary loop 5854 extends through the primary hole 5858. The flat portions 5856 are pressed against the plate 5852. As described above, the connector system 5838 is cured into the barrier 3800 in the assembled configuration illustrated in FIG. 43. The shape of the loop 5842 presses against the plate 5852 and the plate 5852 provides additional strength and resistance to maintain the connector system 5838 in the barrier 3800 during an impact or other event. Accordingly, the connector system 5838 describe herein increase the strength of the connection between barriers 3800 by incorporating the plate 5852 and the shaped loop 5842 such that the shaped loop 5842 presses against the plate 5852 and the plate 5852 provides additional resistance and strength to the loop 5842 to reduce the likelihood of the loop 5842 being pulled out of the barriers 3800.

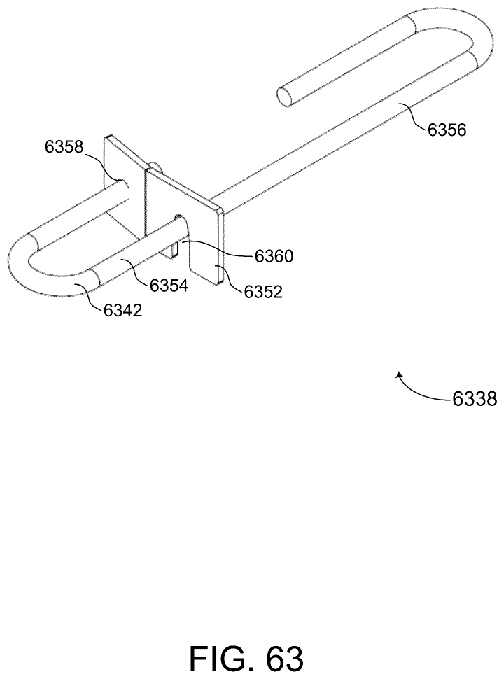

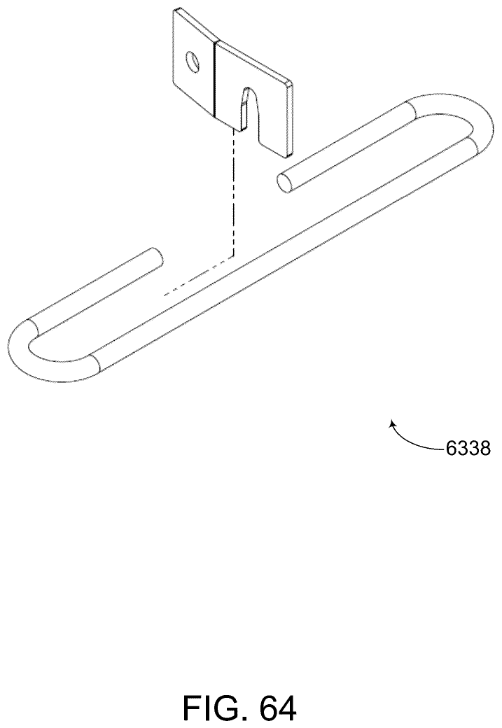

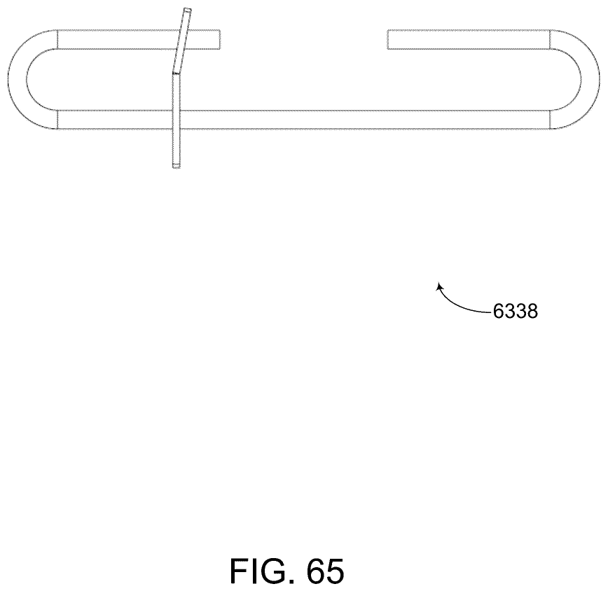

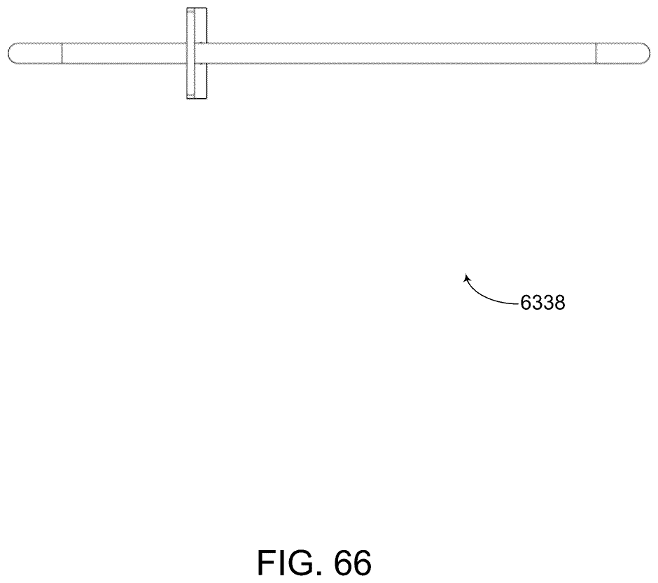

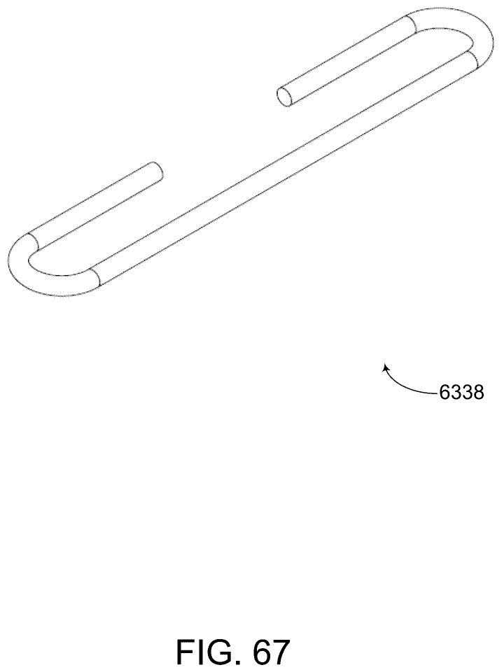

Additionally, FIGS. 63-67 illustrate a connector system 6338. FIG. 63 illustrates a perspective view of the connector system 6338. FIG. 64 illustrates another perspective view of the connector system 6338 illustrated in FIG. 63. FIG. 65 illustrates a top view of the connector system 6338 illustrated in FIG. 63. FIG. 66 illustrates a side view of the connector system 6338 illustrated in FIG. 63. FIG. 67 illustrates a partially perspective view of the connector system 6338 illustrated in FIG. 63. As shown in FIGS. 63-67, the connector system 6338 includes a loop 6342 and a plate 6352. In the illustrated embodiment, the loop 6342 is shaped such that the loop 6342 includes a primary loop 6354 and a secondary loop 6356. The plate 6352 includes a metallic (such as steel), fiberglass, and/or composite plate that defines a primary hole 6358 and a secondary slot 6360. The loop 6342 is shaped such that the primary loop 6354 extends through the primary hole 6358 and the secondary slot 6360. The primary loop 6354 slides into the secondary slot 6360 and slides toward the primary loop 6354 such that the primary loop 6354 extends into the primary hole 6358. The secondary loop 6356 extends into the barrier 3800 and the plate 6352 is angled such that the plate 6352 presses against the primary loop 6354. As described above, the connector system 6338 is cured into the barrier 3800 in the assembled configuration illustrated in FIG. 43. The shape of the loop 6342 presses against the plate 6352 and the plate 6352 provides additional strength and resistance to maintain the connector system 6338 in the barrier 3800 during an impact or other event. Accordingly, the connector system 6338 describe herein increase the strength of the connection between barriers 3800 by incorporating the plate 6352 and the shaped loop 6342 such that the shaped loop 6342 presses against the plate 6352 and the plate 6352 provides additional resistance and strength to the loop 6342 to reduce the likelihood of the loop 6342 being pulled out of the barriers 3800.

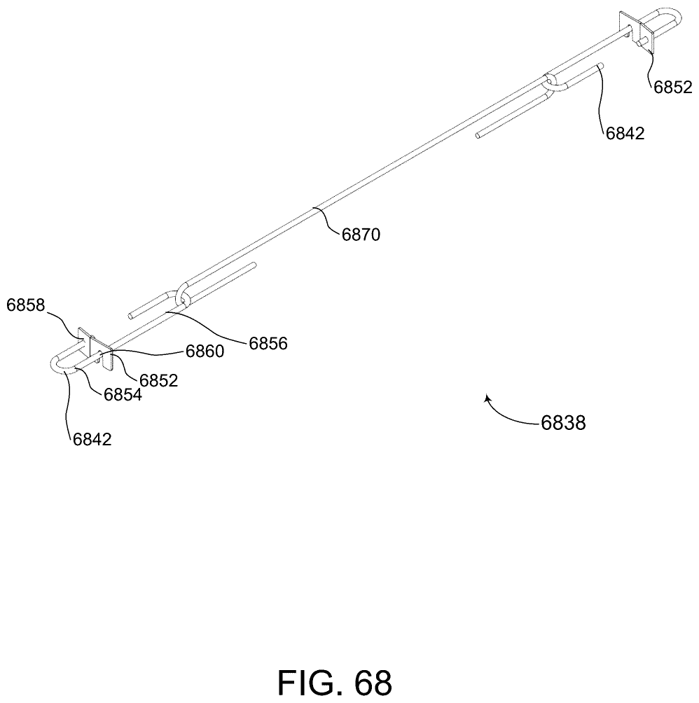

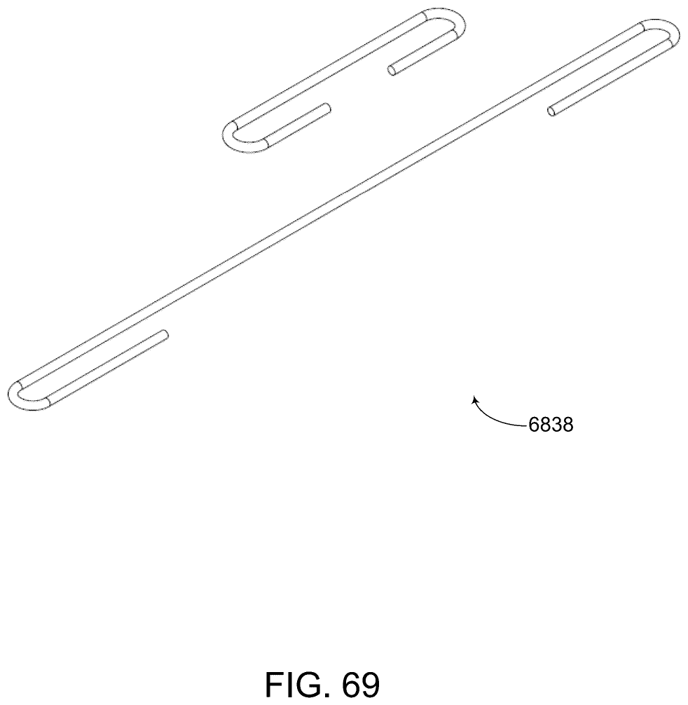

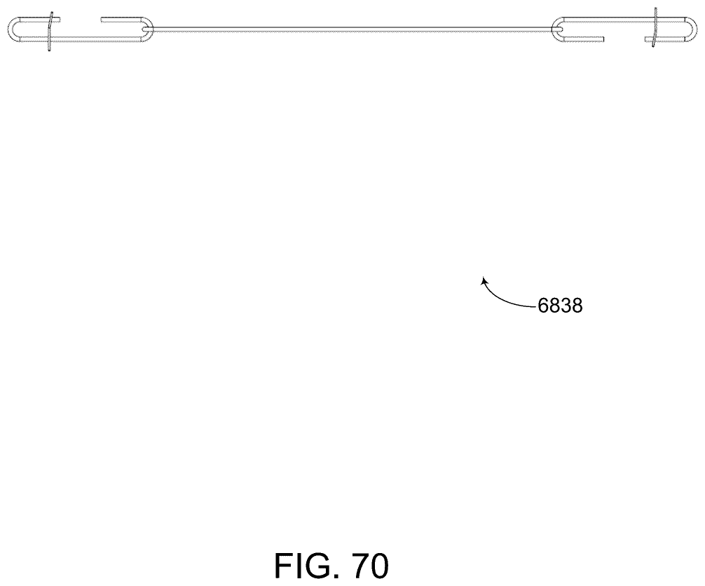

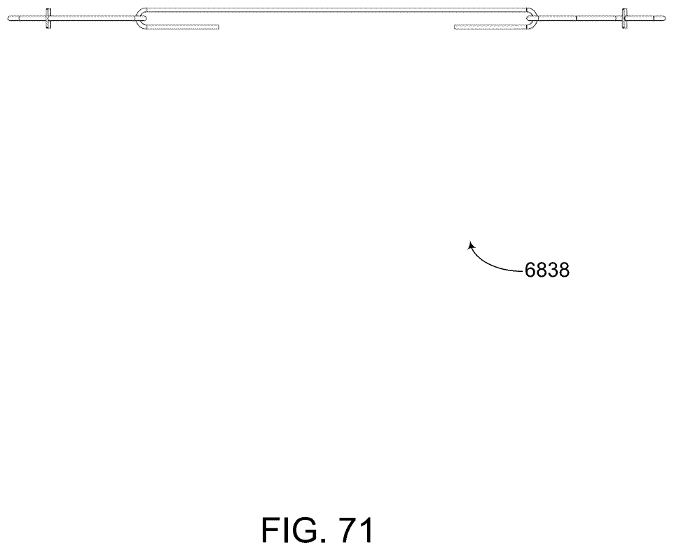

Additionally, FIGS. 68-71 illustrate a connector system 6838. FIG. 68 illustrates a perspective view of the connector system 6838. FIG. 69 illustrates another perspective view of the connector system 6838 illustrated in FIG. 68. FIG. 70 illustrates a top view of the connector system 6838 illustrated in FIG. 68. FIG. 71 illustrates a side view of the connector system 6838 illustrated in FIG. 68. As shown in FIGS. 68-71, the connector system 6838 includes a loop 6842, a plate 6852, and a connector loop 6870. In the illustrated embodiment, the loop 6842 is shaped such that the loop 6842 includes a primary loop 6854 and a secondary loop 6856. The plate 6852 includes a metallic (such as steel), fiberglass, and/or composite plate that defines a primary hole 6858 and a secondary slot 6860. The loop 6842 is shaped such that the primary loop 6854 extends through the primary hole 6858 and the secondary slot 6860. The primary loop 6854 slides into the secondary slot 6860 and slides toward the primary loop 6854 such that the primary loop 6854 extends into the primary hole 6858. The secondary loop 6856 extends into the barrier 3800 and the plate 6852 is angles such that the plate 6852 presses against the primary loop 6854. Furthermore, the connector loop 6870 is formed of a single piece of rebar that extends through the sustainable barrier 3800 and loops onto the secondary loops 6856 of opposing loops 6842. As such, the loops 6842 on opposite sides of the sustainable barriers 3800 are connected by a single piece of rebar that strengthens the connection of the loops 6842 to the sustainable barriers 3800 and the connection between the sustainable barriers 3800. As described above, the connector system 6838 is cured into the barrier 3800 in the assembled configuration illustrated in FIG. 43. The shape of the loop 6842 presses against the plate 6852 and the plate 6852 provides additional strength and resistance to maintain the connector system 6838 in the barrier 3800 during an impact or other event. Furthermore, the connector loop 6870 strengthens the connection of the loops 6842 to the sustainable barriers 3800 and the connection between the sustainable barriers 3800. Accordingly, the connector system 6838 describe herein increase the strength of the connection between barriers 3800 by incorporating the plate 6852 and the shaped loop 6842 such that the shaped loop 6842 presses against the plate 6852 and the plate 6852 provides additional resistance and strength to the loop 6842 to reduce the likelihood of the loop 6842 being pulled out of the barriers 3800.

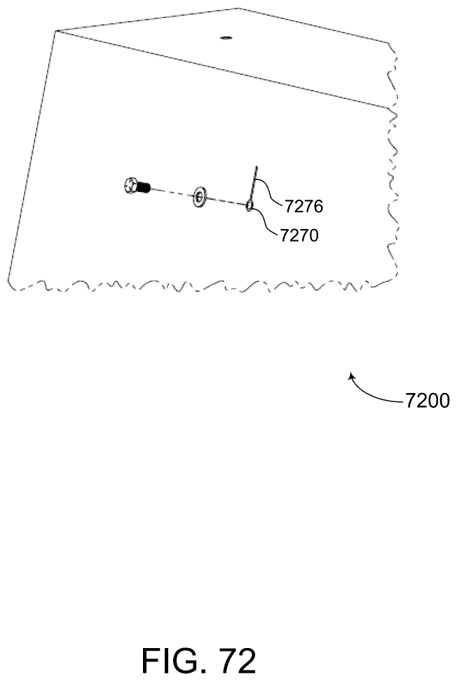

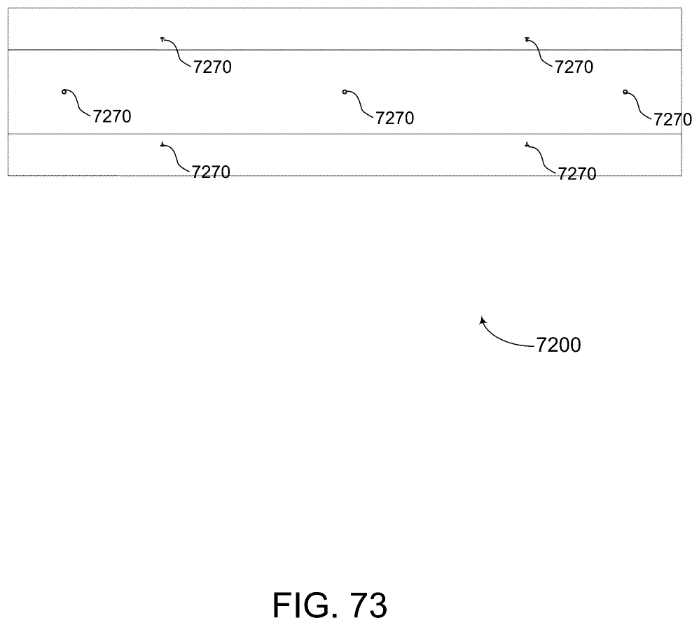

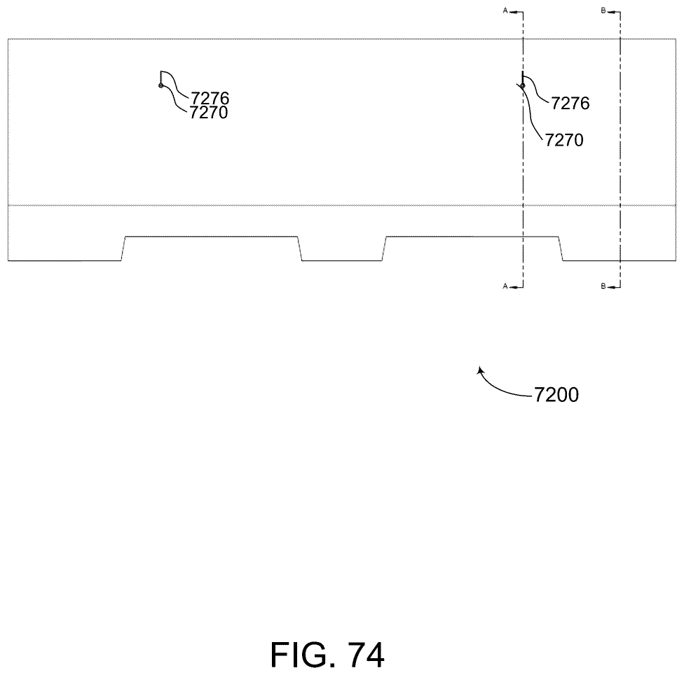

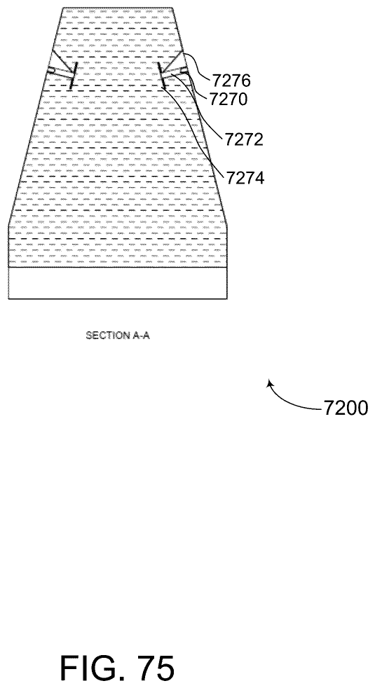

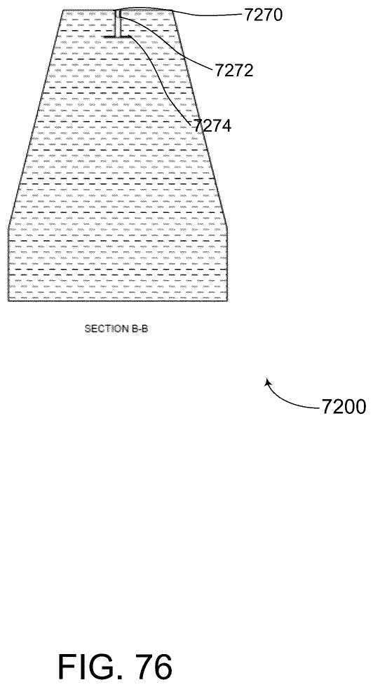

FIGS. 72-76 illustrate a barrier 7200 including an anchor system 7270. FIG. 72 illustrates a perspective view of the barrier 7200 including the anchor system 7270. FIG. 73 illustrates a top view of the barrier 7200 including the anchor system 7270 illustrated in FIG. 72. FIG. 74 illustrates a side view of the barrier 7200 including the anchor system 7270 illustrated in FIG. 72. FIG. 75 illustrates a side sectional view of the barrier 7200 including the anchor system 7270 illustrated in FIG. 72. FIG. 76 illustrates a side sectional view of the barrier 7200 including the anchor system 7270 illustrated in FIG. 72. As shown in FIGS. 72-76, the anchor system 7270 includes a sleeve 7272 and a flange 7274. The sleeve 7272 is configured to receive a screw or a bolt. Specifically, the sleeve 7272 is threaded such that the sleeve 7272 can receive a screw or a bolt. The flange 7274 is configured to be expanded withing the barrier 7200 and is configured to provide additional strength and resistance to maintain the anchor system 7270 in the barrier 7200. In some embodiments, the flange 7274 may be inserted into the barrier 7200 through a slot 7276 and may be expanded into the barrier 7200 to retain the anchor system 7270 in the barrier 7200. The anchor system 7270 is configured to receive a bolt to hold a sign or another accessory on the barrier 7200. For example, the anchor system 7270 may be configured to connect picking eyes or may be mounting points for attaching fixtures to the barriers 7200 such as fencing, fixtures, signs, reflectors, graphics, lighting, and/or any other fixture. Accordingly, the anchor systems 7270 described herein provide additional versatility for the barriers 7200 described herein.

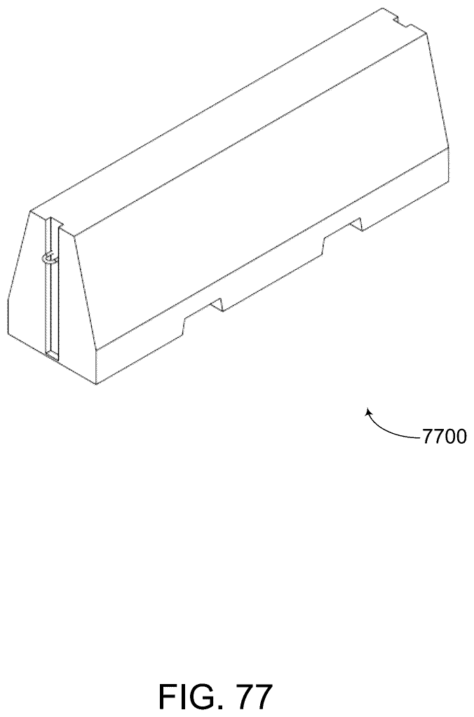

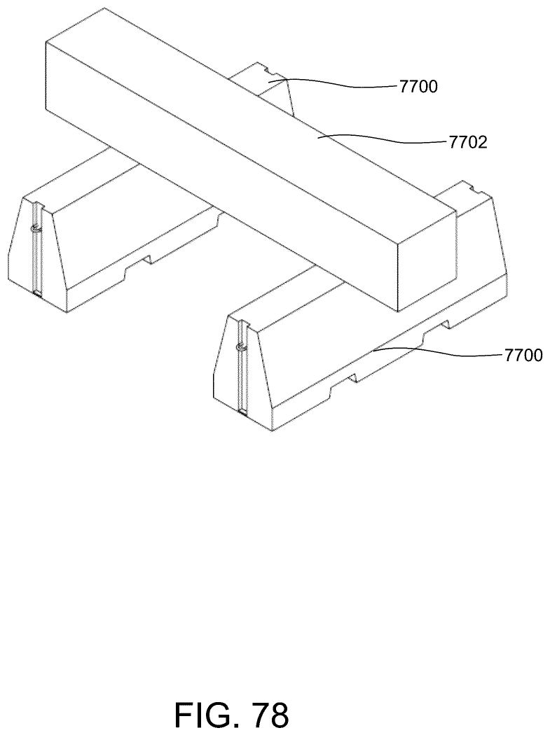

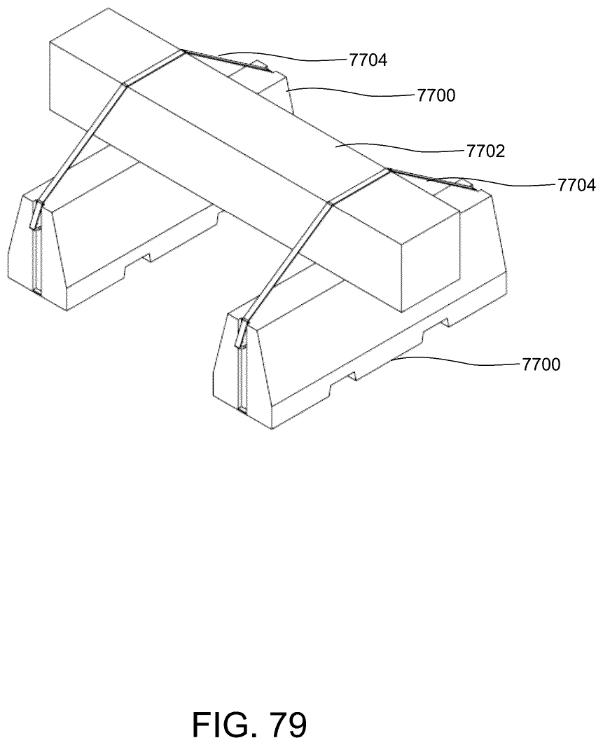

FIGS. 77-79 illustrate a barrier 7700 with performance advantages over traditional concrete barriers. FIG. 77 illustrates a perspective view of the barrier 7700. FIG. 78 illustrates a perspective view of two of the barriers 7700 illustrated in FIG. 77 supporting a load 7702. FIG. 79 illustrates a perspective view of two of the barriers 7700 illustrated in FIG. 77 supporting the load 7702 and securing the load 7702 with a strap 7704. The sustainable barriers illustrated in FIGS. 77-79 have performance advantages over traditional concrete barriers, and purpose built metal stands, in a load rated applications. More specifically, traditional concrete barriers are not designed to support large loads upon them because they offer no benefits over purpose built stands or supports and may be too brittle. Metal load rated stands are typically rated for up to 20,000 pounds and can damage the equipment placed upon them due to the hard metal surface. In contrast, the sustainable barrier 7700 described herein has a maximum load rating of at least 25,000 pounds with a safety factor of 3 for total load for a barrier 7700 that is at least 6 ft in length. In some embodiments, the maximum load rating may be at least 32,000 pounds with a safety factor of 3 for total load for a barrier 7700 that is at least 8 ft in length. Additionally, the sustainable barrier 7700 described herein has a maximum surface pressure rating of at least 150 pound per square inch with a safety factor of 4 for pressure. Furthermore, the sustainable barrier 7700 described herein have undergone further testing and have withstood a surface pressure of over 600 pound per square inch and a total load of over 80,000 pounds without any signs of damage. Furthermore, the sustainable barriers 7700 are also capable of supporting a substantial load for an extended period of time (more than a month) without sustaining any damage.

As such, the sustainable barriers 7700 may be used to support equipment, like industrial saw horses do, because the sustainable barriers 7700 have a high load rating. Specifically, the sustainable barriers 7700 have a maximum load rating of at least 25,000 pounds (greater than 10 tons) and, because the sustainable barriers 7700 are made of softer waste materials, the sustainable barriers 7700 do not damage the other equipment, they contour to the load, and have high friction against the load.

Furthermore, as shown in FIG. 79, the strap 7704 may be secured to at least one of the loops of the connector systems described herein and attached to the load 7702 such that the load 7702 is secured to at least one of the barriers 7700. In the illustrated embodiment, two barriers 7700 support the load 7702 and two straps 7704 secures the load 7702 to the barriers 7700. In alternative embodiments, any number of barriers 7700 may be used to support the load 7702 and any number of straps 7704 may be used to secure the load 7702.

Additionally, the sustainable barriers 7700 also have a maximum elongation at failure of at least approximately 52 percent. Having a higher maximum elongation of the sustainable barrier 7700 allows for larger deformations without failure. Increasing the maximum elongation increases the ability to absorb energy over a longer duration, which could allow for higher speed impacts without risk of failure of the sustainable barrier 7700. If an equivalent amount of energy is absorbed over a longer duration, then the peak deacceleration of the object impacting the sustainable barrier 7700 would be reduced, which is generally safer. Having a low maximum elongation to failure value, as is typical in materials like concrete, results in a more brittle, sudden failure with very little deformation. Successful use of a sustainable barrier 7700 with a minimal maximum elongation at failure value allows for simplification in the manufacturing process since higher elongation values are more challenging to achieve. A broader set of materials can be used with lower elongation targets.

Additionally, the sustainable barriers 7700 also have a maximum tensile strength of, at least, approximately 450 kPa. The maximum tensile strength provides a number of benefits related to the ability to resist damage to the sustainable barrier 7700. Upon impact, a higher maximum tensile strength would lead to less rupture, cracking, and tearing. With less damage incurred, the sustainable barrier 7700 has a greater chance of being reused after an impact. Greater maximum tensile strength allows for higher speed impacts before failing. Successful use of a sustainable barrier 7700 with a minimal maximum tensile strength allows for simplification in the manufacturing process since higher maximum tensile strength values are more challenging to achieve. A broader set of materials can be used with lower maximum tensile strength targets.

In addition, the sustainable barriers 7700 also have a tensile modulus of at least approximately 1,000 kPa. The tensile modulus enables the sustainable barriers 7700 to resist lengthening when stuck by an object, most noticeably when attached to subsequent sustainable barriers 7700, forming a chain of sustainable barriers 7700. A higher tensile modulus in the sustainable barrier 7700 would provide more resistance to deforming when pulled on, which would engage adjacent connect barriers more rapidly, allowing a system of barriers 7700 to deform less upon impact. This would be beneficial in preventing people or objects behind the barriers 7700 from being struck. Higher tensile modulus would also more fully resist internal rebar components, such as loop ends, from being removed from the barrier 7700. Using a sustainable barrier 7700 with the lowest tensile modulus possible provides a softer impact for the object, which in the case of a vehicle, means a safer impact for occupants.

Moreover, the sustainable barriers 7700 also have a compressive modulus of at least approximately 5,900 kPa. The compressive modulus is related to how far an object will deform into the sustainable barrier 7700 with a given load. A higher modulus would imply less deformation into the sustainable barrier 7700 with a given impact, and more redirection of the object. Using a sustainable barrier 7700 with the lowest compressive modulus possible provides a softer impact for the object, which in the case of a vehicle, means a safer impact for occupants.

Moreover, the sustainable barriers 7700 also have a flexural modulus of at least approximately 2,000 kPa. The flexural modulus enables the sustainable barriers 7700 to resist bending when stuck by an object, most noticeably when struck in the mid-span of a long section. A higher flexural modulus in the sustainable barrier 7700 would provide more resistance to deforming when struck, providing a greater ability to redirect the object. Using a sustainable barrier 7700 with the lowest flexural modulus possible provides a softer impact for the object, which in the case of a vehicle, means a safer impact for occupants.

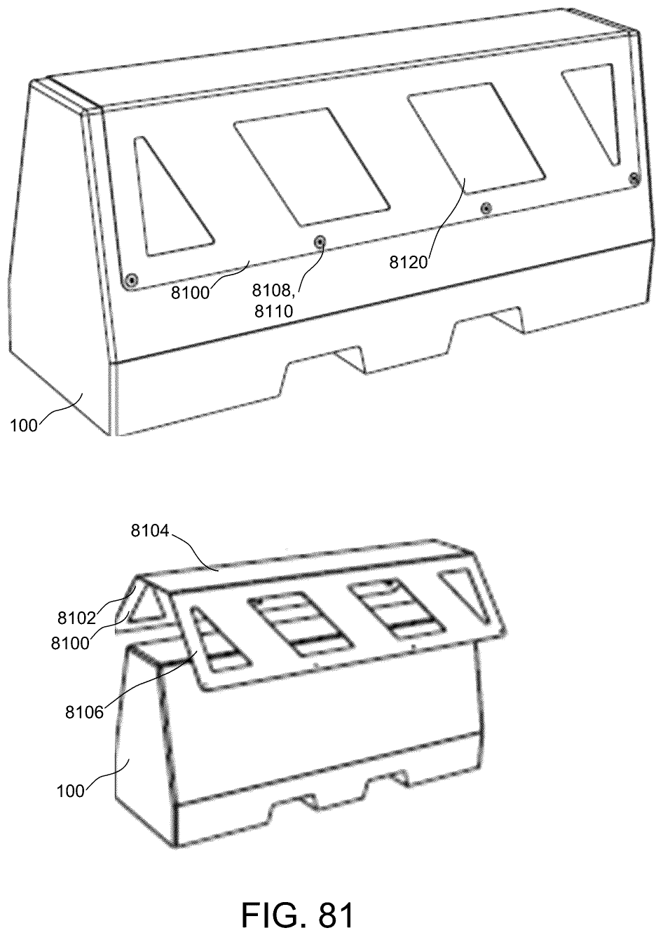

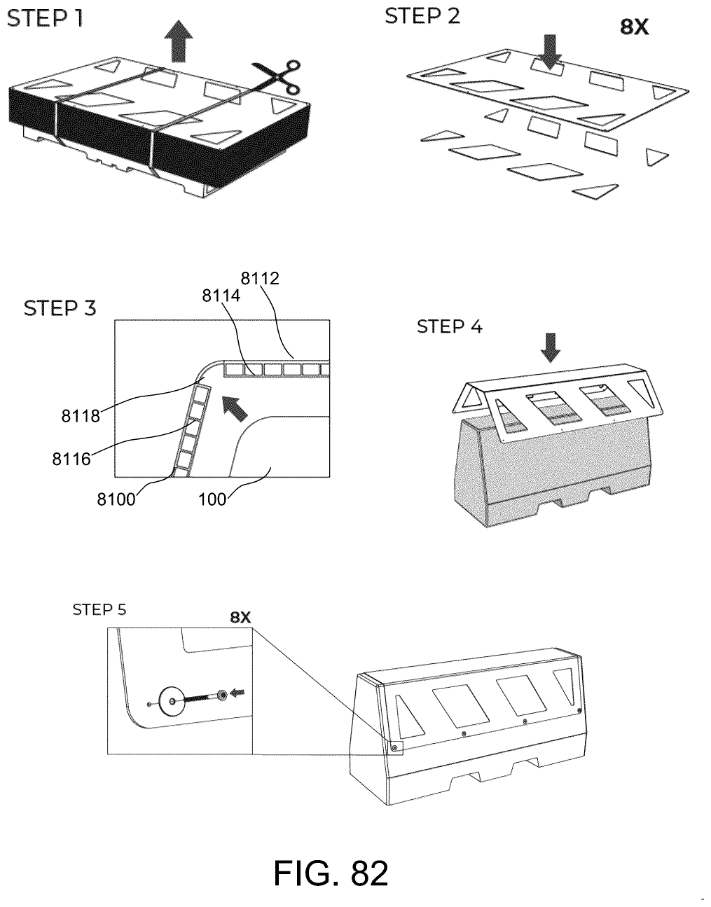

FIG. 81 illustrates a perspective view of a barrier jacket 8100 attached to the barrier 100 and an exploded view of the barrier jacket 8100 and the barrier 100. FIG. 82 illustrates a method of attaching the barrier jacket 8100 to the barrier 100. As shown in FIGS. 81 and 82, the barrier jacket 8100 is configured to be attached to the barrier 100 to increase the visibility of the barrier 100, display branding on the barrier 100, display signs for directing vehicles or pedestrians, and/or display decorations on the barrier 100. Additionally, the barrier jacket 8100 may include reflective material and/or paint that increases the visibility of the barrier 100. The barrier jacket 8100 may also include advertisements, decorations, and/or directions.

In the illustrated embodiment, the barrier jacket 8100 described herein includes sheet material. Specifically, in some embodiments, the barrier jacket 8100 includes plastic formed in a specific configuration such that the barrier jacket 8100 is folded to conform to the shape of the barrier 100. In some embodiments, the barrier jacket 8100 includes a twin wall plastic sheet formed of polypropylene. In alternative embodiments, the barrier jacket 8100 may be formed of any material that enables the barrier jacket 8100 to operate as described herein. For example, the barrier jacket 8100 may be formed of metal that can be folded into a shape conforming to the shape of the barrier 100 or a single wall plastic sheet that can also be folded into a shape conforming to the shape of the barrier 100.

In the illustrated embodiment, the barrier jacket 8100 is folded into three sections to conform to the shape of the barrier 100. Specifically, the barrier jacket 8100 includes a first section 8102, a second section 8104, and a third section 8106. The first section 8102 and the third section 8106 are configured to be attached to the angled tops 118 of the barrier 100 and the second section 8104 is configured to be attached to the top 102 of the barrier 100. At least the first section 8102 and the third section 8106 each include at least one or a plurality of holes 8108 configured to receive at least one or a plurality of fasteners 8110 configured to attach the barrier jacket 8100 to the barrier 100. In the illustrated embodiment, the fasteners 8110 include screws. In alternative embodiments, the barrier jacket 8100 may be attached to the barrier 100 using any type of fastener including, but not limited to, nails, staples, adhesives, and/or any other fastener.

Additionally, as shown in FIG. 82, the barrier jacket 8100 includes a twin wall plastic sheet formed of polypropylene having a first sheet 8112 and a second sheet 8114 attached to each other by a plurality of connectors 8116. The twin wall construction increases the strength of the barrier jacket 8100 but makes folding the barrier jacket 8100 difficult. To make folding easier during installation, the barrier jacket 8100 includes a partial cutout 8118 of the second sheet 8114 that enables the barrier jacket 8100 to fold into three sections to conform to the shape of the barrier 100. Additionally, the barrier jacket 8100 may include a plurality of knockouts 8120 that may be removed to form a design on the barrier 100.

During assembly and installation, the barrier jackets 8100 are removed from a pallet and, if any knockouts 8120 are included in the barrier jackets 8100, the knockouts 8120 are removed. The barrier jackets 8100 are bent along the partial cutouts 8118 and positioned on top of the barrier 100. The fasteners 8110 are inserted into the holes 8108 in the barrier jacket 8100 and into the barrier 100 to attach the barrier jacket 8100 to the barrier 100 and to maintain the barrier jacket 8100 in position on the barrier 100. Accordingly, the barrier jackets 8100 described herein enable the barriers 100 to be modified as need in a quick and economical manner, reducing labor and manufacturing costs.

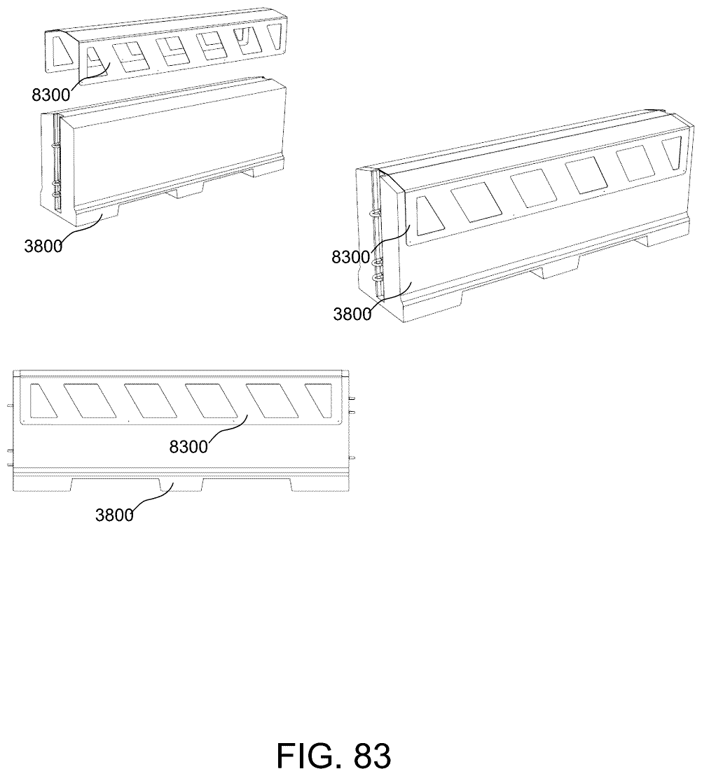

FIG. 83 illustrates a barrier jacket 8300 attached to the barrier 3800. Additionally, the barrier jacket 8100 described herein may be adapted to be installed on other sustainable barriers described herein. For example, the barrier jacket 8100 may be adapted to be installed on the sustainable barrier 3800 by increasing the number of partial cutouts 8118 such that the barrier jacket 8100 is configured to be installed on the sustainable barrier 3800. Specifically, the barrier jacket 8100 may include four partial cutouts 8118 such that the barrier jacket 8100 is folded into five sections that are sized and shaped to be installed on the sustainable barrier 3800.

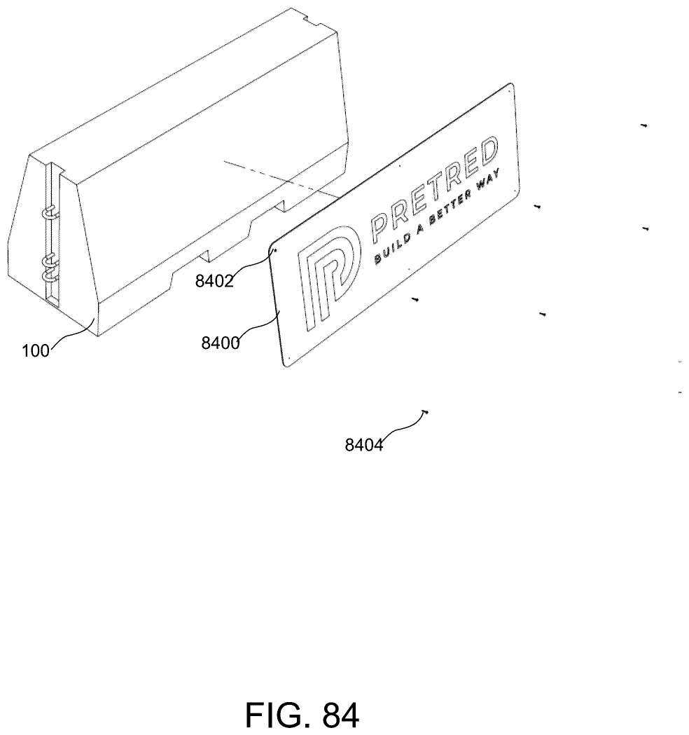

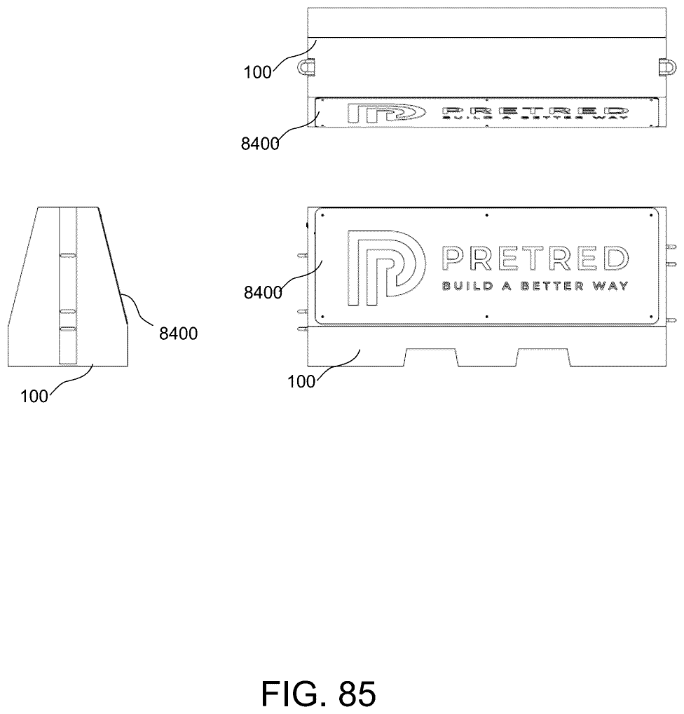

FIG. 84 illustrates an exploded view of a sign 8400 attached to the barrier 100. FIG. 85 illustrates a front, top, and side view of the sign 8400 attached to the barrier 100. As shown in FIGS. 84 and 85, the sign 8400 is configured to be attached to the barrier 100 to increase the visibility of the barrier 100, display branding on the barrier 100, display signs for directing vehicles or pedestrians, and/or display decorations on the barrier 100. Additionally, the sign 8400 may include reflective material and/or paint that increases the visibility of the barrier 100. The sign 8400 may also include advertisements, decorations, and/or directions. The sign 8400 may also be adapted to be attached to the barrier 3800.

In the illustrated embodiment, the sign 8400 described herein includes a sheet material with a display printed on the sheet material. More specifically, in some embodiments, the sign 8400 includes plastic formed in a specific configuration such that the sign 8400 conforms to the shape of the barrier 100. In some embodiments, the sign 8400 includes a twin wall plastic sheet formed of polypropylene. In alternative embodiments, the sign 8400 may be formed of any material that enables the sign 8400 to operate as described herein including, but not limited to, metal, wood, and/or any other material. Additionally, the sign 8400 includes at least one or a plurality of holes 8402 configured to receive at least one or a plurality of fasteners 8404 that attach the sign 8400 to the barrier 100. In the illustrated embodiment, the fasteners 8404 include screws. In alternative embodiments, the sign 8400 may be attached to the barrier 100 using any type of fastener including, but not limited to, nails, staples, adhesives, and/or any other fastener.

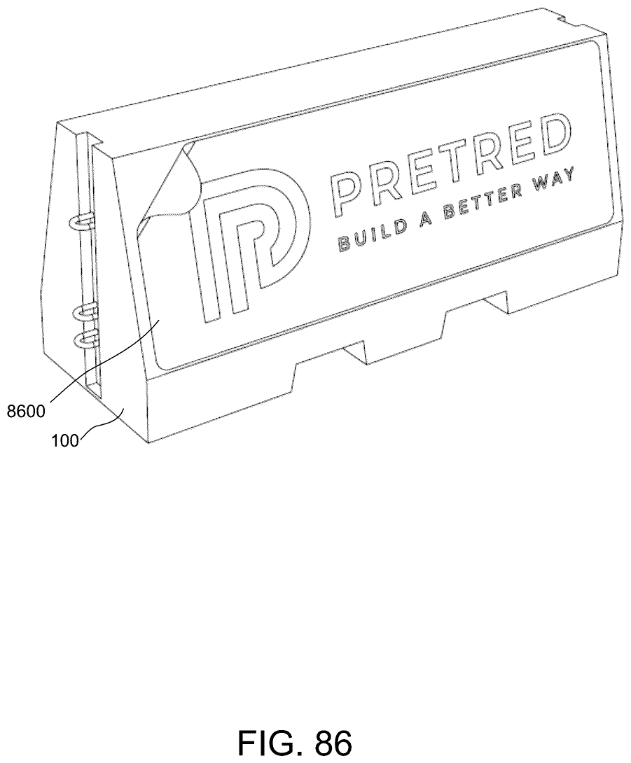

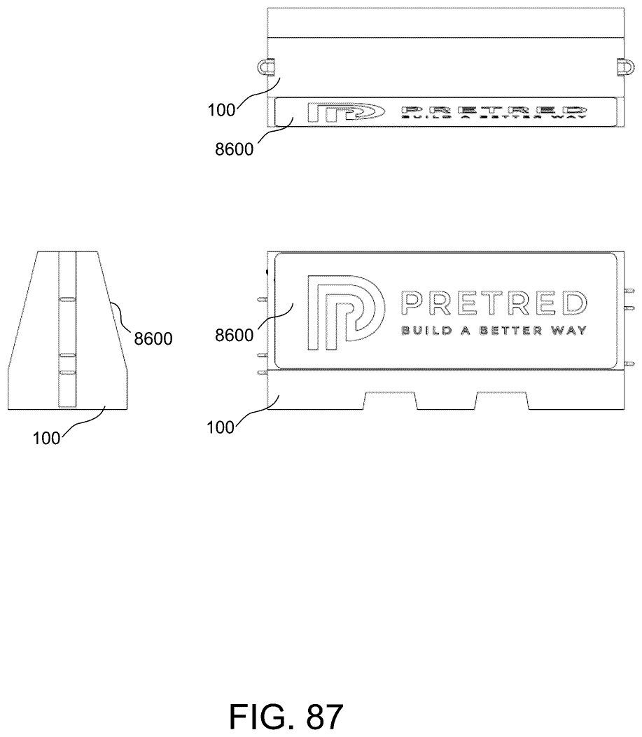

FIG. 86 illustrates a perspective view of another sign 8600 attached to the barrier 100. FIG. 87 illustrates a front, top, and side view of the sign 8600 attached to the barrier 100. As shown in FIGS. 86 and 87, the sign 8600 is configured to be attached to the barrier 100 to increase the visibility of the barrier 100, display branding on the barrier 100, display signs for directing vehicles or pedestrians, and/or display decorations on the barrier 100. Additionally, the sign 8600 may include reflective material and/or paint that increases the visibility of the barrier 100. The sign 8600 may also include advertisements, decorations, and/or directions. The sign 8600 may also be adapted to be attached to the barrier 3800.

In the illustrated embodiment, the sign 8600 described herein includes a sheet material with a display printed on the sheet material. More specifically, in some embodiments, the sign 8600 includes vinyl formed in a specific configuration such that the sign 8600 conforms to the shape of the barrier 100. In the illustrated embodiment, the sign 8600 is a flexible, vinyl sign that is attached to the barrier 100 using an adhesive. More specifically, the adhesive may include a pressure-sensitive, high tack adhesive attached to a vinyl sign. The sign 8600 may be wrapped around the corners of the barrier 100 because the sign 8600 is made of a flexible material. In alternative embodiments, the sign 8600 may be formed of any material that enables the sign 8600 to operate as described herein including, but not limited to, metal, wood, and/or any other material.

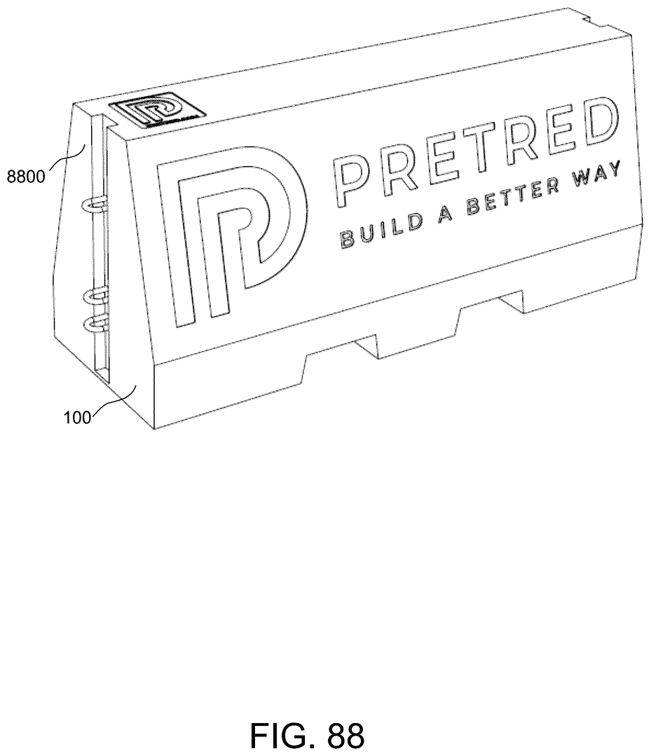

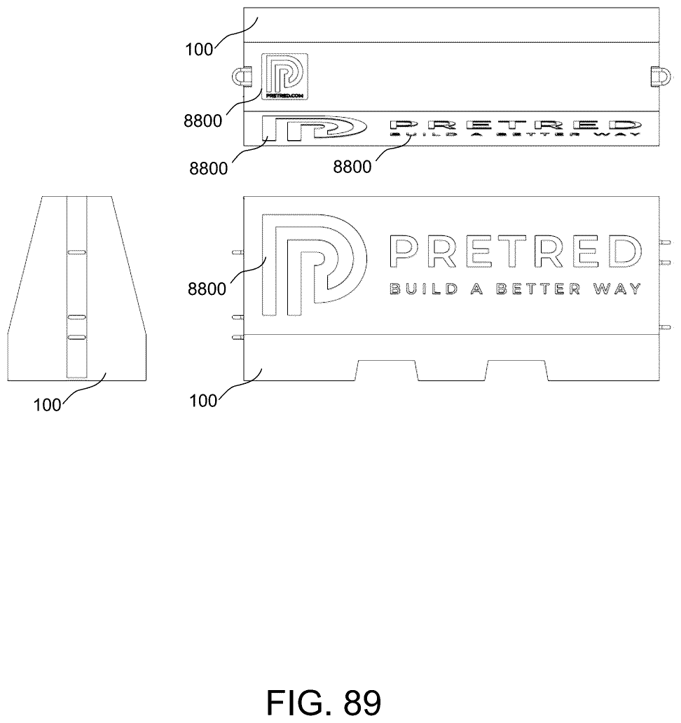

FIG. 88 illustrates a perspective view of the barrier 100 including at least one design 8800 debossed and/or embossed into the barrier 100. FIG. 89 illustrates a front, top, and side view of the barrier 100 including the at least one design 8800 debossed and/or embossed into the barrier 100. As shown in FIGS. 88 and 89, the design 8800 is configured to be debossed and/or embossed into at least one of a side, top, end, and/or bottom of the barrier 100 to increase the visibility of the barrier 100, display branding on the barrier 100, display signs for directing vehicles or pedestrians, and/or display decorations on the barrier 100. Additionally, the design 8800 may include reflective material and/or paint that increases the visibility of the barrier 100. The design 8800 may also include advertisements, decorations, and/or directions. The design 8800 may also be embossed into the barrier 3800. In the illustrated embodiment, the design 8800 is debossed into the barrier 100 by including a die in the shape of the design 8800 within the mold as the batter cures.

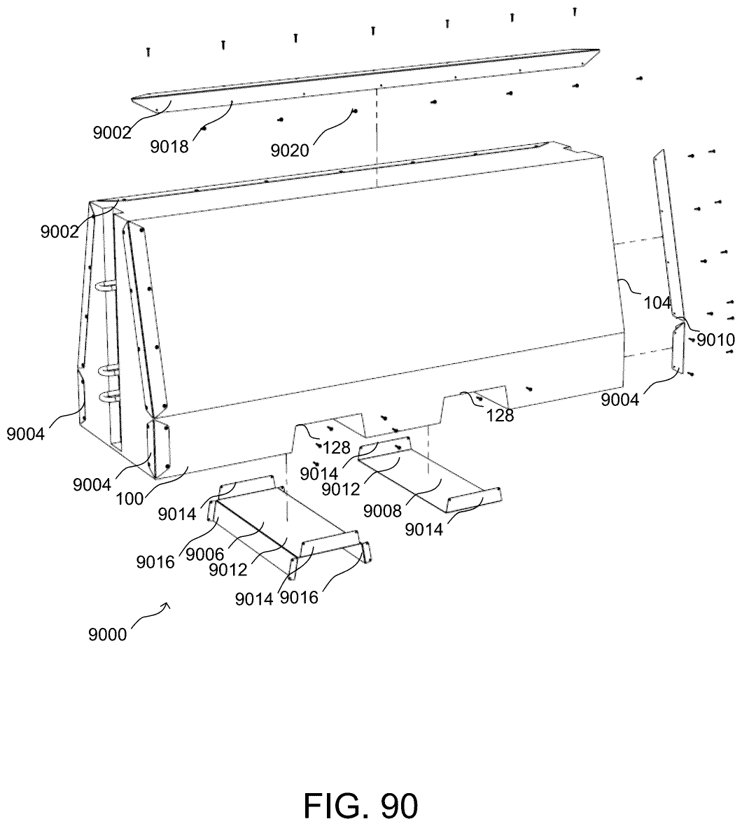

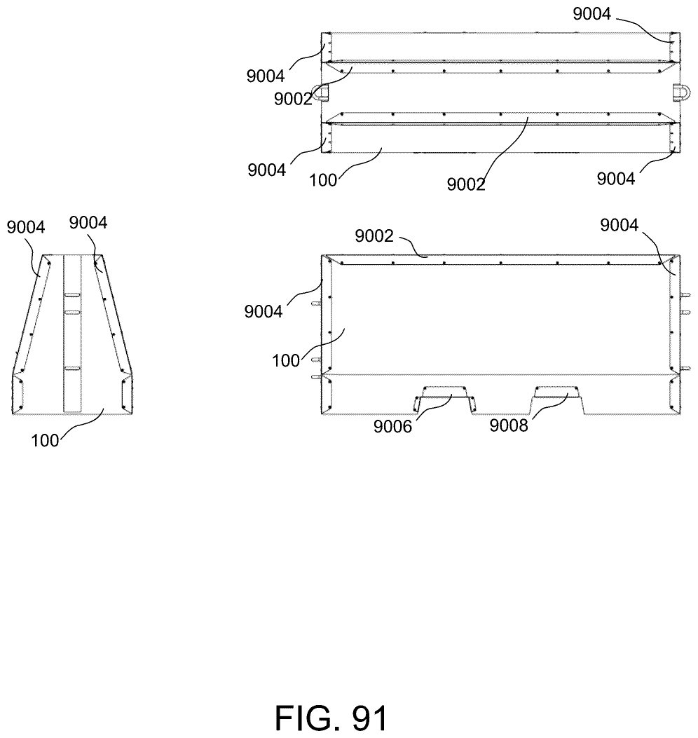

FIG. 90 illustrates a perspective, exploded view of the barrier 100 including a plurality of protective coverings 9000. FIG. 91 illustrates a front, top, and side view of the barrier 100 including the plurality of protective coverings 9000. Specifically, the plurality of protective coverings 9000 includes two top corner coverings 9002, four side corner coverings 9004, a first drainage slot covering 9006, and a second drainage slot covering 9008. The protective coverings 9000 are configured to protect the barrier 100 as the barrier 100 is deployed or being deployed. Specifically, the corners of the barrier 100 may be vulnerable to chipping during deployment and use. Additionally, the drainage slot 128 may be used as lifting points for a forklift and the first and second drainage slot coverings 9006 and 9008 protect the drainage slots 128 during repeated lifting. As such, the protective coverings 9000 protect the barrier 100 during deployment and use.

In the illustrated embodiment, the protective coverings 9000 are formed of sheet metal formed into sheets that are then formed into a shape that corresponds to the shape of the barrier 100. In alternative embodiments, the protective coverings 9000 may be formed of any material that protects the barrier 100 including, but not limited to, plastic, rubber, wood, and/or any other material.

The two top corner coverings 9002 each include a single sheet of metal that has been folded to correspond to the shape of the corner of the top 102 of the barrier 100. Similarly, the four side corner coverings 9004 each also include a single sheet of metal that has been folded to correspond to the shape of the corner of the sides 104 of the barrier 100. The four side corner coverings 9004 may also include cutouts 9010 that enable the sheet of metal to be bent to correspond to the shape of the corner along the entire height of the barrier 100.

As discussed above, the first and second drainage slot coverings 9006 and 9008 protect the drainage slots 128 during repeated lifting. The first and second drainage slot coverings 9006 and 9008 each include a base plate 9012 and two vertical plates 9014 extending from an end of the base plate 9012. The base plate 9012 protects the under side of the barrier 100 during lifting and the two vertical plates 9014 protect the side of the barrier 100 as the forklift is engaging the drainage slots 128. The first drainage slot covering 9006 may further include two side plates 9016 that are configured to protect the sides of the drainage slots 128 during lifting.

Each of the protective coverings 9000 include at least one or a plurality of holes 9018 configured to receive at least one or a plurality of fasteners 9020 that attach the protective coverings 9000 to the barrier 100. In the illustrated embodiment, the fasteners 9020 include screws. In alternative embodiments, the protective coverings 9000 may be attached to the barrier 100 using any type of fastener including, but not limited to, nails, staples, adhesives, and/or any other fastener.

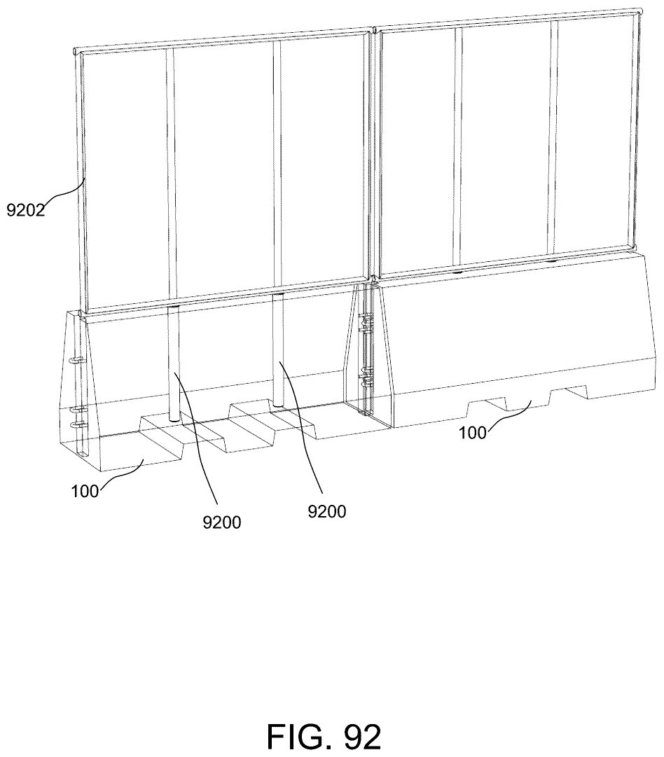

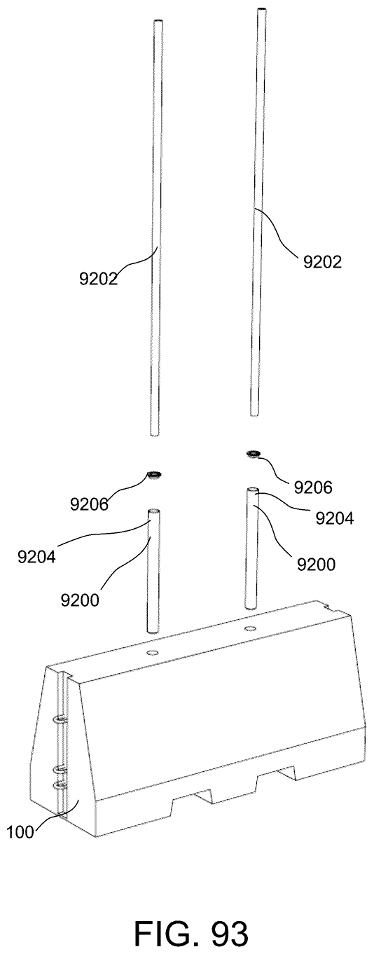

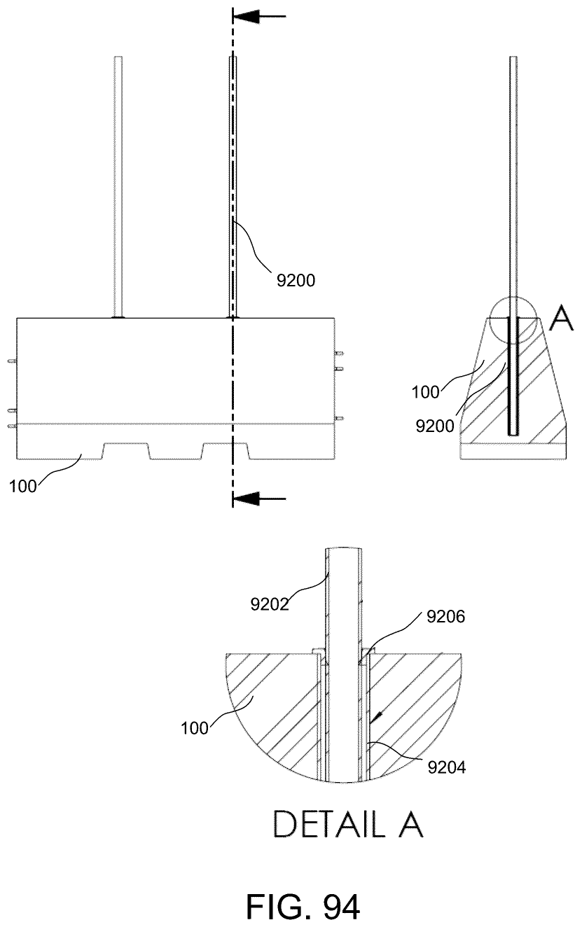

FIG. 92 illustrates a perspective view of an accessory attachment unit 9200 incorporated into the barrier 100. FIG. 93 illustrates an exploded view of the accessory attachment unit 9200. FIG. 94 illustrates a cross-sectional view of the accessory attachment unit 9200. The accessory attachment unit 9200 enables accessories 9202 to be attached to the barriers 100. For example, as illustrated in FIG. 92, the accessory 9202 is a fence that extends from the top 102 of the barrier 100. In alternative embodiments, the accessory 9202 may include a sign, another type of barrier, cabling, and/or any other type of accessory that can extend vertically from the barrier 100.

The accessory attachment unit 9200 includes at least one tube 9204 overmolded into the barrier 100. Specifically, the tube 9204 is positioned in the mold and the batter is poured around the tube 9204. The batter hardens into the barrier 100 around the tube 9204 and the tube 9204 remains in place. The tube 9204 defines an opening in the barrier 100 that is then configured to receive the accessory 9202 (such as a fence post, a sign post, cabling, and/or any other accessory). The accessory attachment unit 9200 may further include at least one grommet 9206 positioned in the tube 9204 and configured to position and secure the fence post and/or sign post in the tube 9204 if the diameters of the tube 9204 and the posts are significantly different.

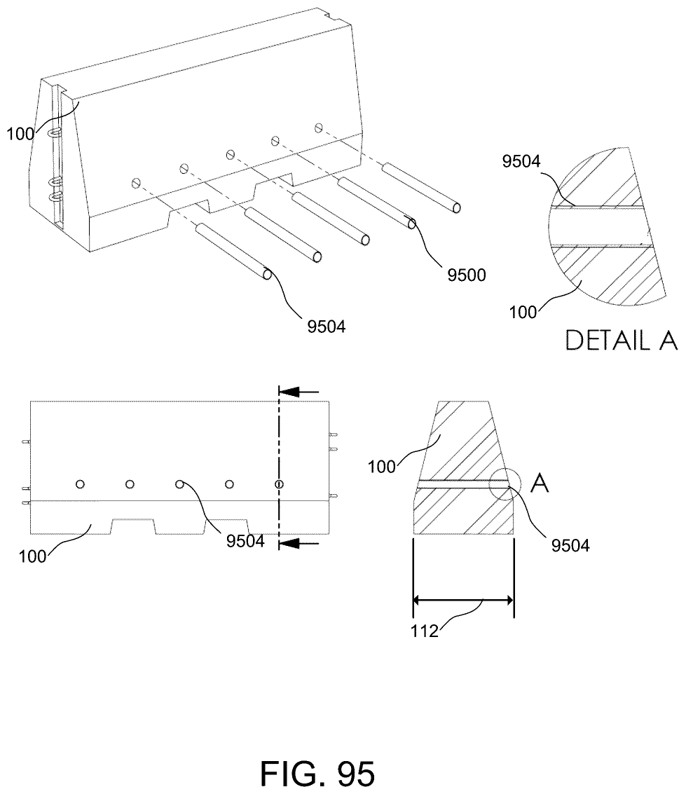

FIG. 95 illustrates a perspective view and a cross-sectional view of an alternative accessory attachment unit 9500 incorporated into the barrier 100. The accessory attachment unit 9500 enables also accessories to be attached to the barriers 100 but in a horizontal direction across the width 112 of the barrier. For example, as illustrated in FIG. 95, the accessory attachment unit 9500 extends through the width 112 of the barrier 100 to enable accessories to be attached to the barrier 100 or to enable drainage through the barrier 100. The accessory may include a fence, a sign, another type of barrier, cabling, and/or any other type of accessory that can extend horizontally from and through the barrier 100.

The accessory attachment unit 9500 includes at least one tube 9504 overmolded into the barrier 100. Specifically, the tube 9504 is positioned in the mold and the batter is poured around the tube 9504. The batter hardens into the barrier 100 around the tube 9504 and the tube 9504 remains in place. The tube 9504 defines two openings in the barrier 100 that is then configured to receive the accessory (such as a fence post, a sign post, cabling, and/or any other accessory) and/or is configured to enable drainage through the barrier 100.

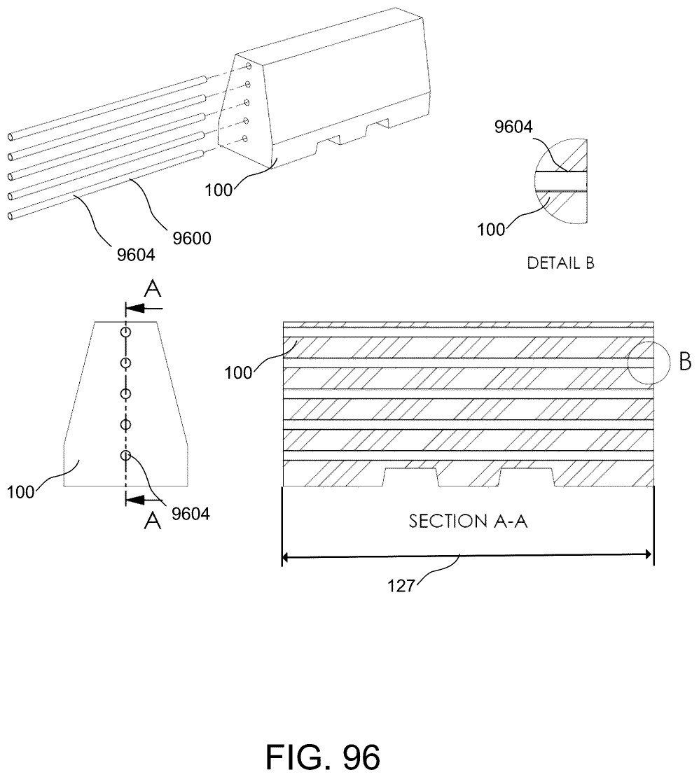

FIG. 96 illustrates a perspective view and a cross-sectional view of an alternative accessory attachment unit 9600 incorporated into the barrier 100. The accessory attachment unit 9600 enables also accessories to be attached to the barriers 100 but in a horizontal direction across the length 127 of the barrier. For example, as illustrated in FIG. 96, the accessory attachment unit 9600 extends through the length 127 of the barrier 100 to enable accessories to be attached to the barrier 100 or to enable drainage through the barrier 100. The accessory may include a connection system to attach the barrier 100 to another barrier 100 or to another object, a fence, a sign, another type of barrier, cabling, and/or any other type of accessory that can extend horizontally from and through the barrier 100.

The accessory attachment unit 9600 includes at least one tube 9604 overmolded into the barrier 100. Specifically, the tube 9604 is positioned in the mold and the batter is poured around the tube 9604. The batter hardens into the barrier 100 around the tube 9604 and the tube 9604 remains in place. The tube 9604 defines two openings in the barrier 100 that is then configured to receive the accessory (such as a connection system, a fence post, a sign post, cabling, and/or any other accessory) and/or is configured to enable drainage through the barrier 100.

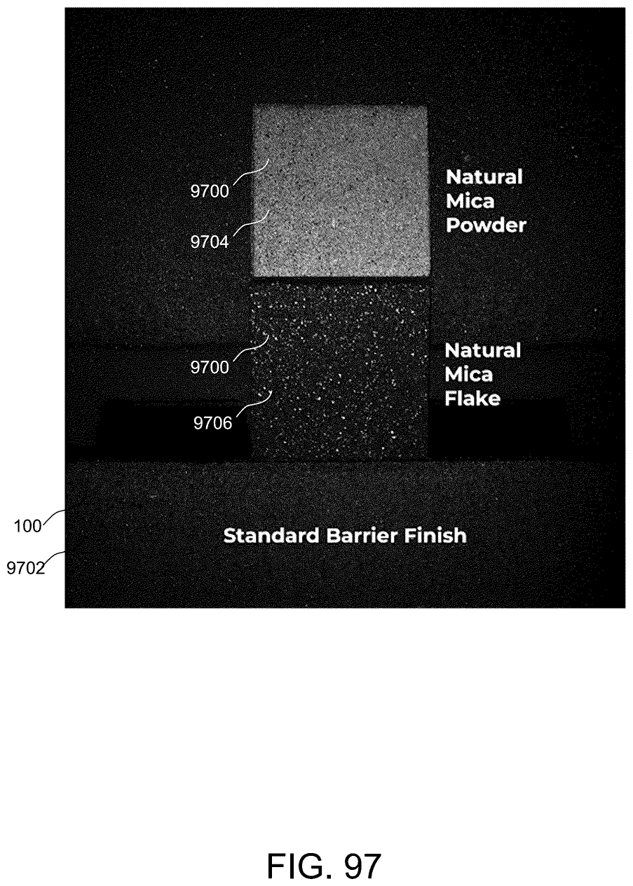

FIG. 97 illustrates a portion of the barrier 100 including reflective material 9700 to increase the visibility of the barrier 100 or the barrier 3800. Specifically, in the illustrated embodiment, the barrier 100 or the barrier 3800 includes a portion 9702 that does not include any reflective material 9700, a portion 9704 that includes reflective material 9700 including natural mica powder, and a portion 9706 that includes reflective material 9700 including natural mica flake. As shown in FIG. 97, the portions 9704 and 9706 are brighter and have increased visibility than the portion 9702 that does not include reflective material 9700. In the illustrated embodiment, the reflective material 9700 includes natural mica powder and natural mica flake. The reflective material 9700 may also include other reflective materials including glass (alumina, silica, titania, and/or any other glass), glitter, any type of mica, and/or any other reflective material. In the illustrated embodiment, the reflective material 9700 is mixed into the batter before molding and the barrier 100 or the barrier 3800 is molded with the reflective material 9700 mixed throughout the barrier 100 or the barrier 3800. In an alternative embodiment, the reflective material 9700 is applied to the surface of the barrier 100 or the barrier 3800 after the barrier 100 or the barrier 3800 has been molded.

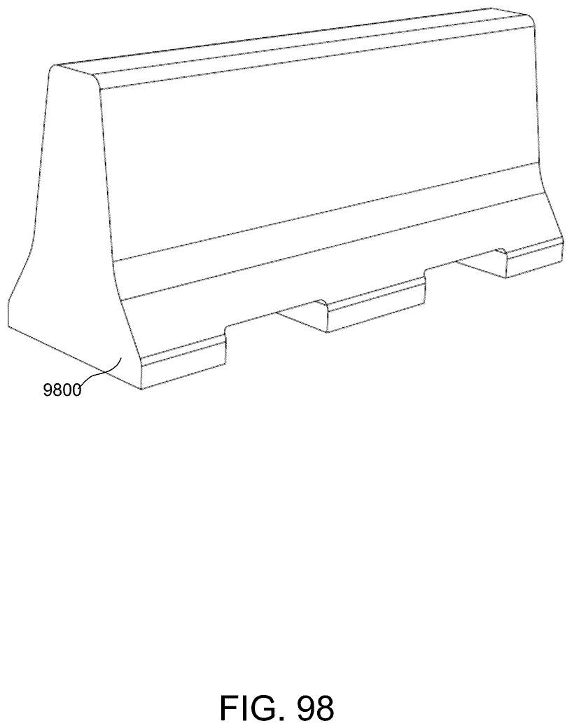

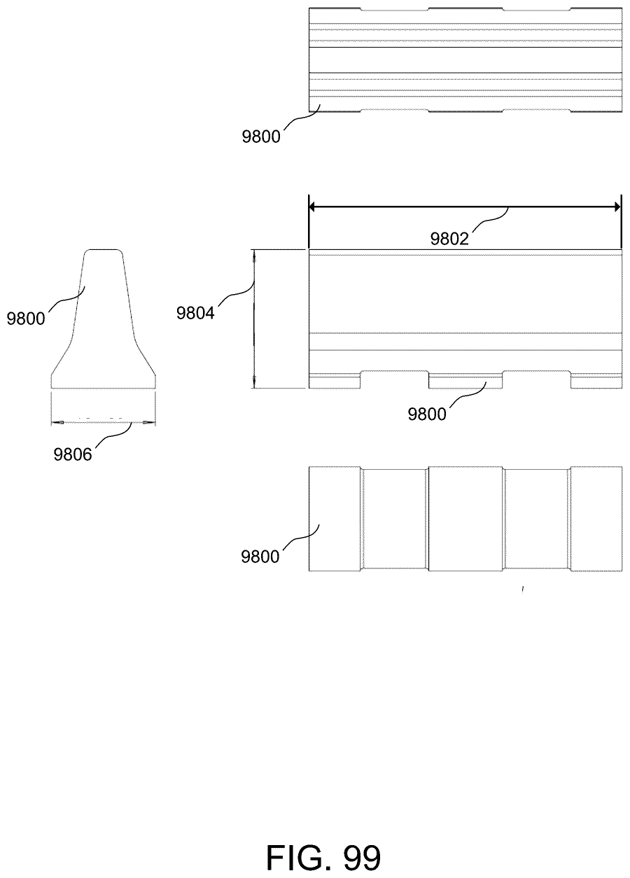

FIG. 98 illustrates a perspective view of a barrier 9800 in a Jersey style barrier shape. FIG. 99 illustrates top, bottom, and side views of the barrier 9800. The barrier 9800 includes a waste material and a binder. In the illustrated embodiment, the waste material include crumb rubber made from used tires. In alternative embodiments, the waste material may be any type of material. In the illustrated embodiment, the binder includes a polyurethane binder. In alternative embodiments, the binder may be any type of material.

The used tires are ground to form a crumb rubber and the binder is formulated to bind the crumb rubber into a formed barrier 9800. In the illustrated embodiments, the waste material is approximately 80% to approximately 90% by weight of the barrier 9800, approximately 81% to approximately 89% by weight of the barrier 9800, approximately 82% to approximately 88% by weight of the barrier 9800, approximately 83% to approximately 87% by weight of the barrier 9800, approximately 84% to approximately 86% by weight of the barrier 9800, or approximately 85% by weight of the barrier 9800. In alternative embodiments, the composition of the waste material in the barrier 9800 described herein may be any amount that enables the barrier 9800 to operate as described herein.

In the illustrated embodiments, the polyurethane binder is approximately 10% to approximately 20% by weight of the barrier 9800, approximately 11% to approximately 19% by weight of the barrier 9800, approximately 12% to approximately 18% by weight of the barrier 9800, approximately 13% to approximately 17% by weight of the barrier 9800, approximately 14% to approximately 16% by weight of the barrier 9800, and/or approximately 15% by weight of the barrier 9800. In alternative embodiments, the composition of the polyurethane binder in the barrier 9800 described herein may be any amount that enables the barrier 9800 to operate as described herein.

In the illustrated embodiment, the barrier 9800 has a length 9802 of approximately 1.83 meters (m), a height 9804 of approximately 810 millimeters (mm), a width 9806 of approximately 610 mm, and a mass of approximately 400 kilograms. In alternative embodiments, the length 9802 may be approximately 0.5 meters to approximately 8 meters, the height 9804 may be approximately 0.5 meters to approximately 2 meters, the width 9806 may be approximately 0.2 meters to approximately 2 meters, and the mass may be approximately 100 kilograms to approximately 2,000 kilograms.

The systems and methods disclosed herein relate to, among other things a sustainable barrier that may be used for a variety of purposes including use as a traffic barrier. The sustainable barriers described herein are formed of a waste material and a binder that binds the waste material into a specific shape for a specific use. Additionally, the waste material and the binder may be combined in different ratios with different compositions such that the material that forms the sustainable barrier may be tailored to specific uses. Moreover, the shape of the barriers may be tailored to a specific shape to suit a specific function. Accordingly, the sustainable barriers described herein are formed of a sustainable material with a tailored composition and shape to suit a specific function.

Specifically, in the illustrated embodiments, the waste material used to form the sustainable barriers described herein is used tires. In alternative embodiments, the waste material may be any material including, but not limited to, recycled plastics, recycled wood, and/or any other sustainable or recyclable material. The binder includes a polyurethane binder, an optional colorant, an optional catalyst, and a small amount of water. The used tires are ground to form a crumb rubber and the binder is formulated to bind the crumb rubber into a formed sustainable barrier. Specifically, the binder has been formulated to bind the crumb rubber into the sustainable barrier without using heat. More specifically, the catalyst within the binder quickly forms the sustainable barrier such that heat is not required.

The properties of the waste material and/or the processing conditions may be varied to tune or specify the final properties of the sustainable barrier. Specifically, a specific type of waste material may be selected to achieve a desired physical property within the sustainable barrier. For example, a denser waste material may be selected such that the sustainable barrier is denser and/or harder. The denser/harder sustainable barrier may be useful for specific uses or harsh environments. For example, the denser/harder sustainable barriers may be tailored such that the density is greater than the density of water and may be useful for flood control. Additionally, the denser/harder sustainable barriers may be useful for barriers in high traffic/high speed highways where collisions may cause damage to softer/less dense barriers.

Conversely, a less dense waste material may be selected such that the sustainable barrier is less dense and/or softer. The less dense/softer sustainable barrier may be useful for specific uses or specific environments. For example, the less dense/softer sustainable barriers may be useful for situations where a barrier is needed but the barrier needs to give to protect the object impacting the barrier. For example, barriers at bumper car facilities or go-cart racetracks need to stop the bumper car or go-cart without hurting the occupant or damaging the bumper car or go-cart. Certain waste materials are denser than others and may be suitable for specific situations. For example, tires suitable for large commercial vehicles (such as constructions vehicles and tractor trailers) are typically denser/harder than tires for residential vehicles and bicycles. The density of the sustainable barrier may be tuned by selecting the material the sustainable barrier is made from based on the materials density. Additionally, the density of the sustainable barrier may also be varied based on the compression pressure used to from the barrier. A higher compression pressure increases the density of the sustainable barrier and a lower compression pressure decreases the density of the sustainable barrier.

Furthermore, different mixtures of materials may form different parts of the same barrier with different densities to perform different functions. For example, a first uncured batter (combination of the waste material and the binder in an uncured slurry) may be poured into a mold to form a core of the barrier. The first uncured batter may be tailored to have a high density such that the core provides structural support for the barrier. A second uncured batter may be poured around the core to form a skin of the barrier. The second uncured batter may be tailored to have a lower density such that the skin gives upon impact with the barrier. As such, the densities of the sustainable materials use to form the barriers may be tailored to a specific use for the barrier.

The shape of the sustainable barriers may also be tailored to different uses. That is, the mold used to cure the batter may be configured to have different shapes such that the sustainable barriers are useful for other applications. For example, the sustainable barriers may have the traditional Jersey Barrier shape for use as a traffic divider. In other embodiments, the sustainable barriers may be blocks instead of the traditional Jersey style barrier. The blocks may be stackable on each other such that the sustainable barriers can be formed into a makeshift wall. In still other embodiments, the sustainable barriers may resemble the traditional Jersey Barrier but may have different angles to deflect vehicles in different directions upon impact. As such, the shape of the sustainable barriers may be tailored to different configurations depending on their use.

Furthermore, because the sustainable barriers are made from a waste material (in this case recycled tires), the sustainable barriers are substantially less brittle than traditional concrete barriers and are substantially less likely to break or chip when moved. As describe above, traditional concrete barriers often chip or even break when moved at a construction site. The barriers described herein do not break or chip like traditional concrete barriers. Specifically, the recycled tires used to form the sustainable barriers are flexible and, as such, the sustainable barriers typically bounce or temporarily deform when impacted or dropped. That is, the sustainable barriers described herein do not break or chip like traditional concrete barriers. Accordingly, the sustainable barriers described herein may be more robust than traditional concrete barriers.

Because the sustainable barriers are formed of less brittle, more flexible materials, the sustainable barriers may be stacked on top of each other several levels high for storage or for creating larger barrier structures. For example, the sustainable barriers may be sized and shaped such that the barriers are stacked several levels high on top of each other to form a makeshift wall. In contrast, the traditional Jersey Barriers cannot be stacked to form tall structures that are several levels high.

The sustainable barriers described herein may also include connectors that enable the sustainable barriers to be connected to each other. In some embodiments, the connectors include loops of rebar that extend out from a side of the sustainable barrier and are capable of interfacing with connectors of other sustainable barriers to form an extended barrier structure. The material of the connectors may also reinforce the structure of the barrier. For example, the rebar may extend into the body of the barrier such that the rebar also acts as a barrier if the sustainable barrier is struck by a vehicle. In some embodiments, the connectors may include shaped ends with corresponding shapes that interconnect with each other to interlock. In some embodiments, the connectors may include a shaped connector that interlocks with identical shaped ends of the sustainable barrier.

In some embodiments, the rebar of the connector extends from one side of the sustainable barrier to the other. More specifically, the connectors may include a rebar loop that extends from a connector on one side of the sustainable barrier to a connector on the other side of the sustainable barrier. As such, the rebar loop forms an extra structural component that strengthens the barrier.

In alternative embodiments, the rebar connectors may not extend throughout the sustainable barrier. Rather, the rebar connector only extends into the sustainable barrier a short distance. In this embodiment, the connector does not provide as much structural reinforcement as the rebar loop embodiment described above and may be designed to separate in the event of an impact. In this embodiment, the rebar connector may be sized and shaped to maintain the connector within the sustainable barrier. For example, the ends of the connector may be turned up or may be twisted to create a tortuous pull-out path in the event of an impact.

Accordingly, the embodiments of sustainable barriers described herein are formed of a sustainable material that may be tailored to a specific use. Specifically, the density of the material may be tailored such that the relative hardness of the material of portions of the sustainable barriers may be tailored for different uses. Furthermore, the shape of the sustainable barriers may also be tailored for different uses. As such, the sustainable barriers described herein may be tailored for different uses and are entirely sustainable.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

### Terminology and Interpretative Conventions

Any methods described in the claims or specification should not be interpreted to require the steps to be performed in a specific order unless stated otherwise. Also, the methods should be interpreted to provide support to perform the recited steps in any order unless stated otherwise.

Spatial or directional terms, such as “left,” “right,” “front,” “back,” and the like, relate to the subject matter as it is shown in the drawings. However, it is to be understood that the described subject matter may assume various alternative orientations and, accordingly, such terms are not to be considered as limiting.

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The terms have, having, include, and including should be interpreted to be synonymous with the terms comprise and comprising. The use of these terms should also be understood as disclosing and providing support for narrower alternative embodiments where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any and all subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

All disclosed numerical values are to be understood as being variable from 0-100% in either direction and thus provide support for claims that recite such values or any and all ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range (e.g., 15.2).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any embodiment, feature, or combination of features described or illustrated in this document. This is true even if only a single embodiment of the feature or combination of features is illustrated and described in this document.

What is claimed:

1. A sustainable barrier comprising:
a waste material; and
a binder mixed with the waste material and configured to bind the waste material into the sustainable barrier, wherein the binder comprises a catalyst configured to enable the binder to bind the waste material into the sustainable barrier, and wherein the sustainable barrier is capable of being certified under the MASH TL2 certification test.

2. The sustainable barrier of claim 1, further comprising two broad sides that are substantially vertical relative to grade.

3. The sustainable barrier of claim 1, further comprising two broad sides that are oriented at an angle relative to grade, wherein the angle is from about 80° to about 100°.

4. The sustainable barrier of claim 1, wherein the sustainable barrier defines a sustainable barrier height of at least 30 inches.

5. The sustainable barrier of claim 1, wherein the sustainable barrier defines a sustainable barrier height of 32 inches.

6. The sustainable barrier of claim 1, wherein the sustainable barrier is not attached to a support surface.

7. The sustainable barrier of claim 1, wherein the sustainable barrier defines a bottom width of at least 20 inches.

8. The sustainable barrier of claim 1, wherein the sustainable barrier defines a bottom width of 22.5 inches.

9. A sustainable barrier comprising:
a waste material; and
a binder mixed with the waste material and configured to bind the waste material into the sustainable barrier, wherein the sustainable barrier comprises 85% by weight of the waste material and 15% by weight of the binder.

10. The sustainable barrier of claim 9, wherein the waste material comprises crumb rubber.

11. The sustainable barrier of claim 9, wherein the binder is a polyurethane binder.

12. The sustainable barrier of claim 9, wherein the sustainable barrier has a mass of approximately 400 kilograms.

13. The sustainable barrier of claim 9, wherein the sustainable barrier has a length of approximately 1.83 meters.

14. The sustainable barrier of claim 9, wherein the sustainable barrier has a height of approximately 810 millimeters.

15. The sustainable barrier of claim 9, wherein the sustainable barrier has a width of approximately 610 millimeters.

16. A sustainable barrier comprising:
a waste material; and
a binder mixed with the waste material and configured to bind the waste material into the sustainable barrier, wherein the binder comprises a catalyst configured to enable the binder to bind the waste material into the sustainable barrier, and wherein the sustainable barrier has a maximum load rating of at least 25,000 pounds.

17. The sustainable barrier of claim 16, wherein the catalyst comprises a polyether polyol-based catalyst.

18. The sustainable barrier of claim 17, wherein the catalyst comprises approximately 0.002% to approximately 0.01% of the barrier by weight of the waste material.

19. The sustainable barrier of claim 17, wherein the catalyst comprises approximately 0.002% of the barrier by weight of the waste material.

20. The sustainable barrier of claim 16, wherein the binder further comprises a polyurethane binder.
